(19) United States
(12) Patent Application Publication
(10) Pub. No.: US 2015/0067568 A1
(43) Pub. Date: Mar. 5, 2015

(54) APPARATUS AND METHOD FOR DISPLAYING CHART IN ELECTRONIC DEVICE

(71) Applicant: Samsung Electronics Co., Ltd., Suwon-si (KR)

(72) Inventors: Gi-Yong LEE, Suwon-si (KR); Han-Kyung JEON, Seongnam-si (KR)

(21) Appl. No.: 14/468,952

(22) Filed: Aug. 26, 2014

(30) Foreign Application Priority Data
Aug. 30, 2013 (KR) 10-2013-0104468

(51) Int. Cl. G06F 3/0484; G06F 3/0482

(52) U.S. Cl. CPC G06F 3/04842; G06F 3/0482
USPC 715/771

(57) ABSTRACT

An apparatus and a method for displaying a chart in a mobile electronic device are provided. The apparatus includes a display unit configured to receive an input of an object associated with a chart, and a controller configured to control display of at least one chart component based on characteristics of the object.

### CROSS-REFERENCE TO RELATED APPLICATION(S)

This application claims the benefit under 35 U.S.C. §119(a) of a Korean patent application filed on Aug. 30, 2013 in the Korean Intellectual Property Office and assigned Serial number 10-2013-0104468, the entire disclosure of which is hereby incorporated by reference.

### TECHNICAL FIELD

The present disclosure relates to an electronic device. More particularly, the present disclosure relates to an apparatus and a method for displaying a chart in a mobile electronic device.

### BACKGROUND

Mobile electronic devices, such as smart phones, personal computers, and tablet computers, may provide a number of useful features to users through a wide variety of applications. The mobile electronic devices have evolved into advanced devices that can provide a variety of features, allowing users to enjoy various types of information in addition to the voice call feature. For example, these mobile electronic devices may provide a chart service that displays a chart graph based on the data entered by users.

The chart service may display a chart graph for chart data, after numeric data is entered by a user and then the entered numeric data is converted into chart data.

Since mobile electronic devices are limited in terms of the screen size, users may have difficulty in entering numeric data for a chart. In the chart service, a mobile electronic device may display a chart graph after numeric data is entered by a user and then conversion of the entered numeric data is requested by the user. Consequently, the user may not intuitively check or recognize the chart graph while entering the numeric data.

Moreover, when modifying the displayed chart graph, the mobile electronic device may modify or update the entered numeric data, so the user may not intuitively check the chart graph while modifying the numeric data.

Therefore, there is a need for a method and an apparatus for displaying a chart graph using an object recognition technique to allow a user to intuitively recognize a chart graph.

The above information is presented as background information only to assist with an understanding of the present disclosure. No determination has been made, and no assertion is made, as to whether any of the above might be applicable as prior art with regard to the disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for displaying a chart graph using an object recognition technique to allow a user to intuitively recognize a chart graph.

Another aspect of the present disclosure is to provide a method and an apparatus for modifying a chart graph using an object recognition technique to allow a user to intuitively modify a chart graph.

In accordance with an aspect of the present disclosure, an electronic device is provided. The electronic device includes a display unit configured to receive an input for entering an object associated with a chart, and a controller configured to control display of at least one chart component based on characteristics of the object.

In accordance with another aspect of the present disclosure, a method for displaying a chart in an electronic device is provided. The method includes receiving an input for entering an object associated with a chart, and generating and displaying at least one chart component based on characteristics of the object.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a mobile electronic device according to various embodiments of the present disclosure;

FIG. 2 is a flowchart of creating a chart in a mobile electronic device according to an embodiment of the present disclosure;

FIG. 3 is a flowchart of displaying a chart in a mobile electronic device according to a first embodiment of the present disclosure;

FIG. 4 is a flowchart of displaying a chart in a mobile electronic device according to a second embodiment of the present disclosure;

FIGS. 5A, 5B, and 5C are flowcharts of changing a chart in a mobile electronic device according to the first embodiment of the present disclosure;

FIG. 6 is a flowchart of changing a chart in a mobile electronic device according to the second embodiment of the present disclosure;

FIG. 7 is a flowchart of storing a chart in a mobile electronic device according to an embodiment of the present disclosure;

FIGS. 8A, 8B, 8C, and 8D illustrate screens on which a chart is displayed according to the first embodiment of the present disclosure;

FIGS. 9A, 9B, 9C, and 9D illustrate screens on which a chart is displayed according to the second embodiment of the present disclosure;

FIGS. 10A, 10B, 10C, 10D, 10E, and 10F illustrate screens on which a line graph is changed according to the first embodiment of the present disclosure;

FIGS. 11A, 11B, 11C, 11D, and 11E illustrate screens on which a bar graph is changed according to the first embodiment of the present disclosure;

FIGS. 12A, 12B, 12C, and 12D illustrate screens on which a pie graph is changed according to the first embodiment of the present disclosure;

FIGS. 13A, 13B, 13C, and 13D illustrate screens on which a line graph, a bar graph, and a pie chart are changed according to the second embodiment of the present disclosure;

FIG. 14 illustrates a format of an image file, in which a chart image is stored according to an embodiment of the present disclosure;

FIGS. 15A, 15B, 15C, 15D, 15E, and 15F illustrate screens on which a chart is displayed according to a third embodiment of the present disclosure;

FIGS. 16A, 16B, 16C, and 16D illustrate screens on which chart data is changed according to the third embodiment of the present disclosure;

FIGS. 17A, 17B, 17C, and 17D illustrate screens on which a bar graph is changed according to the third embodiment of the present disclosure;

FIGS. 18A, 18B, and 18C illustrate screens on which a pie graph is changed according to the third embodiment of the present disclosure; and

FIGS. 19A and 19B illustrate screens on which a chart larger in size than a chart display area is displayed according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Electronic devices according to various embodiments of the present disclosure may include mobile electronic devices and electronic devices that are not easy to carry. The latter may include personal computers, and the like, and the former, as easy-to-carry mobile electronic devices, may include video phones, cell phones, smart phones, International Mobile Telecommunication 2000 (IMT-2000) mobile electronic devices, Wideband Code Division Multiple Access (WCDMA) mobile electronic devices, Universal Mobile Telecommunication Service (UMTS) mobile electronic devices, Personal Digital Assistants (PDAs), Portable Multimedia Players (PMPs), Digital Multimedia Broadcasting (DMB) mobile electronic devices, Electronic-Book (E-Book) readers, portable computers (for example, laptop computers, tablet computers, and the like), digital cameras, or the like.

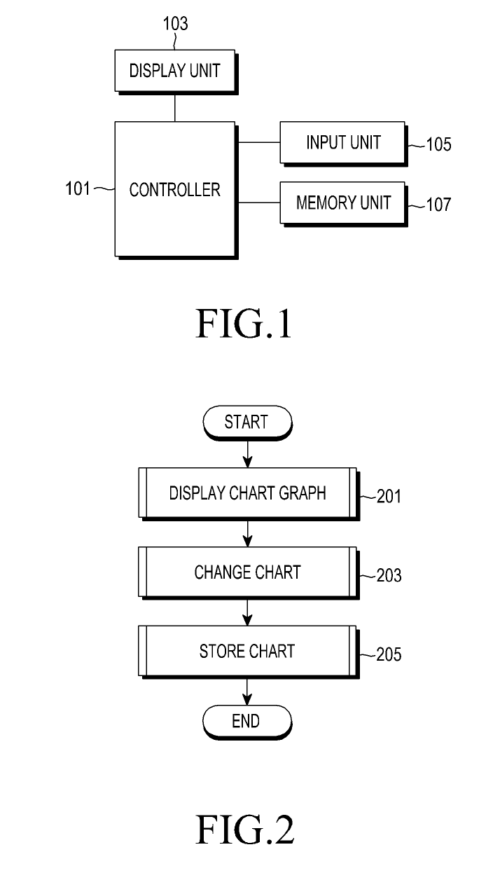

FIG. 1 is a block diagram of a mobile electronic device according to various embodiments of the present disclosure.

Referring to FIG. 1, the mobile electronic device may include a controller 101, a display unit 103, an input unit 105 and a memory unit 107.

Each of the components will be described below. The input unit 105 may include numeric/character keys for entering numeric/character information and function keys for setting various functions. The display unit 103, which displays image signals on its screen, may display the data requested to be output from the controller 101. For example, if the display unit 103 is implemented as a touch screen, the input unit 105 may include a minimum number of keys, and the display unit 103 may replace some of the key input function of the input unit 105. The touch screen may include, for example, a capacitive touch screen and a resistive touch screen, and the like.

The memory unit 107 may include a program memory and a data memory. The program memory may store a booting program and an Operating System (OS) for controlling the overall operation of the mobile electronic device, and the data memory may store various data generated during operation of the mobile electronic device. For example, if chart-related information and charts are stored as images, the memory unit 107 may store image data including chart images and chart data of the chart images.

The chart-related information may be construed to include chart data and user data. The user data may include at least one parameter and at least one value corresponding to the at least one parameter. The at least one parameter may include the series currently focused or selected by the user, the maximum value of the Y-axis, the number of scale marks of the Y-axis, the X-axis unit (for example, years, or the like), the Y-axis unit (for example, m, kg, or the like), the starting angle of the first area of a pie graph, the color information of a pie graph, the form of displaying values of a pie graph (for example, the form of displaying values of a pie graph in at least one of ratios and values), the type of a chart table (for example, a general purpose or a chart purpose), and the form of displaying the series of a chart table (for example, the form of displaying the series of a chart table in rows or columns).

The at least one value may be a number, a character, or a binary number, such as ‘true/false’. For example, a value corresponding to the X-axis unit, the Y-axis unit, the form of displaying values of a pie graph, the type of a chart table, or the form of displaying the series of a chart table may be a character. As another example, a value corresponding to the maximum value of the Y-axis, the number of scale marks of the Y-axis, or the starting angle of the first area of a pie graph may be a number.

The chart data may include a chart name, a series list and a series name list. The series list may include a series value list and series colors, and the series value list may include chart values and colors.

The controller 101 may perform a function of controlling the overall operation of the mobile electronic device. For example, the controller 101 may create and display a chart by recognizing an object(s) entered by the user, change the chart at the user's change request, and store the chart in a specific format at the user's save request.

More specifically, the controller 101 may recognize an object entered by the user, generate chart data based on the recognized object, and display the chart based on the generated chart data.

The term ‘chart data’ as used herein may refer to data for a chart, and the chart data may include a chart name, a series list, and a series name list. The series list may include a series value list and series colors. The series value list may include chart values and colors. An object may be entered using various methods, such as, for example, a user's finger, a stylus pen, a user's eyes, and the like. For example, if an object is entered by a user's finger or a stylus pen, the controller 101 may recognize an object formed by a gesture by detecting a gesture (for example, a touch-and-drag and touch-off gesture) made by the user's finger or the stylus pen. As another example, if an object is entered by the user's eyes, the controller 101 may recognize an object formed by movements of the user's eyes by detecting the movements (for example, a moving direction and a moving distance) of the user's eyes.

If a change request for a displayed chart is entered by the user, the controller 101 may change the displayed chart in response to the entered change request. The chart change may include object addition, graph (or chart) type switching, chart modification, and the like. The object addition may refer to an operation in which, if an object is entered by the user after a chart is displayed, the displayed chart is changed based on the entered object. The chart type switching may refer to an operation in which, if a chart type is selected by the user, the type of the displayed chart is switched to the selected type. The graph type (or chart type) may refer to a type of a graph representing a chart, and may include, for example, a line graph, a bar graph, a pie (or circle) graph, and the like.

The chart modification may be construed to include change in chart color, change in chart value, change in scale mark of the coordinate system, chart deletion, and the like. The ‘change in chart color’ may refer to an operation of changing the color of some areas or the entire area of a graph representing the chart to a color selected by the user. The ‘change in chart value’ may refer to an operation of changing chart values included in a graph representing the chart at the user's request. The ‘change in scale mark of the coordinate system’ may refer to an operation of changing scale marks of the coordinate system for a graph representing the chart at the user's request. The ‘chart deletion’ may refer to an operation of deleting some areas or the entire area of a graph representing the chart at the user's request.

If storage is requested by the user, the controller 101 may store chart data in a data format requested by the user. For example, if storing a chart as an image is requested by the user, the controller 101 may generate a chart image including a chart by capturing the displayed chart. The controller 101 may generate and store image data including the generated chart image and the chart data of the displayed chart.

In some cases, the controller 101 may display a chart graph according to a first or second embodiment of the present disclosure.

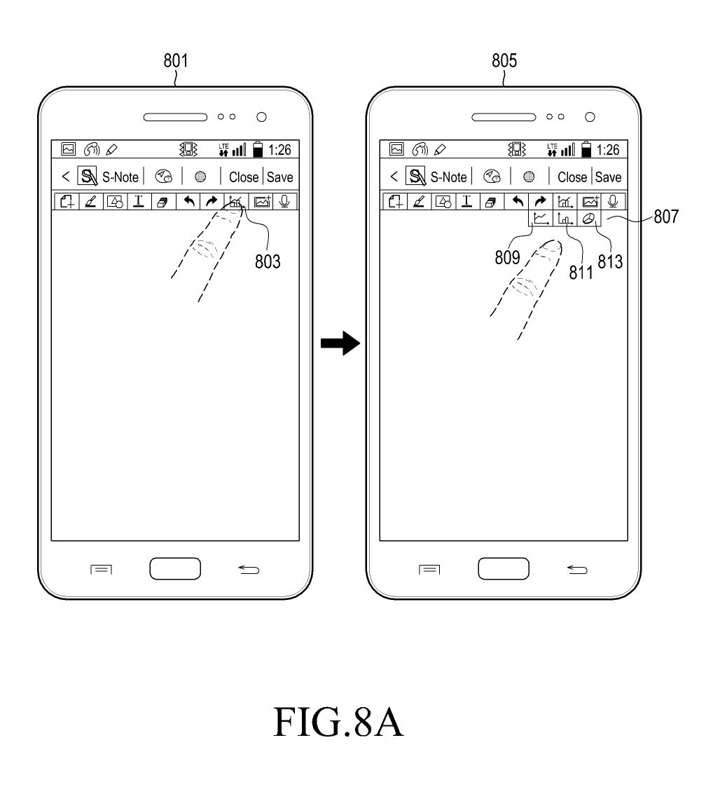

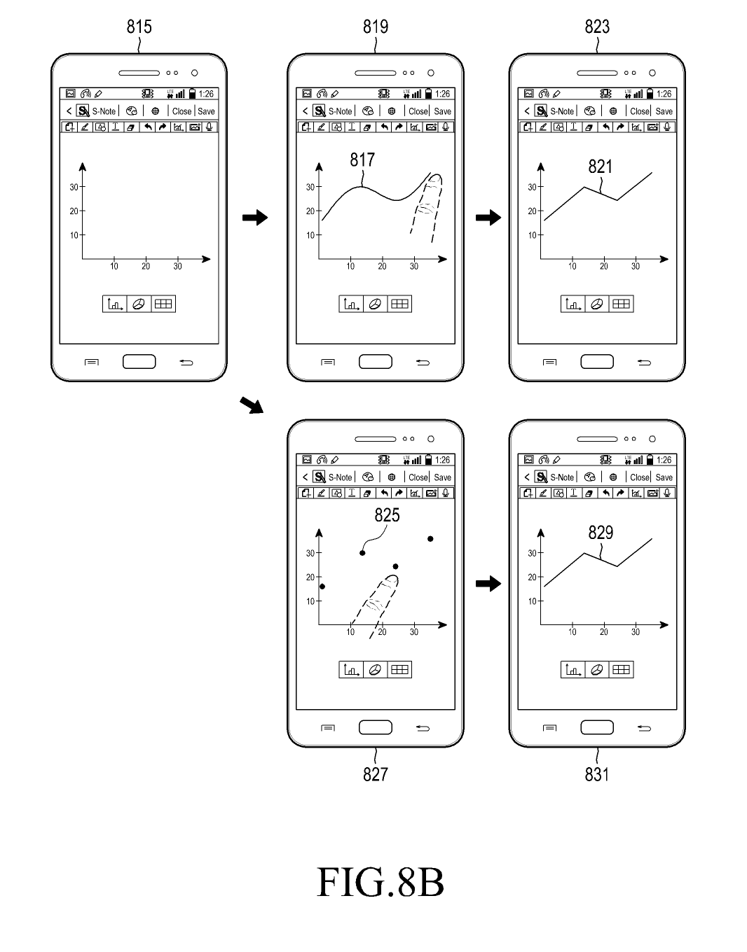

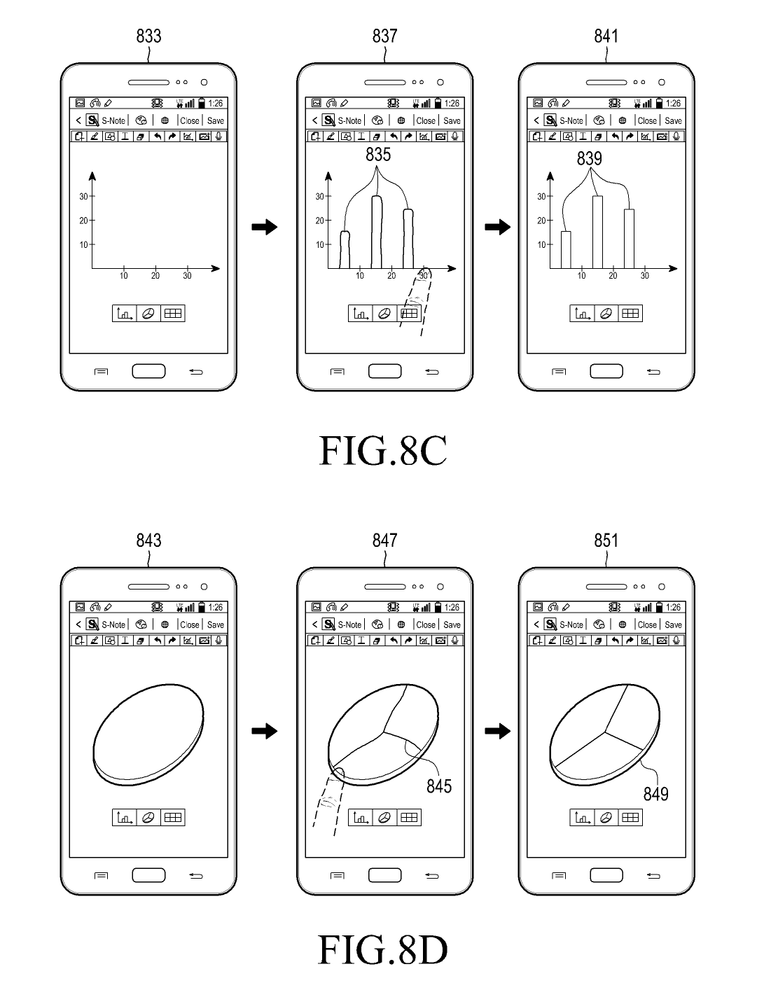

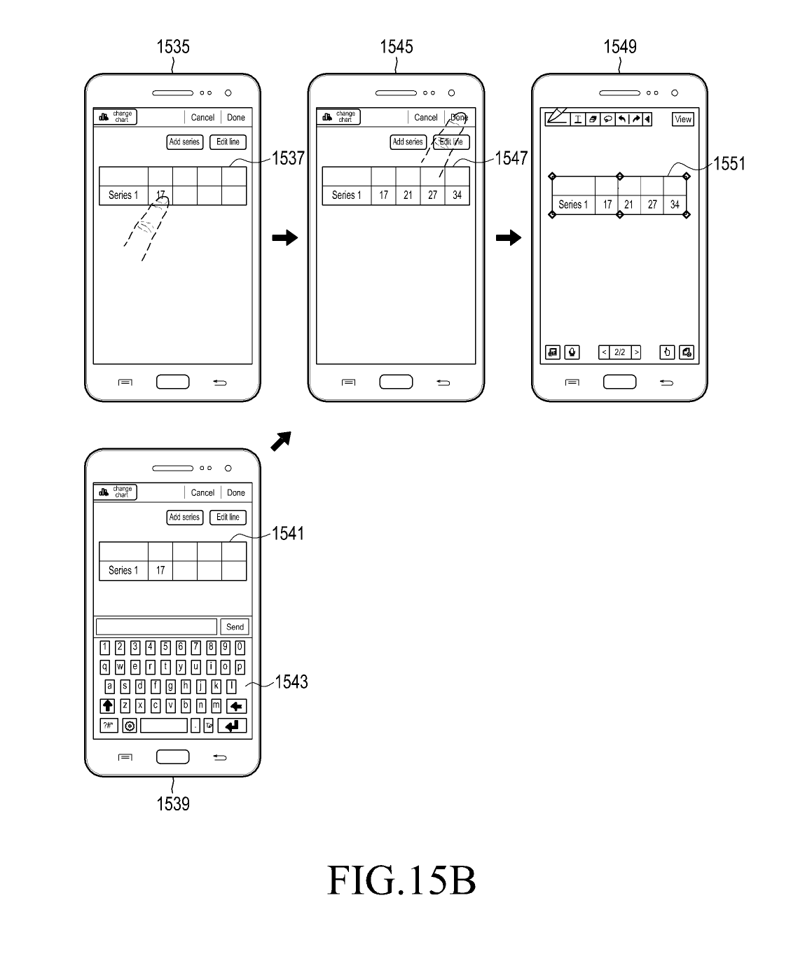

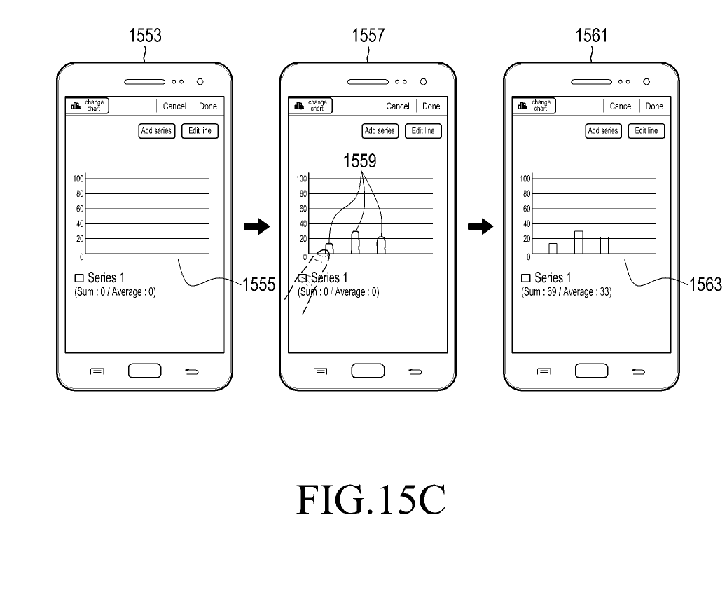

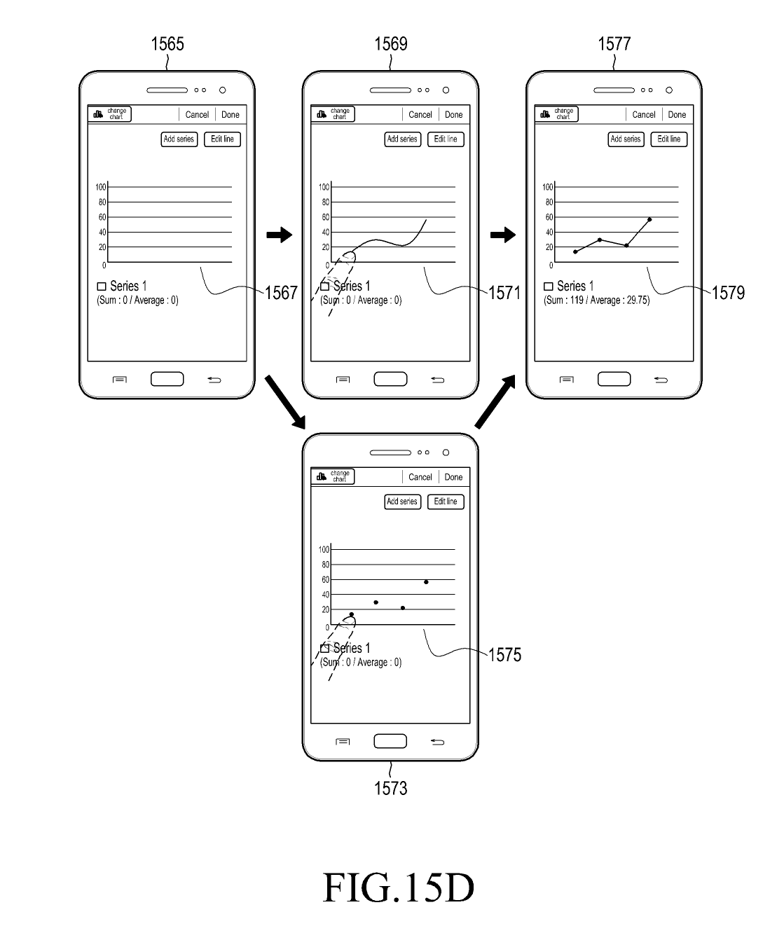

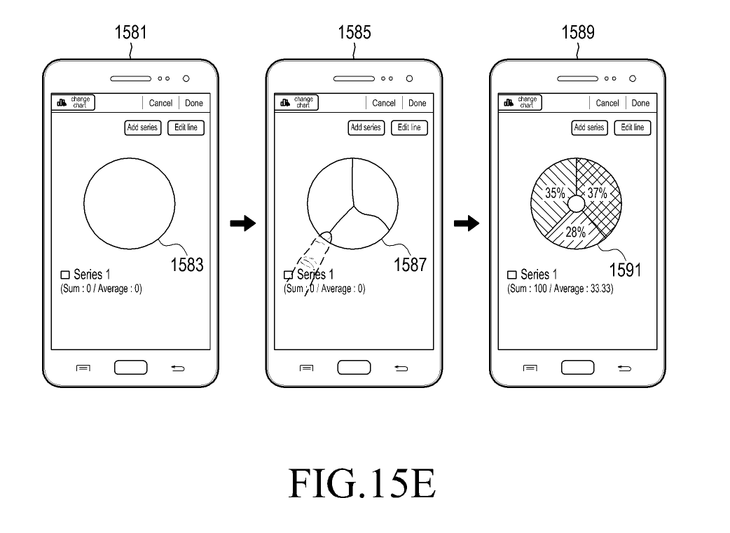

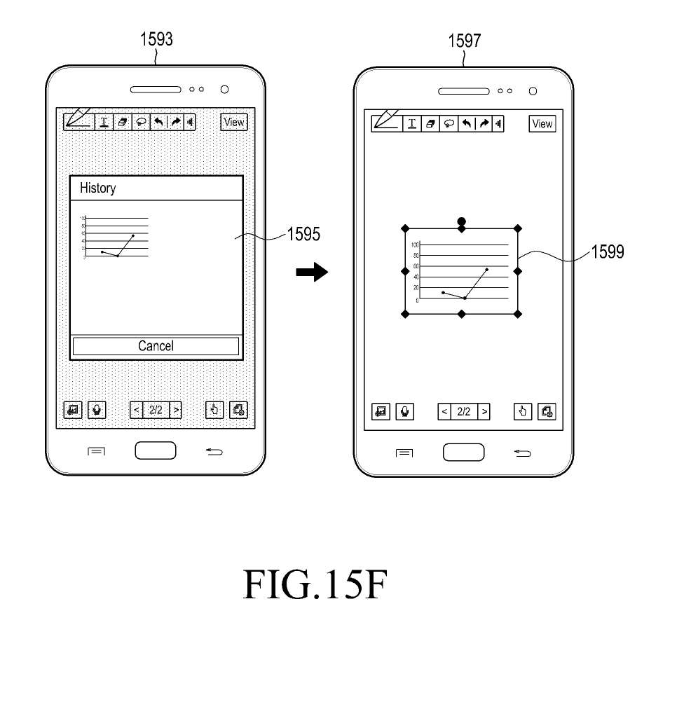

In accordance with a first embodiment of the present disclosure, the controller 101 may determine whether chart creation is requested by the user. For example, the controller 101 may display a Create Chart icon, and if the Create Chart icon is selected by the user, the controller 101 may determine that chart creation is requested. The Create Chart icon may refer to an icon used for receiving a request for chart creation from the user. For example, the controller 101 may display a Create Chart icon 803 as shown in a screen 801 of FIG. 8A, and if the Create Chart icon 803 is touched by the user, the controller 101 may determine that chart creation is requested. As another example, if an Insert Image icon 1503 is selected as shown in a screen 1501 of FIG. 15A, the controller 101 may display insertion menus including at least one insertable image type, and if a Magic Chart menu for requesting insertion of a chart is selected by the user from among the displayed insertion menus, the controller 101 may determine that chart creation is requested.

If it is determined that chart creation is requested, the controller 101 may display types of graphs for showing a chart. The chart types (or graph types) may include a line graph, a bar graph, a circle or oval graph, and the like. For example, if the Create Chart icon 803 is touched by the user, the controller 101 may display chart types 807 including a Line Graph icon 809, a Bar Graph icon 811, and a Pie Graph icon 813, as shown in a screen 805 of FIG. 8A. As another example, if a Magic Chart menu 1505 is selected by the user, the controller 101 may display a Chart Type menu 1509 including a Chart Table menu 1511, a Bar Graph menu 1513, a Line Graph menu 1515, a Pie Graph menu 1517, and a History menu 1519 showing the previously generated at least one chart, as shown in a screen 1507 of FIG. 15A.

The controller 101 may determine whether any one of the displayed chart types is selected. For example, if any one icon is touched among the Line Graph icon 809, the Bar Graph icon 811, and the Pie Graph icon 813 included in the chart types 807 displayed as shown in the screen 805 of FIG. 8A, the controller 101 may determine that any one of the displayed chart types is selected. As another example, if any one menu is touched in the Chart Type menu 1509 displayed as shown in the screen 1507 of FIG. 15A, the controller 101 may determine that any one of the displayed chart types is selected by the user.

If any one of the chart types is selected, the controller 101 may display an object input window depending on the selected chart type. The object input window may refer to a window used for receiving an object from the user, and may or may not include the coordinate system depending on the selected chart type.

For example, if the selected chart type corresponds to a line graph or a bar graph, the controller 101 may display an object input window including the coordinate system, as shown in a screen 815 of FIG. 8B, a screen 833 of FIG. 8C, a screen 1553 of FIG. 15C, or a screen 1565 of FIG. 15D. As another example, if the selected chart type corresponds to a pie graph, the controller 101 may display an object input window including a circle, as shown in a screen 843 of FIG. 8D or a screen 1581 of FIG. 15E. As further another example, if the selected chart type corresponds to a chart table menu, the controller 101 may display a table setting window 1523 used for setting the size of the chart table, as shown in a screen 1521 of FIG. 15A. As further another example, if the selected chart type corresponds to a history menu, the controller 101 may display a history window 1595 including the previously generated at least one chart, as shown in a screen 1593 of FIG. 15F.

The controller 101 may determine whether an object is entered in an object input widow. The object may be entered by a user's finger, a stylus pen, a user's eyes, or the like. For example, if an object is entered by a user's finger or a stylus pen, the controller 101 may determine whether an object is entered, by detecting a gesture (for example, a touch-and-drag and touch-off gesture) made by the user's finger or the stylus pen. As another example, if an object is entered by the user's eyes, the controller 101 may determine whether an object is entered, by detecting the movements (for example, a moving direction and a moving distance) of the user's eyes.

If an object is entered, the controller 101 may recognize a type of the entered object, and generate chart data based on the recognized object type. For example, if the chart type selected by the user corresponds to a line graph, the controller 101 may determine coordinates (that is, X-axis and Y-axis) for the area that is touched by the user on the display unit 103, and determine whether the entered object is a polygon, based on the determined coordinates. For example, if the entered object is a polygon, the controller 101 may determine start and end points and at least one inflection point of the polygon, based on the coordinates for the touched area, and generate chart data for a line graph based on the determined start and end points and at least one inflection point.

If the chart type selected by the user corresponds to a bar graph, the controller 101 may determine coordinates (that is, X-axis and Y-axis) for the area that is touched by the user on the display unit 103, and determine whether the entered object is a polygon or a rectangle with one side opened, based on the determined coordinates. For example, if the entered object is a polygon or a rectangle with one side opened, the controller 101 may determine the maximum value of the Y-axis of the polygon or the rectangle with one side opened, based on the coordinates for the touched area, and generate chart data for a bar graph based on the determined maximum value of the Y-axis.

If the chart type selected by the user corresponds to a pie graph, the controller 101 may determine an angle at which a gesture has entered into the circular coordinate system and an angle at which a gesture has escaped out of the circular coordinate system, determine a size of a specific area included in the pie graph based on the determined entry angle and escape angle, and generate chart data for the pie graph based on the determined size of the specific area.

For example, if an object or a curve 817 is entered in an object input window including the coordinate system as shown in a screen 819 of FIG. 8B, the controller 101 may recognize start and end points and at least one inflection point of the curve 817, estimate y-axis values corresponding to the recognized start and end points and at least one inflection point, and generate chart data based on the estimated y-axis values. More specifically, if the y-axis values corresponding to the start point, two inflection points and the end point of the curve 817 are 17, 21, 27, and 34, the controller 101 may generate chart data shown in Table 1.

TABLE 1

| / | | | | |
|---|---|---|---|---|
| | 17 | 21 | 27 | 34 |

As another example, if objects or a plurality of points 825 are entered in an object input window including the coordinate system as shown in a screen 827 of FIG. 8B, the controller 101 may recognize the plurality of points 825, estimate y-axis values corresponding to the plurality of recognized points, and generate chart data based on the estimated y-axis values. More specifically, if the y-axis values corresponding to the plurality of points are 17, 21, 27, and 34, the controller 101 may generate chart data shown in Table 1.

As further another example, if objects or a plurality of bars 835 are entered in an object input window including the coordinate system as shown in a screen 837 of FIG. 8C, the controller 101 may recognize the plurality of bars 835, estimate the maximum values of the y-axes corresponding to the plurality of recognized bars, and generate chart data based on the estimated maximum values of the y-axes. More specifically, if the maximum values of the y-axes corresponding to the plurality of bars are 17, 30, and 22, the controller 101 may generate chart data shown in Table 2.

TABLE 2

| / | | | |
|---|---|---|---|
| | 17 | 30 | 22 |

As further another example, if objects or a plurality of oblique lines 845 are entered in an object input window including a circle as shown in a screen 847 of FIG. 8D, the controller 101 may recognize the plurality of oblique lines 845, estimate sizes corresponding to a plurality of areas formed by the circle and the plurality of oblique lines 845, and generate chart data based on the estimated sizes. More specifically, if the sizes corresponding to the plurality of areas are 35, 28, and 37, the controller 101 may generate chart data shown in Table 3.

TABLE 3

| / | | | |
|---|---|---|---|
| | 35 | 28 | 37 |

As further another example, if objects or numbers are entered in an object input window including a coordinate table as shown in a screen 1535 of FIG. 15B, the controller 101 may generate chart data based on the entered numbers. More specifically, if the entered numbers are 17, 21, 27, and 34, the controller 101 may generate chart data shown in Table 1.

As further another example, if objects or a plurality of bars 1559 are entered in an object input window including the coordinate system as shown in a screen 1557 of FIG. 15C, the controller 101 may recognize the plurality of bars 1559, estimate the maximum values of the y-axes corresponding to the plurality of recognized bars, and generate chart data based on the estimated maximum values of the y-axes. More specifically, if the maximum values of the y-axes corresponding to the plurality of bars are 17, 30, and 22, the controller 101 may generate chart data shown in Table 2.

As further another example, if an object or a curve 1571 is entered in an object input window including the coordinate system as shown in a screen 1569 of FIG. 15D, the controller 101 may recognize start and end points and at least one inflection point of the curve 1571, estimate y-axes values corresponding to the recognized start and end points and inflection points, and generate chart data based on the estimated y-axis values. More specifically, if the y-axes values corresponding to the start point, two inflection points and the end point of the curve 1571 are 17, 21, 27, and 34, the controller 101 may generate chart data shown in Table 1.

As further another example, if objects or a plurality of points 1575 are entered in an object input window including the coordinate system as shown in a screen 1573 of FIG. 15D, the controller 101 may recognize the plurality of points 1575, estimate y-axes values corresponding to the plurality of recognized points, and generate chart data based on the estimated y-axes values. More specifically, if the y-axes values corresponding to the plurality of points are 17, 21, 27, and 34, the controller 101 may generate chart data shown in Table 1.

As further another example, if objects or a plurality of oblique lines 1587 are entered in an object input window including a circle as shown in a screen 1585 of FIG. 15E, the controller 101 may recognize the plurality of oblique lines 1587, estimate sizes corresponding to a plurality of areas formed by the circle and the plurality of oblique lines 1587, and generate chart data based on the estimated sizes. More specifically, if the sizes corresponding to the plurality of areas are 35, 28, and 37, the controller 101 may generate chart data shown in Table 3.

The controller 101 may create a chart graph depending on the selected chart type based on the generated chart data, and display the created chart graph. For example, if the chart type selected by the user corresponds to a line graph, the controller 101 may create a line graph based on the chart data shown in Table 1, and display the line graph including a broken (or polygonal) line 821 as shown in a screen 823 of FIG. 8B.

As another example, if the chart type selected by the user corresponds to a bar graph, the controller 101 may create a bar graph based on the chart data shown in Table 2, and display the bar graph including three bars 839 as shown in a screen 841 of FIG. 8C. As further another example, if the chart type selected by the user corresponds to a pie graph, the controller 101 may create a pie graph based on the chart data shown in Table 3, and display the pie graph including three areas 849 as shown in a screen 851 of FIG. 8D.

As further another example, if the chart type selected by the user corresponds to a chart table, the controller 101 may display a chart table 1547 as shown in a screen 1545 of FIG. 15B. As further another example, if the chart type selected by the user corresponds to a line graph, the controller 101 may create a line graph based on the chart data shown in Table 1, and display the line graph including a broken line 1579 as shown in a screen 1577 of FIG. 15D. As further another example, if the chart type selected by the user corresponds to a bar graph, the controller 101 may create a bar graph based on the chart data shown in Table 2, and display the bar graph including three bars 1563 as shown in a screen 1561 of FIG. 15C. As further another example, if the chart type selected by the user corresponds to a pie graph, the controller 101 may create a pie graph based on the chart data shown in Table 3, and display the pie graph 1591 illustrating three areas as shown in a screen 1589 of FIG. 15E.

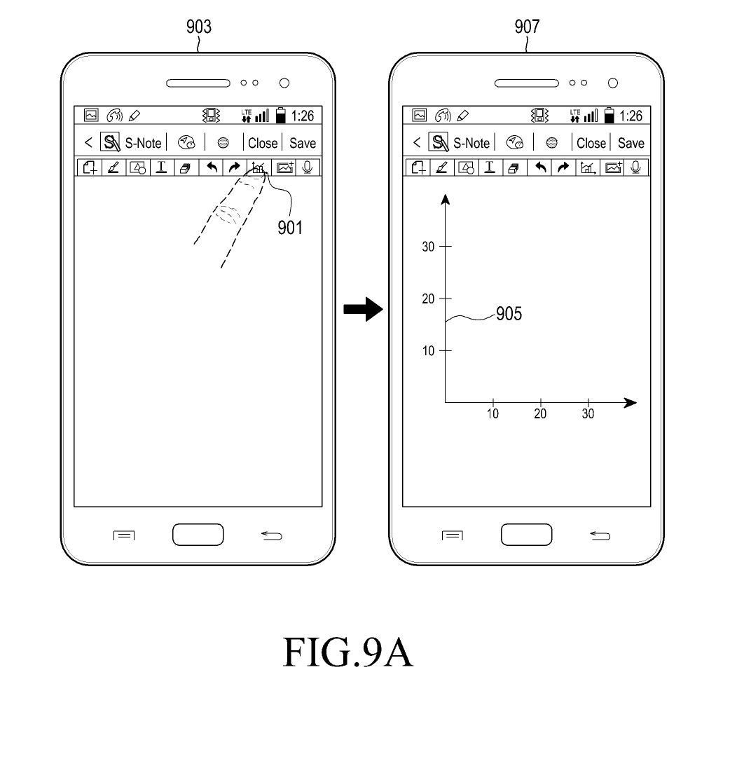

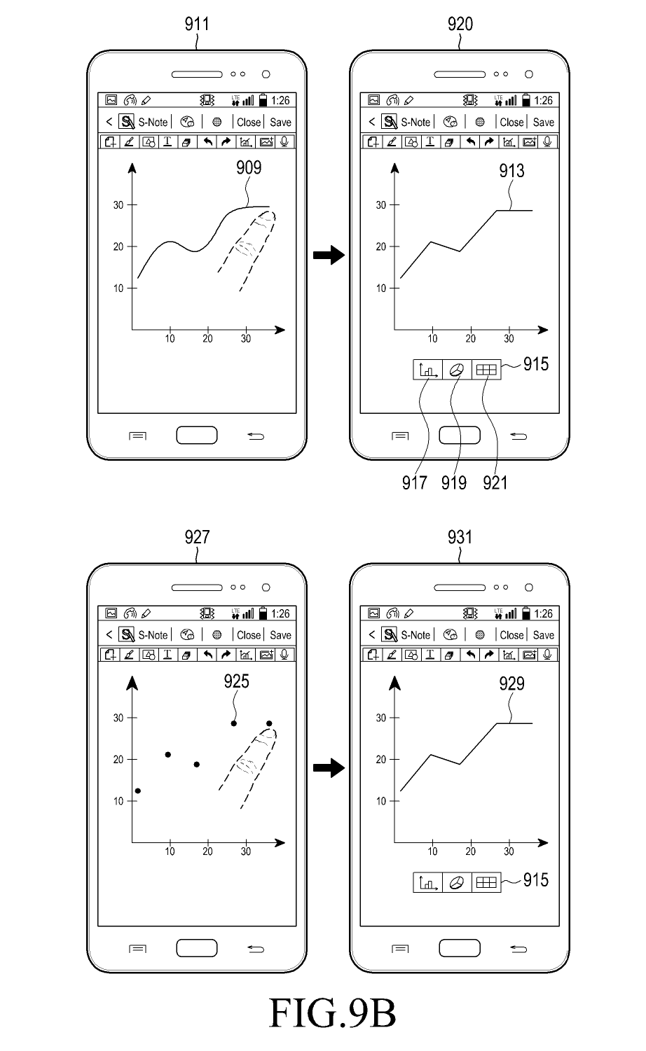

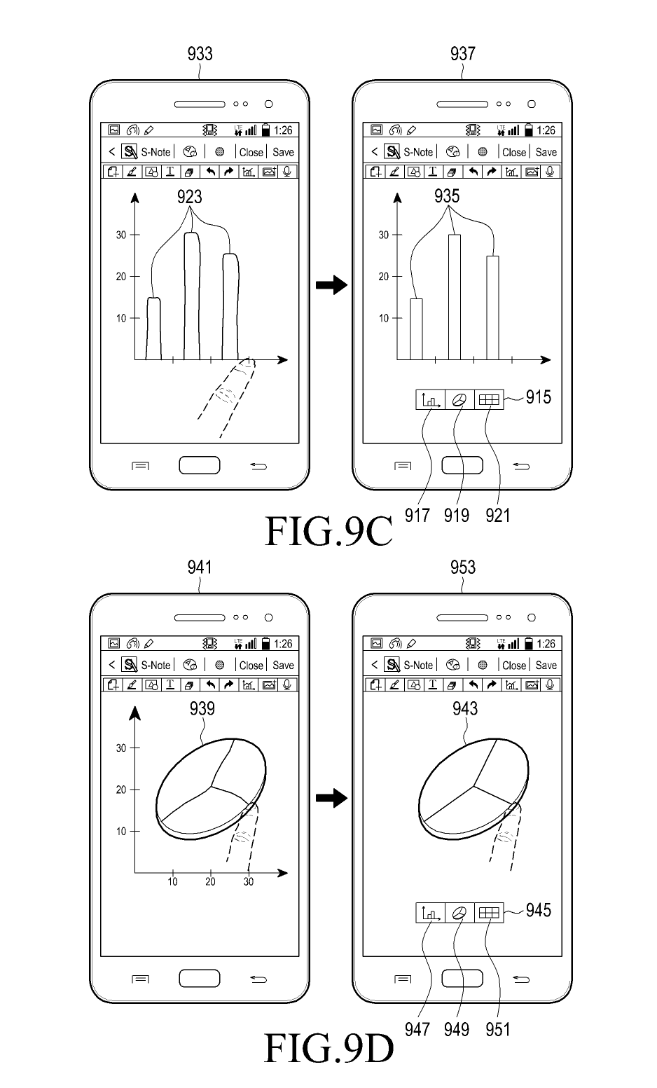

In accordance with a second embodiment of the present disclosure, the controller 101 may determine whether chart creation is requested by the user. For example, the controller 101 may display a Create Chart icon, and if the Create Chart icon is selected or touched by the user, the controller 101 may determine that chart creation is requested. The Create Chart icon may refer to an icon used for receiving a request for chart creation from the user. For example, the controller 101 may display a Create Chart icon 901 as shown in a screen 903 of FIG. 9A, and if the Create Chart icon 901 is touched by the user, the controller 101 may determine that chart creation is requested.

If it is determined that chart creation is requested, the controller 101 may display an object input window including the coordinate system. The object input window may refer to a window used for receiving an object from the user, and may include the coordinate system for a line graph or a bar graph. For example, the controller 101 may display an object input window including a coordinate system 905 as shown in a screen 907 of FIG. 9A.

The controller 101 may determine whether an object is entered in an object input window. The object may be entered by a user's finger, a stylus pen, a user's eyes, or the like. For example, if an object is entered by a user's finger or a stylus pen, the controller 101 may determine whether an object is entered, by detecting a gesture (for example, a touch-and-drag and touch-off gesture) made by the user's finger or the stylus pen. As another example, if an object is entered by the user's eyes, the controller 101 may determine whether an object is entered, by detecting the movements (for example, a moving direction and a moving distance) of the user's eyes.

If an object is entered, the controller 101 may recognize a shape of the entered object, determine a chart type based on the recognized shape of the object, and generate chart data based on the determined chart type and the recognized shape of the object. The chart type may refer to chart types supportable by the mobile electronic device, and may include a line graph, a bar graph, a circle or oval graph, and the like.

The shape of the entered object may be recognized in a variety of ways. For example, the controller 101 may determine whether a shape of an object corresponds to a curve, a point, a bar, a circle, or the like. The bar may be a rectangle with one side opened. For example, if the recognized shape of the object corresponds to a curve or a point, the controller 101 may determine that the chart type corresponds to a line graph, and if the recognized shape of the object corresponds to a bar, the controller 101 may determine that the chart type corresponds to a bar graph. If the recognized shape of the object corresponds to a circle, the controller 101 may determine that the chart type corresponds to a pie graph.

For example, if an object or a curve 909 is entered in an object input window as shown in a screen 911 of FIG. 9B, the controller 101 may determine that the chart type corresponds to a line graph since the shape of the object corresponds to the curve 909, recognize start and end points and at least one inflection point of the curve 909, estimate y-axis values corresponding to the recognized start and end points and inflection points, and generate chart data based on the estimated y-axis values. More specifically, if the y-axis values corresponding to the start point, two inflection points and the endpoint of the curve 909 are 17, 21, 27, and 34, the controller 101 may generate chart data shown in Table 1.

As another example, if objects or a plurality of points 925 are entered in an object input window as shown in a screen 927 of FIG. 9B, the controller 101 may determine that the chart type corresponds to a line graph since the shape of the object corresponds to the plurality of points 925, recognize the plurality of points 925, estimate y-axis values corresponding to the plurality of recognized points, and generate chart data based on the estimated y-axis values. More specifically, if the y-axis values corresponding to the plurality of points are 17, 21, 27, and 34, the controller 101 may generate chart data shown in Table 1.

As further another example, if objects or a plurality of bars 923 are entered in an object input window as shown in a screen 933 of FIG. 9C, the controller 101 may determine that the chart type corresponds to a bar graph since the shape of the object corresponds to the plurality of bars 923, recognize the plurality of bars 923, estimate the maximum values of the y-axes corresponding to the plurality of recognized bars, and generate chart data based on the estimated maximum values of the y-axes. More specifically, if the maximum values of the y-axes corresponding to the plurality of bars are 17, 30, and 22, the controller 101 may generate chart data shown in Table 2.

As further another example, if an object or a circle 939 including a plurality of areas is entered in an object input window as shown in a screen 941 of FIG. 9D, the controller 101 may determine that the chart type corresponds to a pie graph since the shape of the object corresponds to the circle 939, estimate sizes corresponding to the plurality of areas, and generate chart data based on the estimated sizes. More specifically, if the sizes corresponding to the plurality of areas are 35, 28, and 37, the controller 101 may generate chart data shown in Table 3.

The controller 101 may create a chart graph depending on the determined chart type based on the generated chart data, and display the created chart graph. For example, if the determined chart type corresponds to a line graph, the controller 101 may create a line graph based on the chart data shown in Table 1, and display the line graph including a broken line 913 as shown in a screen 920 of FIG. 9B.

As another example, if the determined chart type corresponds to a bar graph, the controller 101 may create a bar graph based on the chart data shown in Table 2, and display the bar graph including three bars 935 as shown in a screen 937 of FIG. 9C. As further another example, if the determined chart type corresponds to a pie graph, the controller 101 may create a pie graph based on the chart data shown in Table 3, and display a pie graph 943 including three areas as shown in a screen 953 of FIG. 9D.

Although it is assumed in the present disclosure that the controller 101 creates a chart in order of an operation of recognizing an entered object, an operation of generating chart data based on the recognized object, and an operation of displaying a chart graph based on the chart data, these operations may be performed simultaneously, or the order of the operations may be subject to change.

The controller 101 may change the chart graph according to various embodiment of the present disclosure.

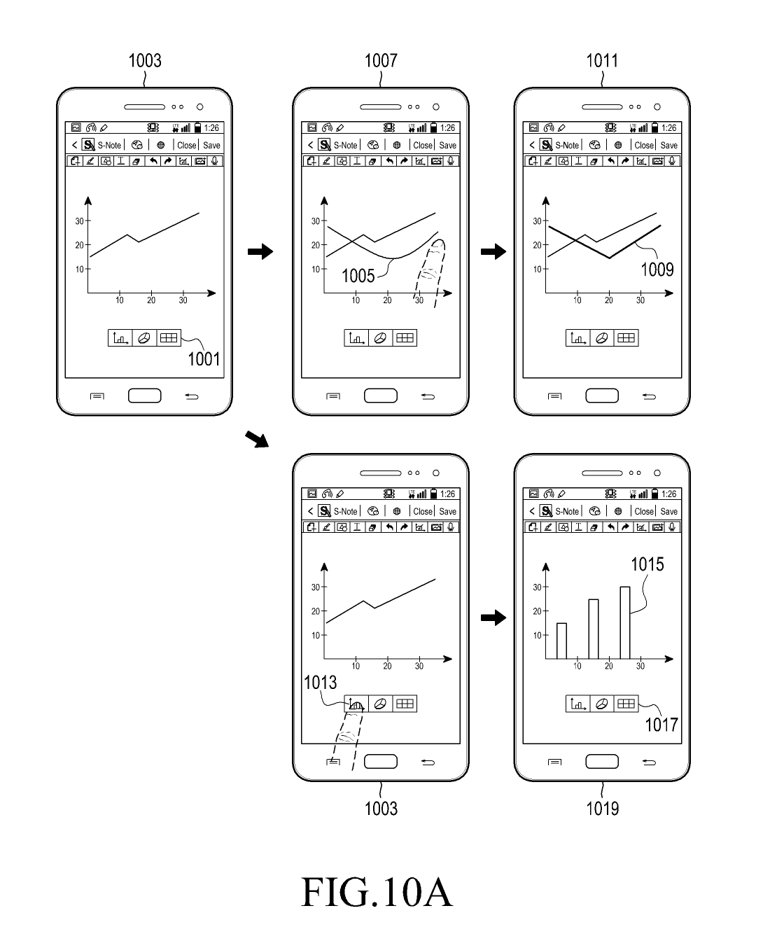

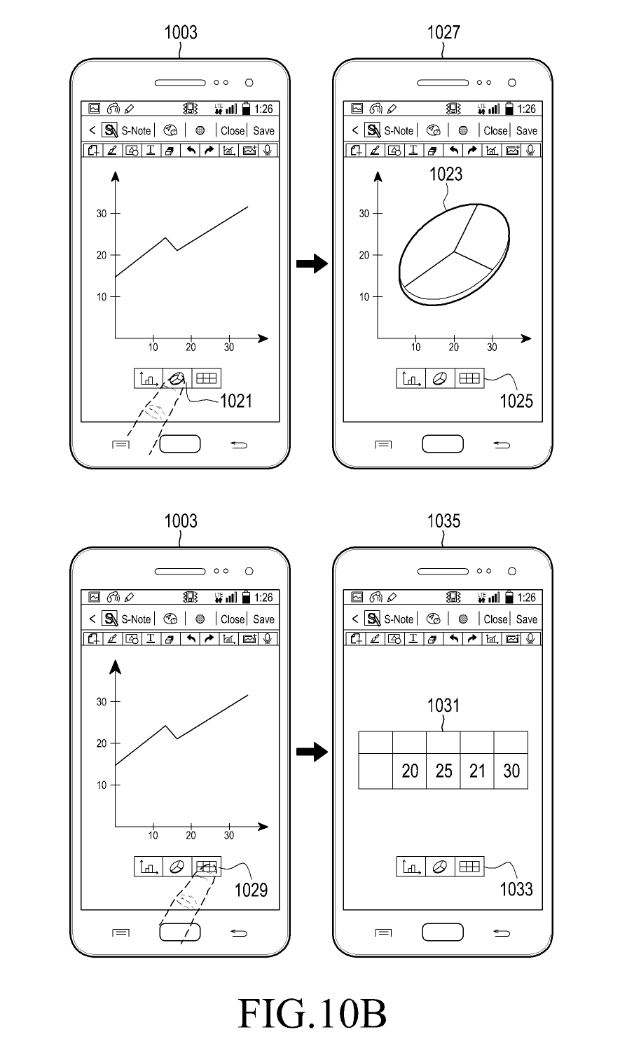

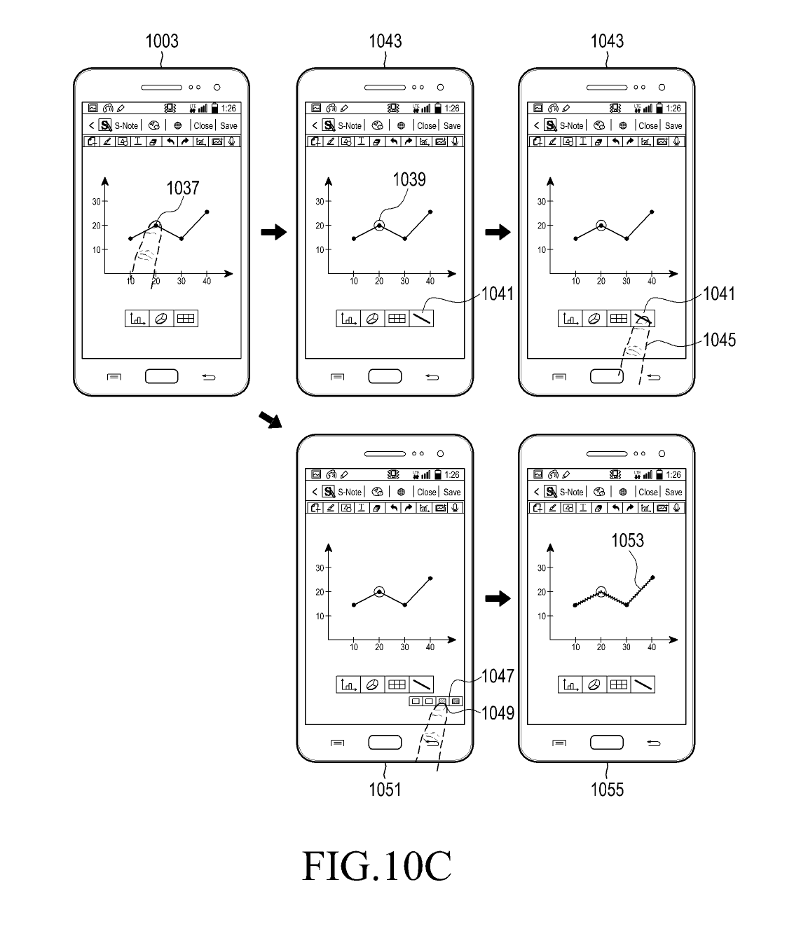

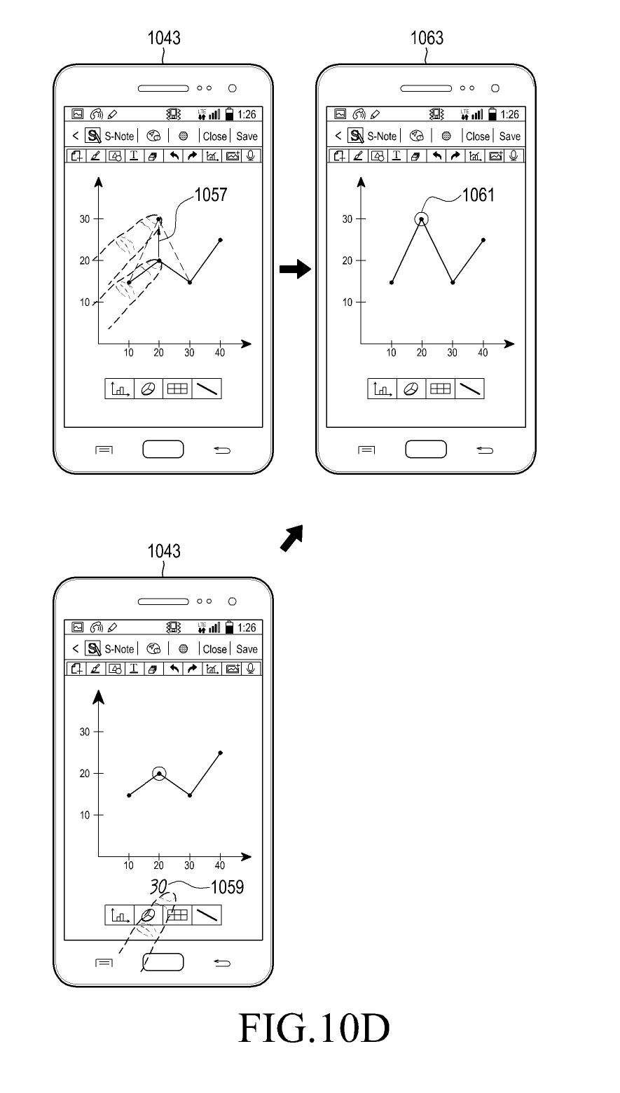

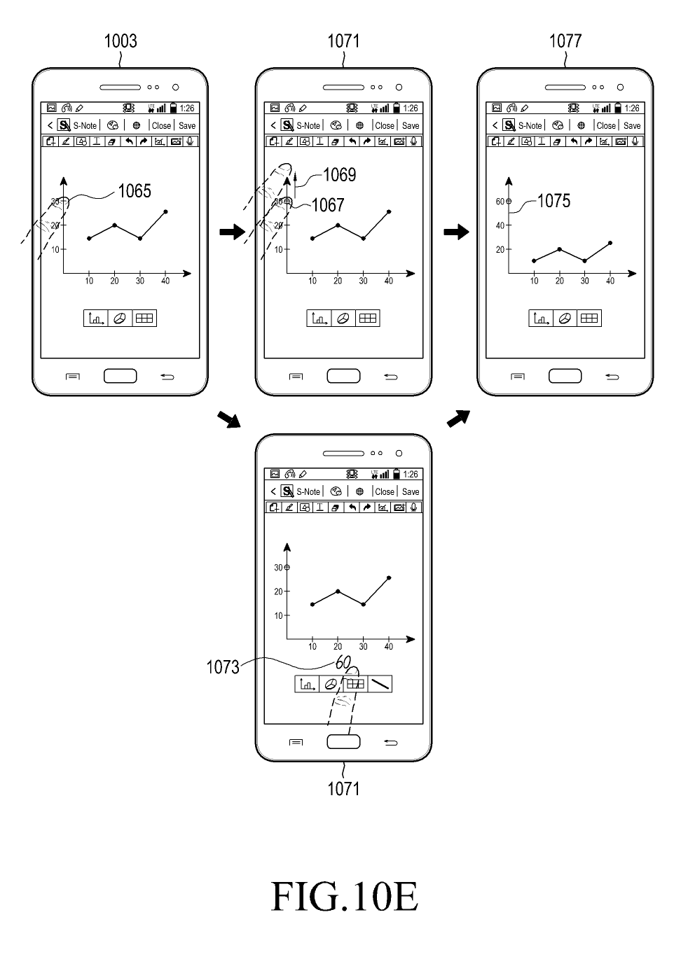

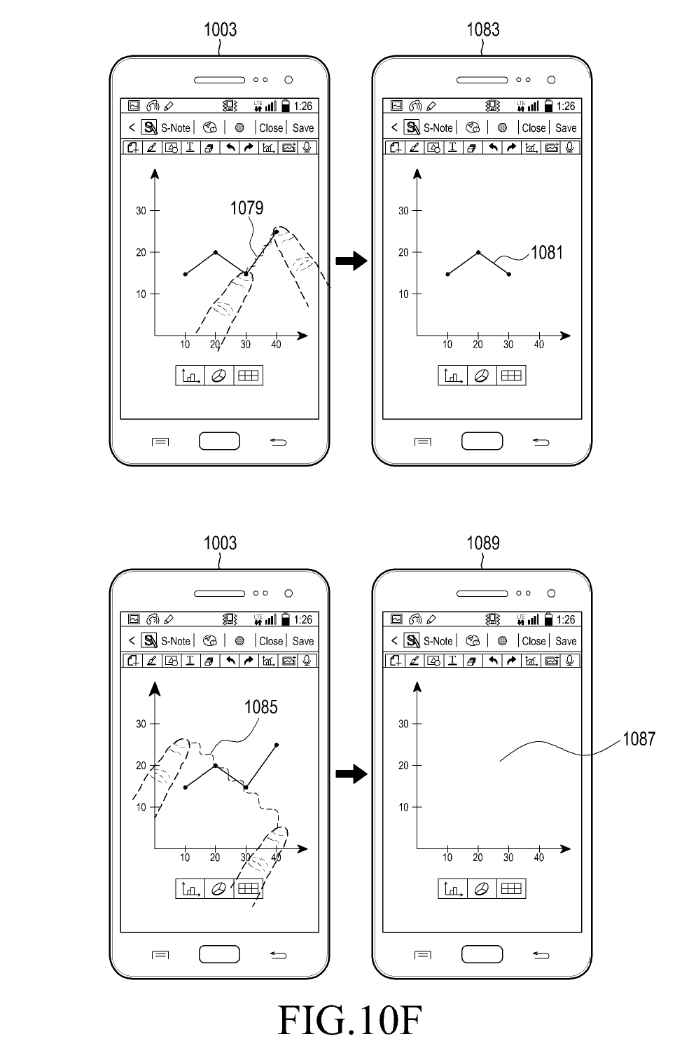

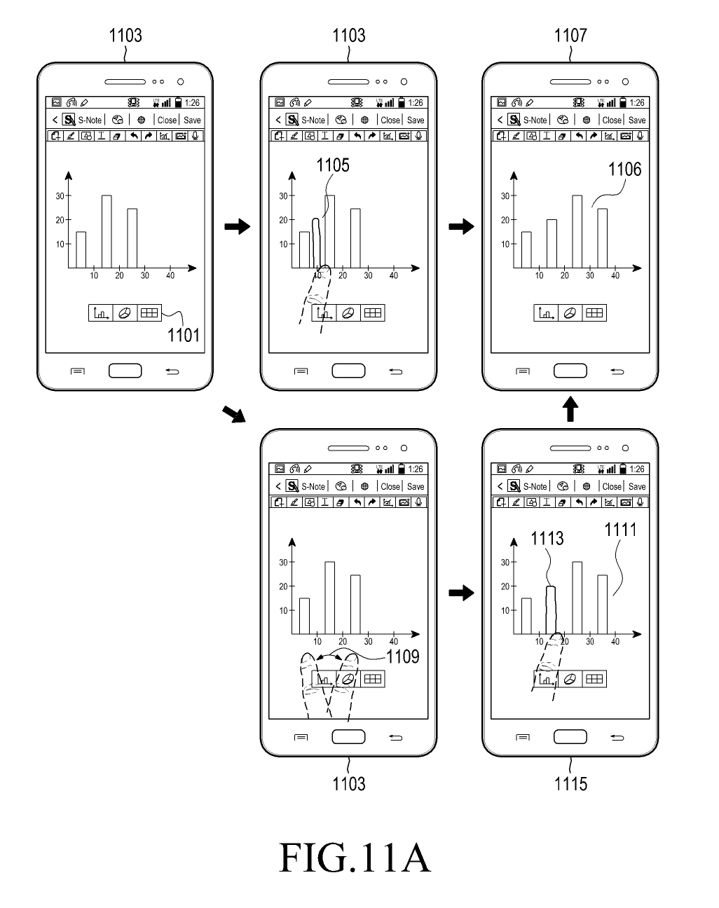

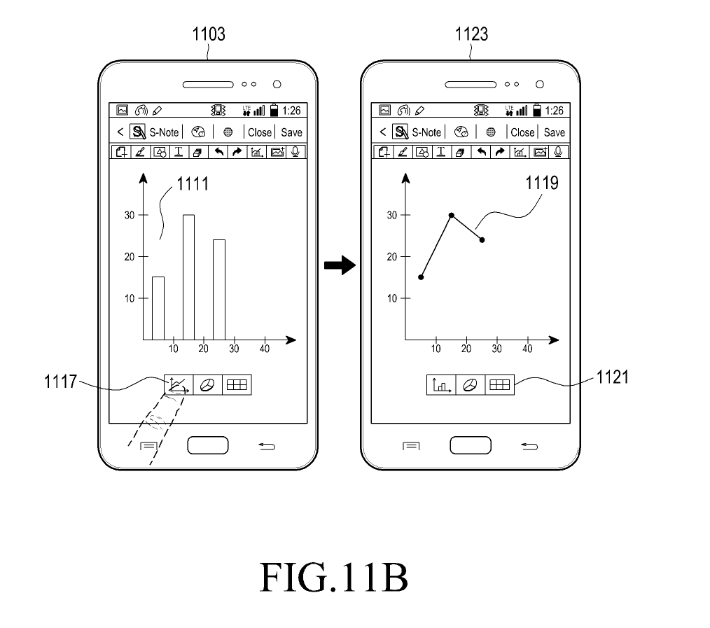

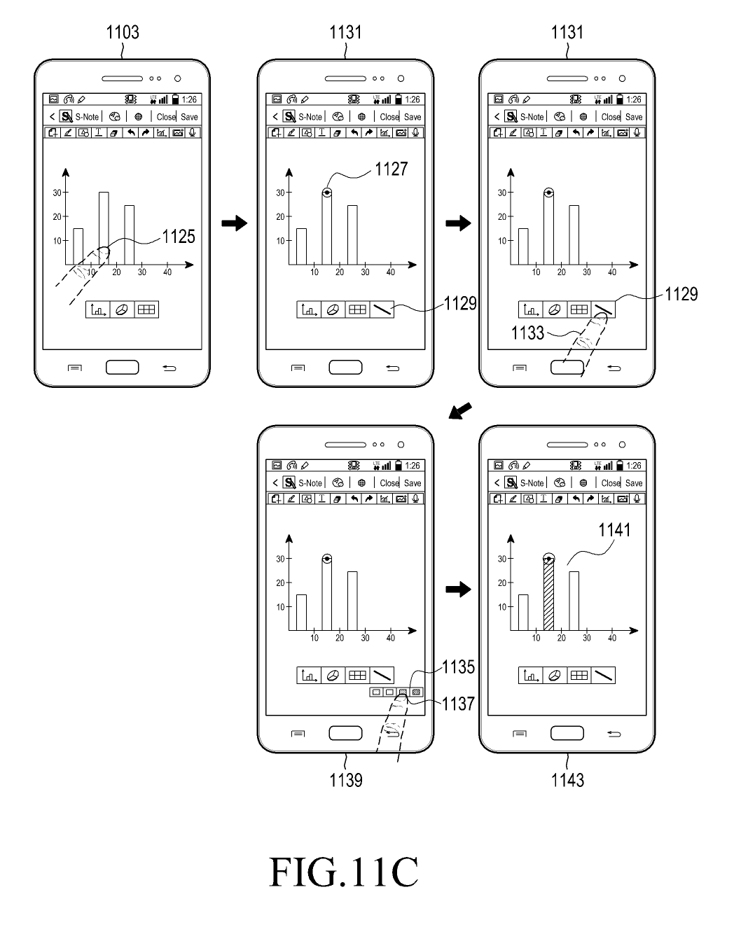

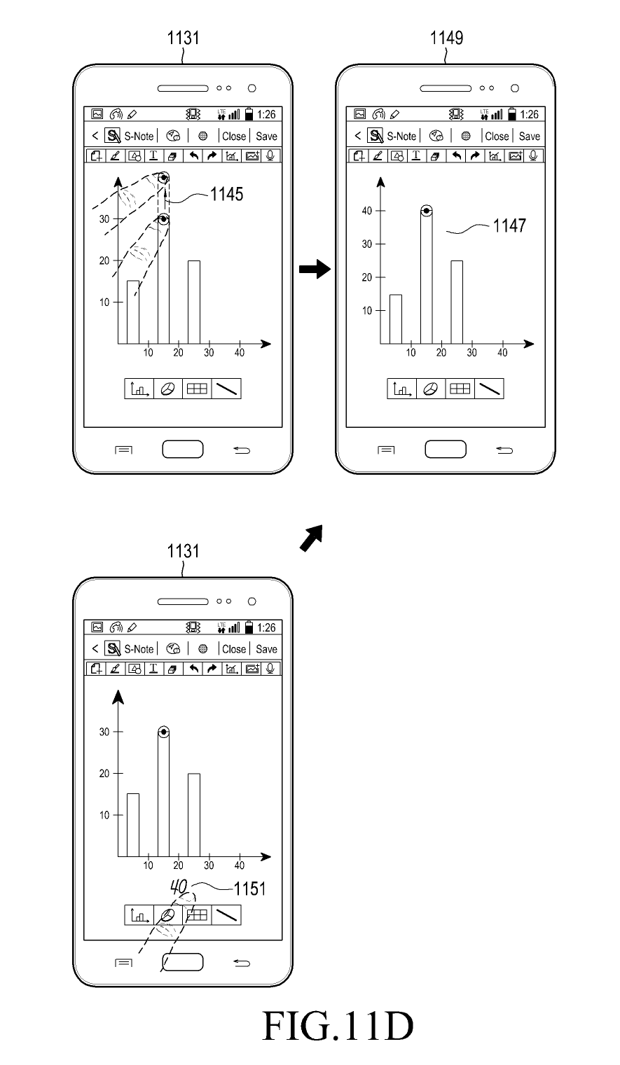

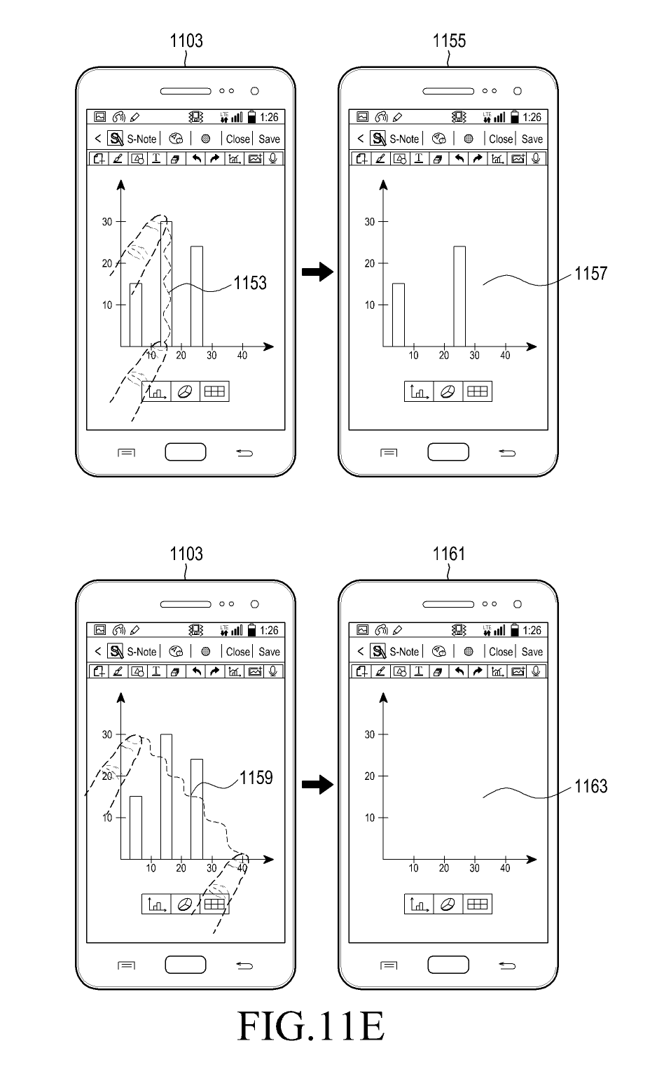

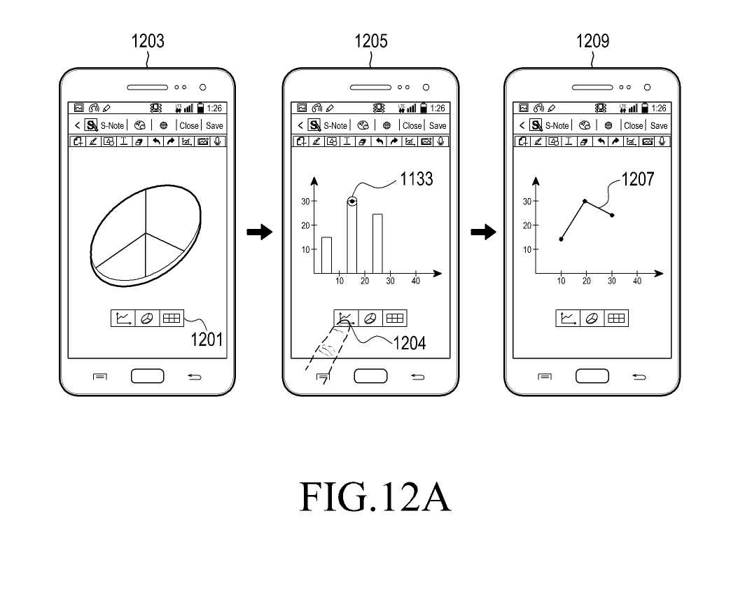

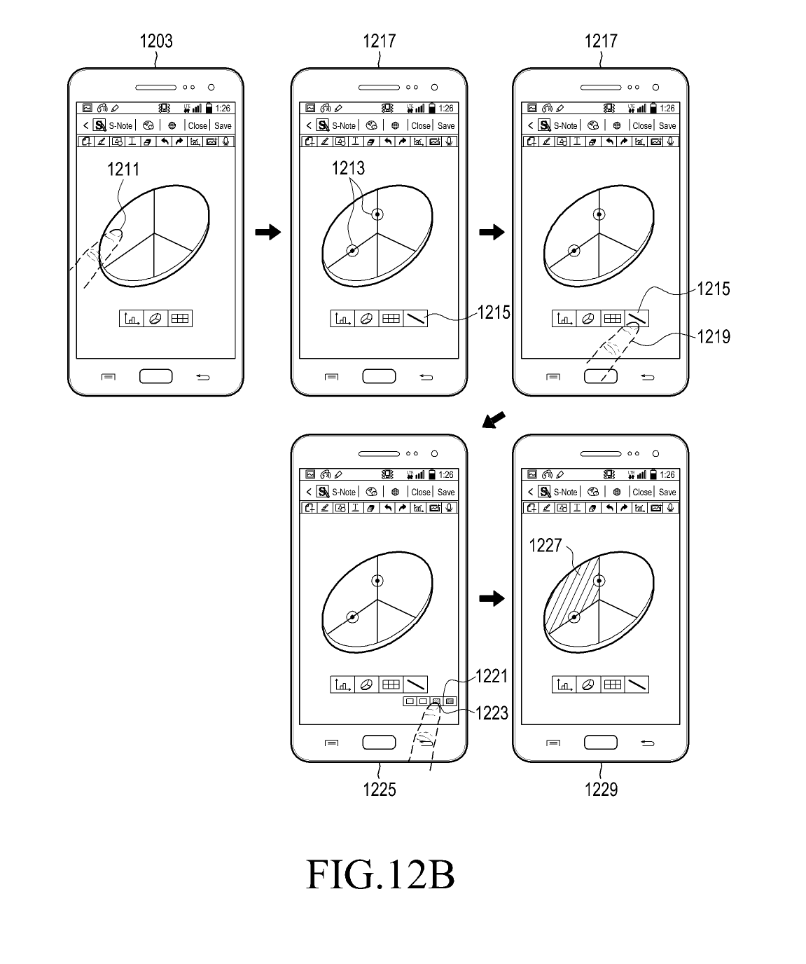

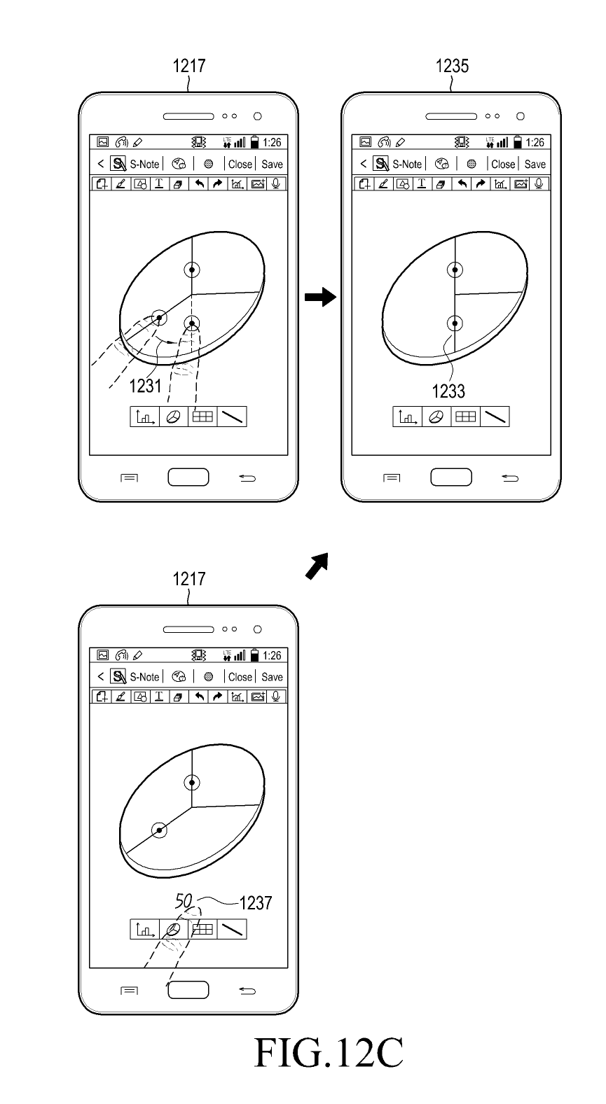

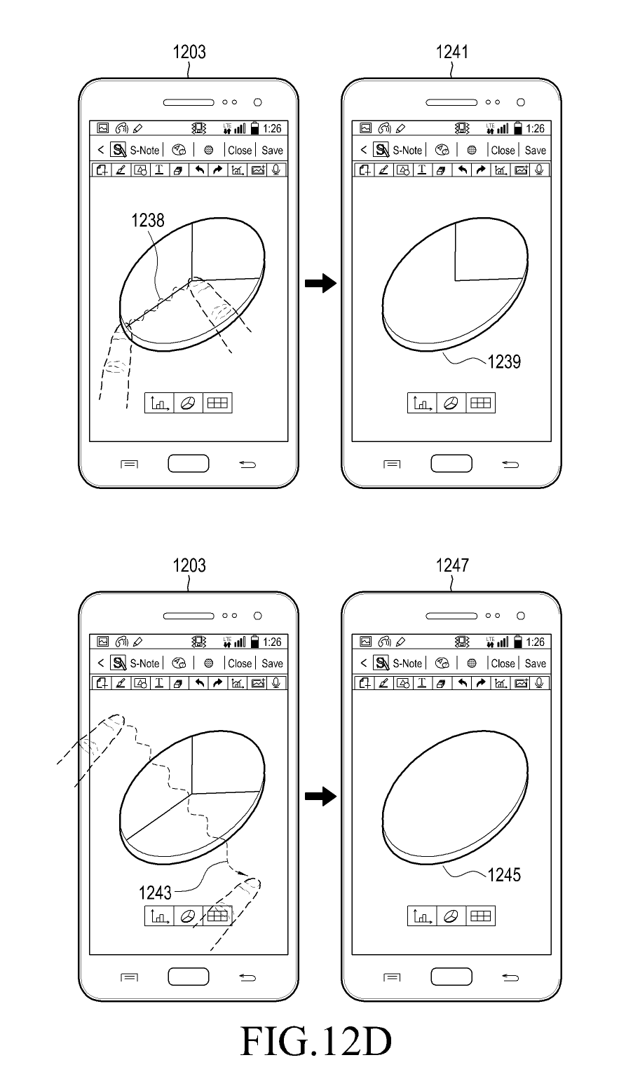

More specifically, the controller 101 may display a chart graph. For example, the controller 101 may display a chart in any one of the chart types supportable by the mobile electronic device. For example, the controller 101 may display a line graph as shown in a screen 1003 of FIG. 10A. As another example, the controller 101 may display a bar graph as shown in a screen 1103 of FIG. 11A. As further another example, the controller 101 may display a pie graph as shown in a screen 1203 of FIG. 12A.

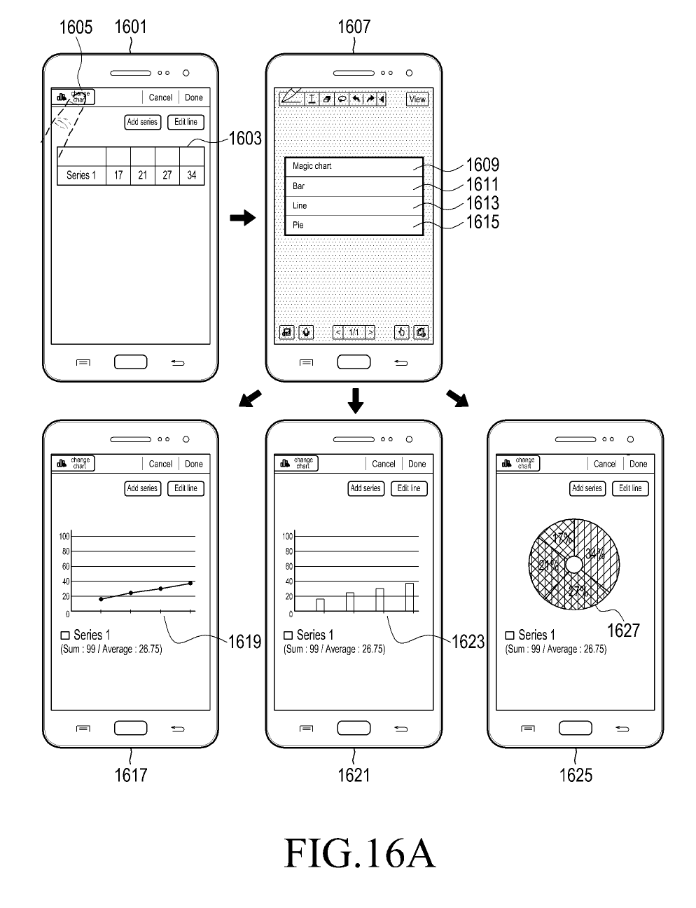

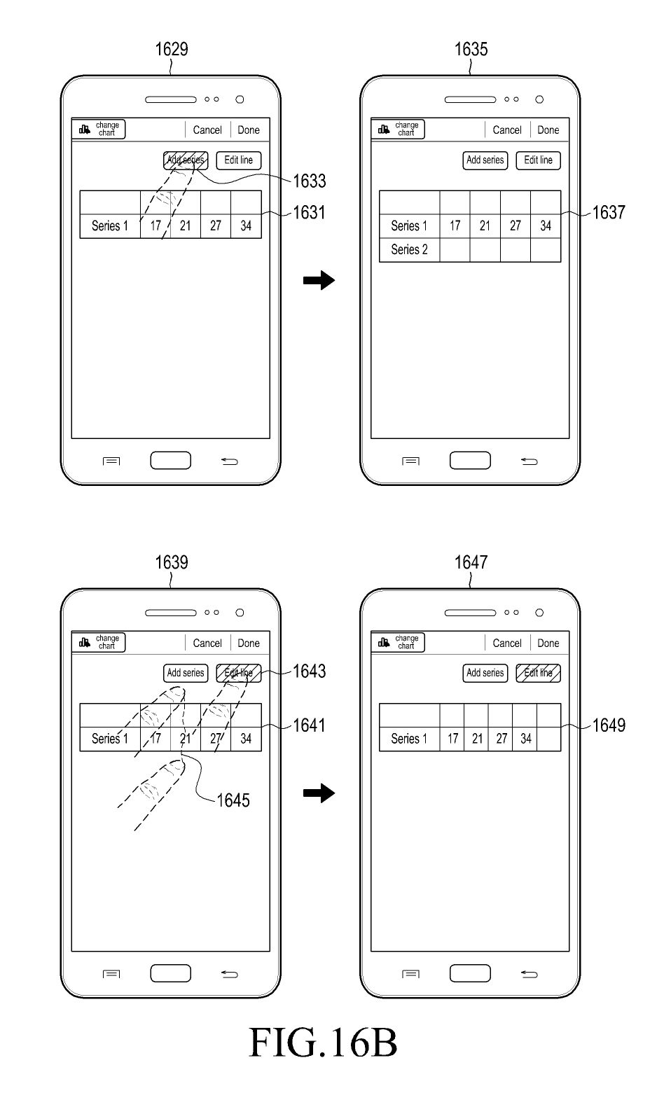

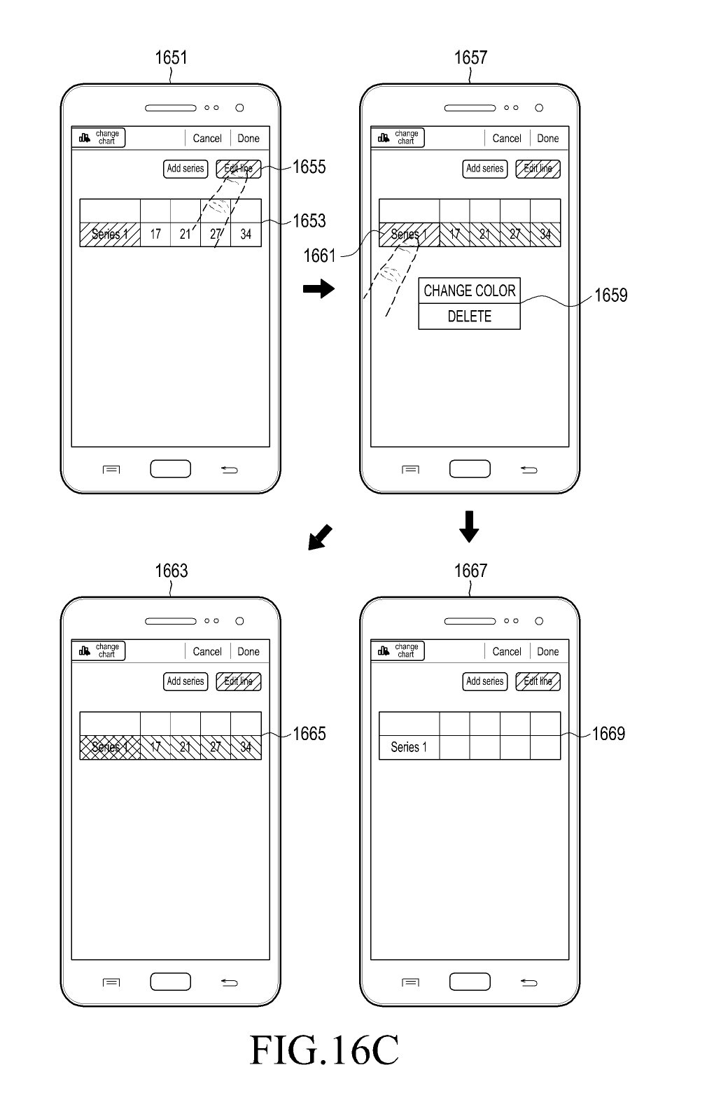

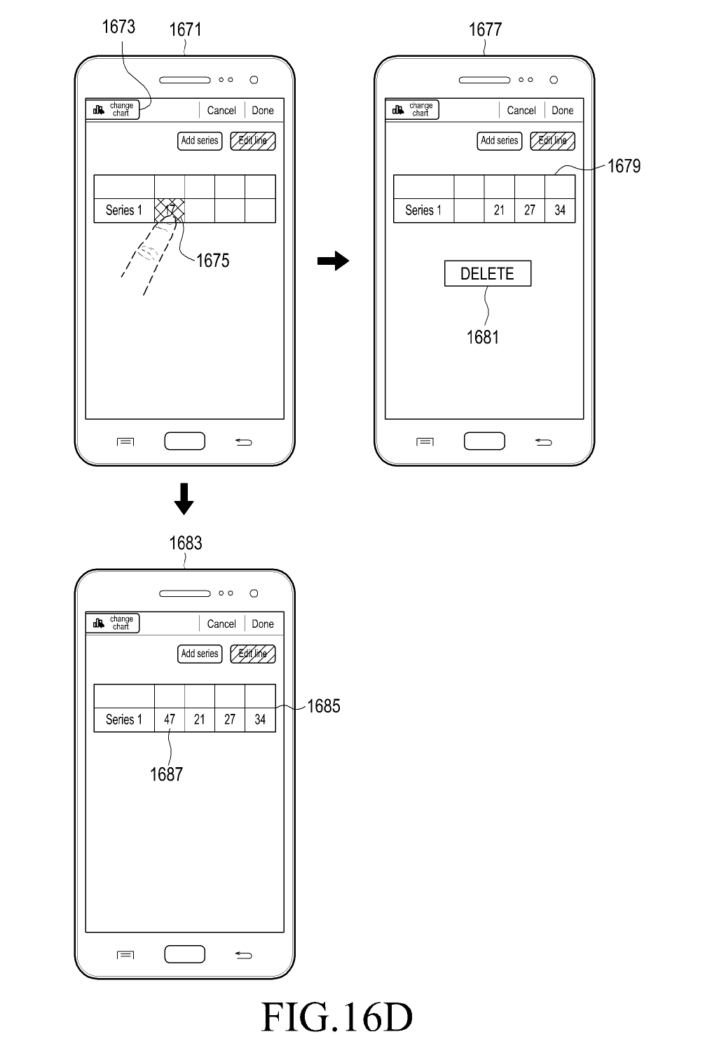

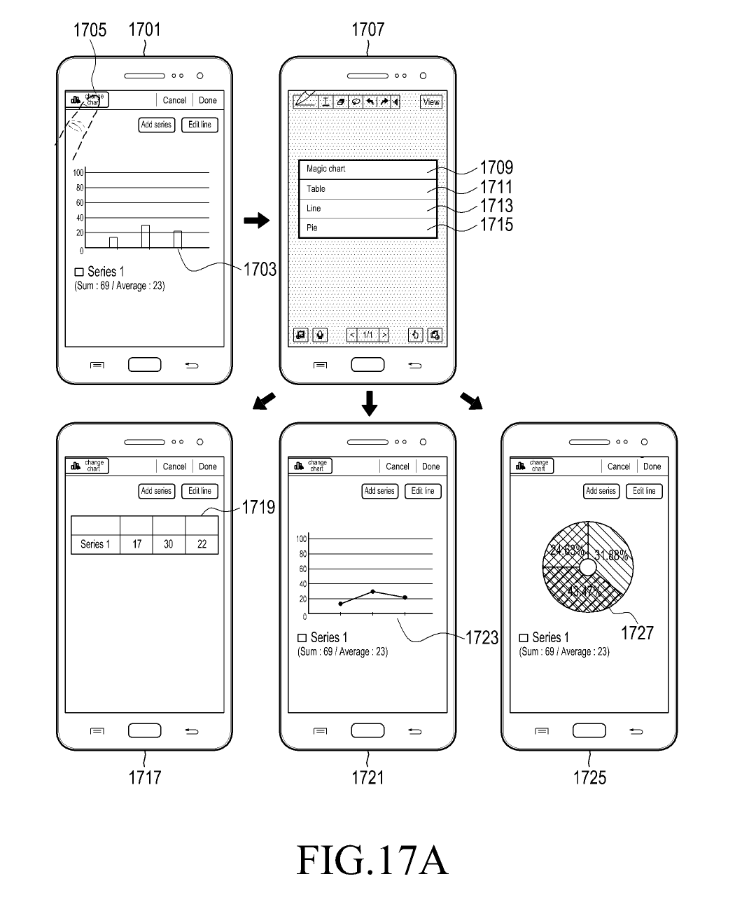

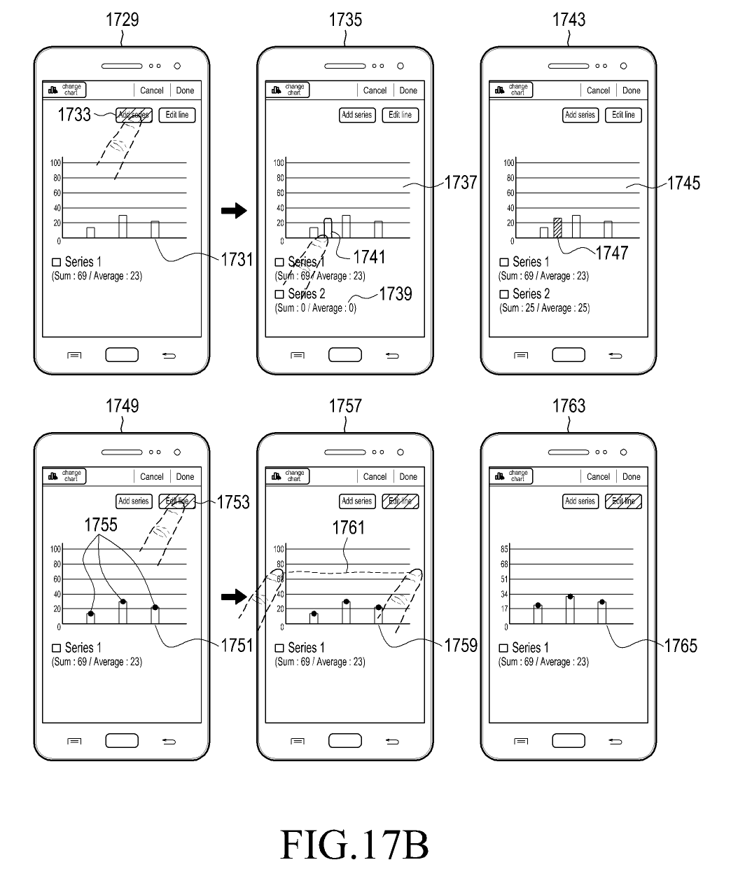

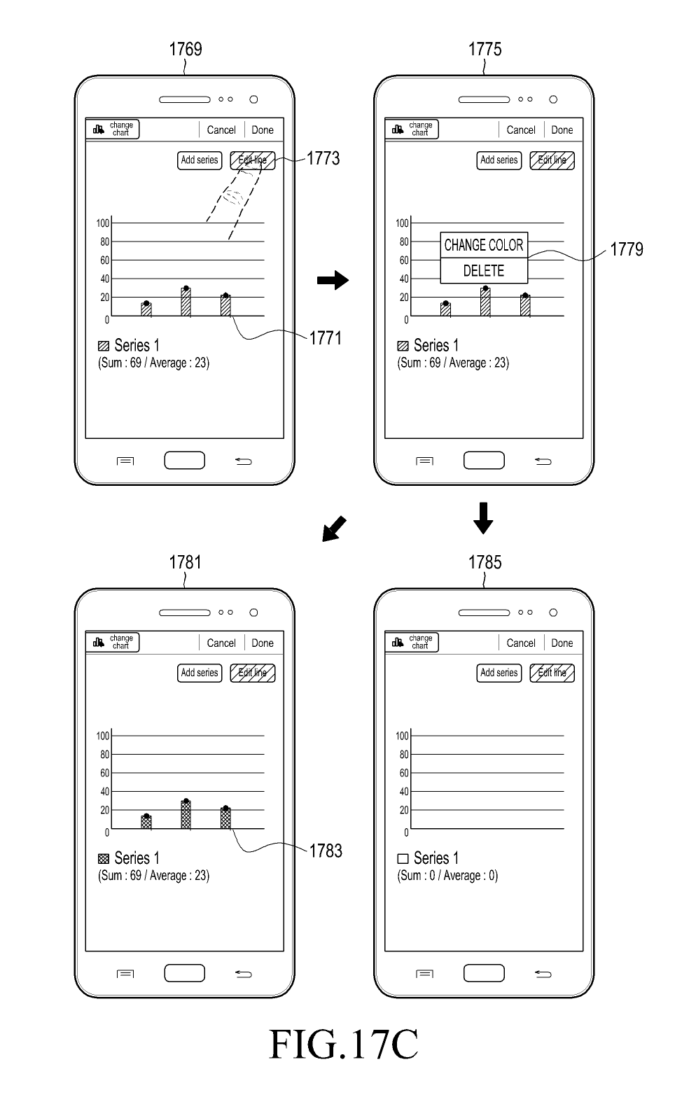

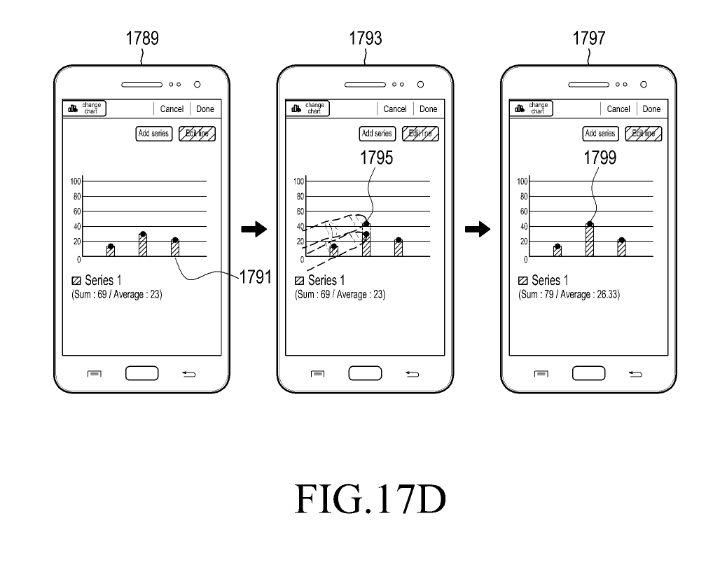

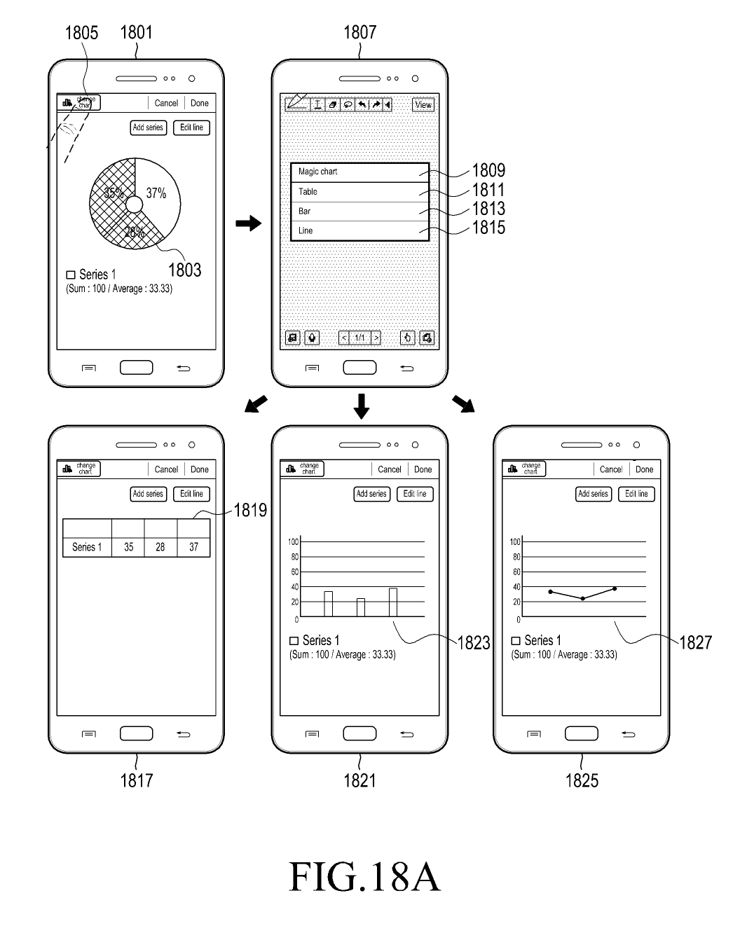

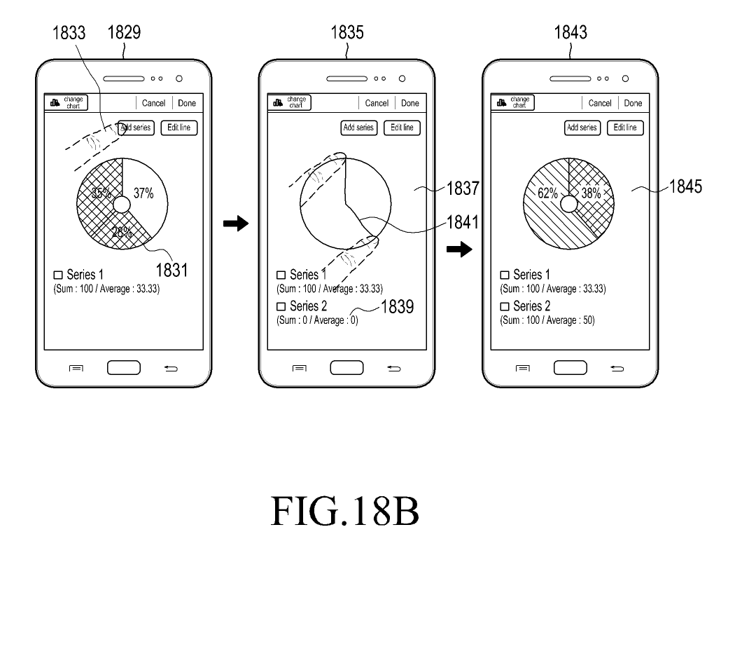

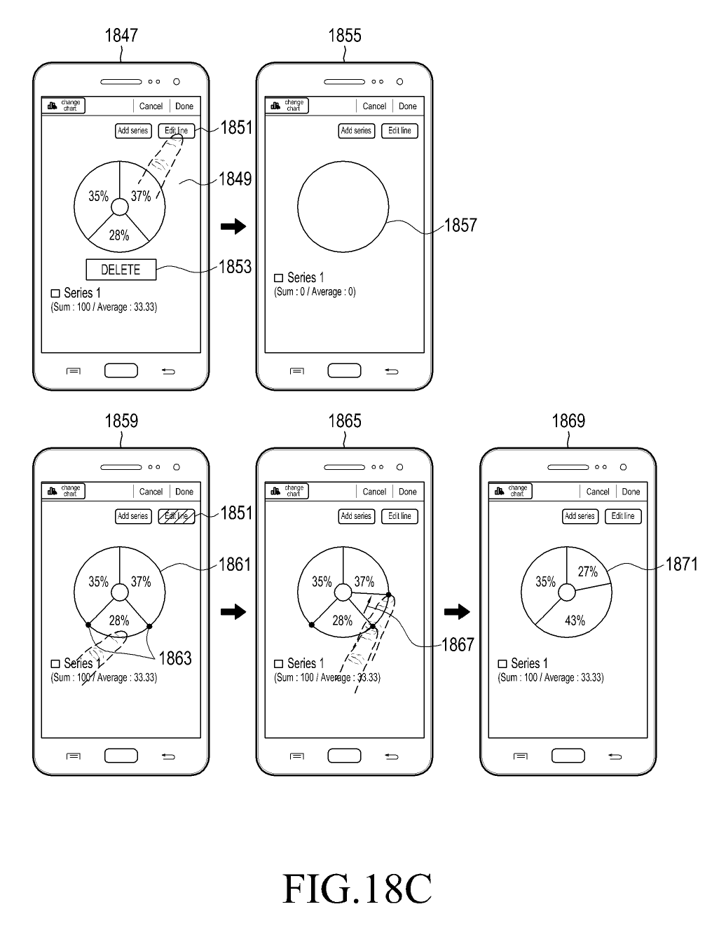

As further another example, the controller 101 may display a chart table as shown in a screen 1601 of FIG. 16A. As further another example, the controller 101 may display a bar graph as shown in a screen 1701 of FIG. 17A. As further another example, the controller 101 may display a pie graph as shown in a screen 1801 of FIG. 18A.

The controller 101 may determine whether an object is additionally entered in the displayed chart graph.

If an object is additionally entered, the controller 101 may recognize the additionally entered object, and update the chart data based on the recognized object.

For example, if an object or a curve 1005 is entered on a line graph as shown in a screen 1007 of FIG. 10A, the controller 101 may recognize start and end points and at least one inflection point of the curve 1005, estimate y-axis values corresponding to the recognized start and end points and inflection point, and update the chart data of the line graph based on the estimated y-axis values. More specifically, if the y-axis values corresponding to the start point, one inflection point and the end point of the curve 1005 are 15, 10, and 20, the controller 101 may generate chart data shown in Table 4 by updating the chart data shown in Table 1 based on the y-axis values of 15, 10, and 20.

TABLE 4

| / | | | | |
|---|---|---|---|---|
| | 17 | 21 | 27 | 34 |
| | 15 | 10 | 20 | |

As another example, if objects or a plurality of points are entered on a line graph, the controller 101 may recognize the plurality of points, estimate y-axis values corresponding to the plurality of recognized points, and update the chart data of the line graph based on the estimated y-axis values. More specifically, if the y-axis values corresponding to the plurality of points are 15, 10, and 20, the controller 101 may generate chart data shown in Table 4 by updating the chart data shown in Table 1 based on the y-axis values of 15, 10, and 20.

As further another example, if an object or a bar 1105 is entered on a bar graph as shown in a screen 1103 of FIG. 11A, the controller 101 may estimate the maximum value of the y-axis of the bar 1105, and update the chart data of the bar graph based on the estimated y-axis value. More specifically, if the object or the bar 1105 is entered between the first and second bars included in the bar graph and the maximum value of the y-axis of the bar 1105 is 25, the controller 101 may generate chart data shown in Table 5 by updating the chart data shown in Table 2 based on the input position (or entry position) and the maximum value ‘25’ of the y-axis of the bar 1105.

TABLE 5

| / | | | | |
|---|---|---|---|---|
| | 17 | 25 | 30 | 22 |

As further another example, if an Add Series menu is selected by the user as shown in a screen 1629 of FIG. 16B, the controller 101 may add a series in a chart table 1637 as shown in a screen 1635, and if objects or numbers are entered in the added series by the user, the controller 101 may update the chart table based on the entered at least one number. More specifically, if the entered numbers are 15, 10, and 20, the controller 101 may create a chart table shown in Table 4 by updating the chart table shown in Table 1 based on the entered numbers of 15, 10, and 20.

As further another example, if an Add Series menu is selected by the user as shown in a screen 1729 of FIG. 17B, the controller 101 may display series information 1739 indicating information about the added series as shown in a screen 1735, and if the added series is selected by the user and an object or a bar 1741 is entered on the bar graph as shown in a screen 1735 of FIG. 17B, the controller 101 may estimate the maximum value of the y-axis of the bar 1741, and update the chart data of the bar graph based on the estimated maximum value of the y-axis. More specifically, if the maximum value of the y-axis of the bar 1741 is 25, the controller 101 may generate chart data shown in Table 5 by updating the chart data shown in Table 2 based on the x-axis value and the maximum value ‘25’ of the y-axis of the bar 1741.

The controller 101 may create a chart graph based on the updated chart data, and display the created chart graph. For example, if the chart type corresponds to a line graph, the controller 101 may create a line graph based on the updated chart data shown in Table 4, and display a line graph 1009 including a broken line corresponding to the entered additional object and a broken line corresponding to the existing object, as shown in a screen 1011 of FIG. 10A. As another example, if the chart type corresponds to a chart table, the controller 101 may display a chart table shown in Table 4. As further another example, if the chart type corresponds to a bar graph, the controller 101 may create a bar graph based on the updated chart table shown in Table 5, and display a bar graph 1745 including a bar corresponding to the added series and a plurality of bars corresponding to the previous series, as shown in a screen 1743 of FIG. 17B.

If no object is additionally entered, the controller 101 may determine whether change in chart type is requested by the user. For example, the controller 101 may display a Change Chart Graph icon including a plurality of icons corresponding to available chart types, and if any one of the plurality of icons is selected by the user, the controller 101 may determine that change in chart type is requested.

For example, if the displayed chart graph is a line graph, the controller 101 may display a Change Chart Graph icon 1001 including a Bar Graph icon, a Pie Graph icon, and a Chart Data icon used for requesting display of chart data for the displayed chart graph, as shown in the screen 1003 of FIG. 10A. If a Bar Graph icon 1013 is touched by the user among the plurality of icons displayed in the Change Chart Graph icon 1001, the controller 101 may determine that a request to change a line graph to a bar graph is entered.

In the same manner, the controller 101 may determine entry of a chart type change request depending on the user's input, even if the displayed chart graph is a bar graph or a pie graph.

If change in chart type is requested, the controller 101 may display the displayed chart graph as a change-requested chart graph using the chart data of the displayed chart graph. For example, if a request to change a line graph to a bar graph is entered, the controller 101 may change a line graph to a bar graph 1015 based on the chart data of the line graph, as shown in a screen 1019 of FIG. 10A.

In the same manner, the controller 101 may change the chart type depending on the user's input, even if the displayed chart graph is a bar graph or a pie graph.

The controller 101 may determine whether chart modification is requested by the user. For example, if an element (for example, a specific area of a broken line, or a specific area of a bar or a circle) included in the chart graph is selected, or an Edit Line menu is selected, the controller 101 may determine that chart modification is requested. As another example, if a specific area 1037 of a broken line included in a line graph is touched or is touched for a period of time as shown in the screen 1003 of FIG. 10C, the controller 101 may determine that modification of the touched specific area 1037 is requested. As further another example, if an Edit Line menu 1643 is touched by the user as shown in a screen 1639 of FIG. 16B, the controller 101 may determine that modification of the displayed chart graph is requested.

If chart modification is requested, the controller 101 may activate or enable a chart edit mode. The chart edit mode may refer to a mode for editing a color, a value, or the like, for a selected specific area of the displayed chart graph. If the chart edit mode is activated, the controller 101 may display an identification icon or a Change Color icon.

A first identification icon may refer to an icon used for indicating that a specific area selected by the user is being edited, and the Change Color icon may refer to an icon used for receiving a color change request for a selected specific area from the user. For example, if chart modification is requested by the user, the controller 101 may display a first identification icon 1039 and a Change Color icon 1041 as shown in a screen 1043 of FIG. 10C.

The controller 101 may determine whether change in chart color is requested by the user. For example, if the displayed Change Color icon or Change Color menu is selected by the user, the controller 101 may determine that change in chart color is requested. As another example, if the Change Color icon 1041 is touched by the user as shown in the screen 1043 of FIG. 10C, the controller 101 may determine that change in chart color is requested. As further another example, if one series included in a chart table is touched by the user and then a key is touched by the user, the controller 101 may display an Edit Chart menu 1659 including a Change Color menu for requesting change in chart color and a Delete menu for deleting some areas of the chart graph, as shown in a screen 1657 of FIG. 16C, and if the Change Color menu included in the Edit Chart menu 1659 is touched by the user, the controller 101 may determine that change in chart color is requested.

If change in chart color is requested, the controller 101 may display a palette including a plurality of colors, and if any one of the plurality of colors included in the displayed palette is selected by the user, the controller 101 may change the color of the selected specific area to the selected color.

For example, if the Change Color icon 1041 is touched, the controller 101 may display a palette 1047 including a plurality of colors as shown in a screen 1051 of FIG. 10C, and determine whether a specific color among the plurality of colors included in the palette 1047 is selected by the user. If a specific color 1049 is selected from among the plurality of colors included in the palette 1047, the controller 101 may change the color of a broken line 1053 including a selected specific area to the specific color 1049, as shown in a screen 1055 of FIG. 10C. As another example, if the Change Color menu is touched, the controller 101 may display a palette including a plurality of colors, and if a specific color among the plurality of colors included in the palette is selected by the user, the controller 101 may change the color of the touched series to the specific color as shown in a screen 1663 of FIG. 16C.

The controller 101 may determine whether change in chart value is requested by the user. For example, if the displayed first identification icon is shifted from the current position to another position by the user, if a number is entered in an object input window, or if a number is entered in a chart table, the controller 101 may determine that change in chart value is requested.

For example, if the first identification icon 1039 is touched by the user in the screen 1043 of FIG. 10C, the controller 101 may determine that change in value of a specific area is requested. As another example, if a specific number 1059 is entered by the user in a screen 1043 of FIG. 10D, the controller 101 may determine that change in chart value of the specific area is requested. As further another example, after chart modification is requested by the user, if a specific area of a chart table 1669 is selected by the user as shown in a screen 1667 of FIG. 16C, the controller 101 may determine that change in chart value of a specific area is requested.

If change in chart value is requested, the controller 101 may estimate the change-requested chart value based on the user's input, and update the chart data of the displayed chart graph based on the estimated chart value. For example, if the first identification icon 1039 undergoes a touch-and-drag and touch-off gesture 1057 by the user in the screen 1043 of FIG. 10D, the controller 101 may estimate a y-axis value corresponding to the touch-off point in the coordinate system. If the estimated y-axis value is 30, the controller 101 may generate chart data shown in Table 6 by updating the chart data shown in Table 1 based on the estimated y-axis value.

TABLE 6

| / | | | | |
|---|---|---|---|---|
| | 17 | 30 | 27 | 34 |

As another example, if the specific number 1059 is entered by the user in the screen 1043 of FIG. 10D, the controller 101 may recognize the specific number. If the recognized specific number is 30, the controller 101 may generate chart data shown in Table 6 by updating the chart data shown in Table 1 based on the recognized specific number.

As further another example, if a specific number is entered in a specific area of the chart table 1669 by the user in the screen 1667 of FIG. 16C, the controller 101 may recognize the entered specific number. If the recognized specific number is 47, the controller 101 may update the chart data shown in Table 1 based on the specific number ‘47’.

The controller 101 may create a chart graph based on the updated chart data, and display the created chart graph.

For example, if the displayed chart type corresponds to a line graph, the controller 101 may create a line graph based on the updated chart data shown in Table 6, and display the line graph including an identification icon 1061 whose y-axis value is 30 in the coordinate system, as shown in a screen 1063 of FIG. 10D. As another example, if the chart type corresponds to a chart table, the controller 101 may create a chart table based on the updated chart data, and display a chart table 1685 including a specific number ‘47’ 1687 as shown in a screen 1683 of FIG. 16D.

The controller 101 may determine whether deactivation of chart edit mode is requested by the user. For example, if an icon unrelated to chart editing (for example, a Change Chart Type icon, and the like) is selected, if no identification icon or no Change Color icon is selected for a period of time, or if no specific number is entered for a period of time, the controller 101 may determine that deactivation of chart edit mode is requested.

If deactivation of chart edit mode is requested, the controller 101 may deactivate the chart edit mode, and display no identification icon and no Change Color icon.

The controller 101 may determine whether change in scale mark of the coordinate system included in an object input window is requested the user. For example, if the coordinate system is selected, the controller 101 may determine that change in scale mark of the coordinate system is requested. For example, if a coordinate system 1065 is touched or is touched for a period of time in a screen 1003 of FIG. 10E, the controller 101 may determine that change in scale mark of the coordinate system is requested. As another example, if a gesture 1761 is entered in parallel to the x-axis of the coordinate system as shown in a screen 1757 of FIG. 17B, the controller 101 may determine that change in scale mark of the coordinate system is requested.

If change in scale mark of the coordinate system is requested, the controller 101 may estimate the change-requested scale marks based on the user's input, change scale mark data of the coordinate system based on the estimated scale marks, change scale marks of the displayed coordinate system based on the changed scale mark data, and change the size of the chart graph depending on the changed scale marks of the coordinate system. The scale mark data may refer to data for scale marks of the displayed coordinate system, and, for example, if the scale marks are 10, 20, and 30, the scale mark data may include 10, 20, and 30.

For example, if change in scale mark of the coordinate system is requested, the controller 101 may display a second identification icon on the coordinate system. If a second identification icon 1067 undergoes a touch-and-drag and touch-off gesture 1069 by the user in a screen 1071 of FIG. 10E, the controller 101 may determine an increase or decrease in scale (for example, whether the scale of the coordinate system increases or decreases) based on the drag direction, and determine an increasing gap or a decreasing gap between scale marks (for example, whether the gap between scale marks increases or decreases) based on the time from the touch until the touch-off. If it is determined that the scale increases and the increasing gap (or increment) is 20, the controller 101 may change a coordinate system 1075 such that an increasing gap between scale marks on the y-axis becomes 20, as shown in a screen 1077 of FIG. 10E, thereby reducing the size of the chart graph.

As another example, if the gesture 1761 that horizontally crosses a bar graph is entered as shown in the screen 1757 of FIG. 17B, the controller 101 may divide the maximum (or full) scale of the y-axis by a value obtained by adding one (1) to the number of displayed scale mark lines, and determine the calculated value as a gap between scale marks. For example, if the maximum scale of the y-axis is 100 and the number of displayed scale mark lines is 5, the controller 101 may divide 100 by 6, and determine the calculated value ‘17’ as a gap between scale marks. If the gap between scale marks is determined as 17, the controller 101 may change a coordinate system included in a bar graph 1765 such that a gap between scale marks on the y-axis becomes 17, as shown in a screen 1763 of FIG. 17B, thereby increasing the size of the chart graph.

The controller 101 may determine whether chart deletion is requested by the user. For example, if a specific gesture is entered or a Delete menu is selected by the user, the controller 101 may determine that chart deletion is requested. For example, if a specific gesture (for example, a touch-off after touch-and-zigzag gesture) 1079 is entered by the user in a screen 1003 of FIG. 10F, the controller 101 may determine that chart deletion is requested. As another example, if a Delete menu 1681 is selected by the user in a screen 1677 of FIG. 16D, the controller 101 may determine that chart deletion is requested.

If chart deletion is requested, the controller 101 may recognize a specific area of the chart graph, deletion of which is requested by the user, update the chart data by deleting a value corresponding to the recognized specific area from the chart data of the displayed chart graph, and create and display a chart graph based on the updated chart data.

For example, if the specific gesture 1079 is entered in a specific area of a chart graph in the screen 1003 of FIG. 10F, the controller 101 may recognize the specific area in the chart graph. If the specific area corresponds to a straight line located between a scale mark 30 and a sale mark 40 on the x-axis, the controller 101 may generate chart data shown in Table 7 by deleting a value corresponding to the recognized specific area from the chart data shown in Table 1 based on the recognized specific area.

TABLE 7

| / | | | |
|---|---|---|---|
| | 17 | 21 | 27 |

As another example, if a specific area 1675 in the chart table shown in the screen 1671 is touched by the user and then a Delete menu 1681 is touched by the user, the controller 101 may delete a chart value included in the specific area 1675, and display a chart table 1679 as shown in a screen 1677 of FIG. 16D.

The controller 101 may determine whether a letter is entered by the user. The letter may include a number and a character. The number may include Arabic numerals, and the character may include Alphabet, Hangul (Korean Alphabet), Hiragana (Japanese Alphabet), Chinese characters, and the like. If a letter is entered, the controller 101 may determine whether the entered letter is a number.

If the entered letter is a number, the controller 101 may determine a chart value or a scale mark closest to the number's input position in the displayed chart graph, and change the chart data or scale mark data of the displayed chart graph based on the entered number. The scale mark data may refer to data regarding scale marks of the coordinate system, and, for example, if the y-axis scale marks of the coordinate system are 10, 20, and 30, the scale mark data may include 10, 20, and 30.

For example, if a scale mark is changed to an entered number, the controller 101 may determine an increase or decrease in scale, and an increasing gap or a decreasing gap between scale marks, based on the entered number. The controller 101 may change scale mark data of the chart graph based on the determined increase or decrease in scale and the determined increasing gap or decreasing gap between scale marks.

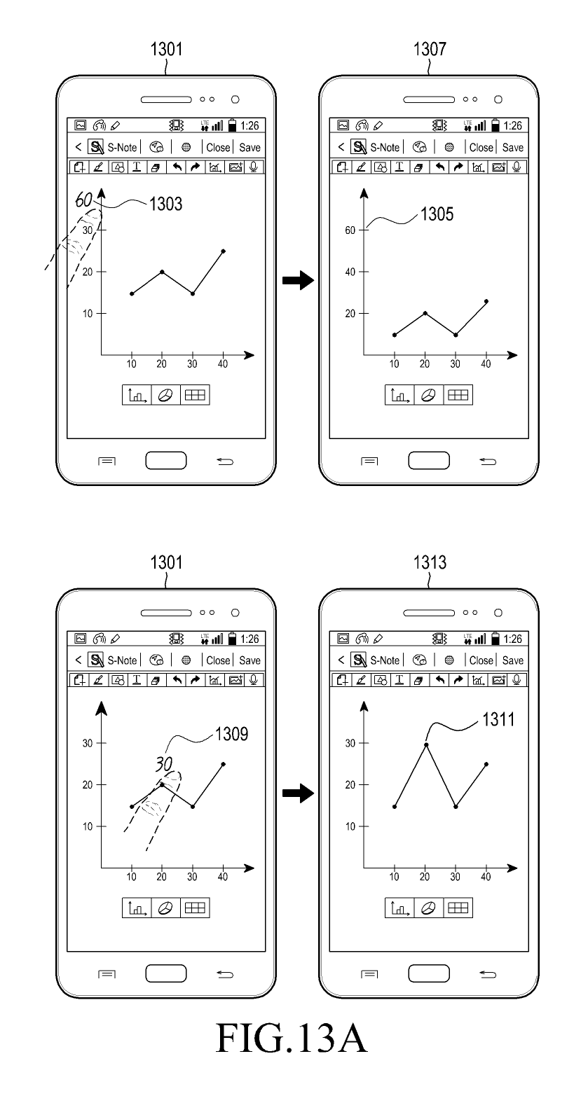

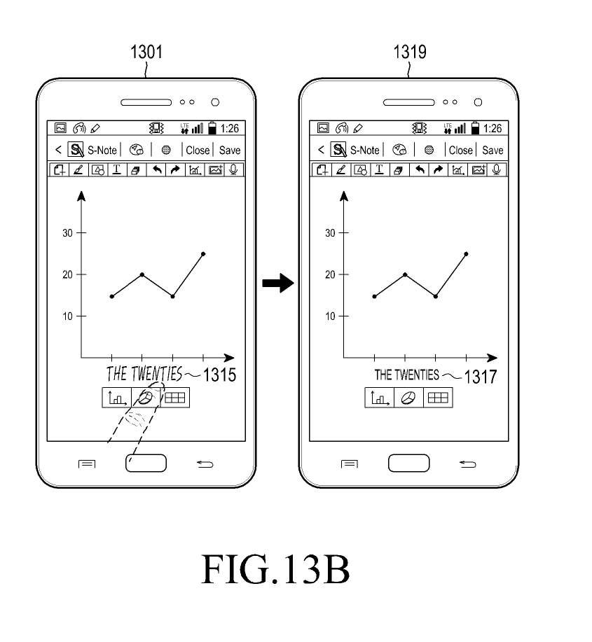

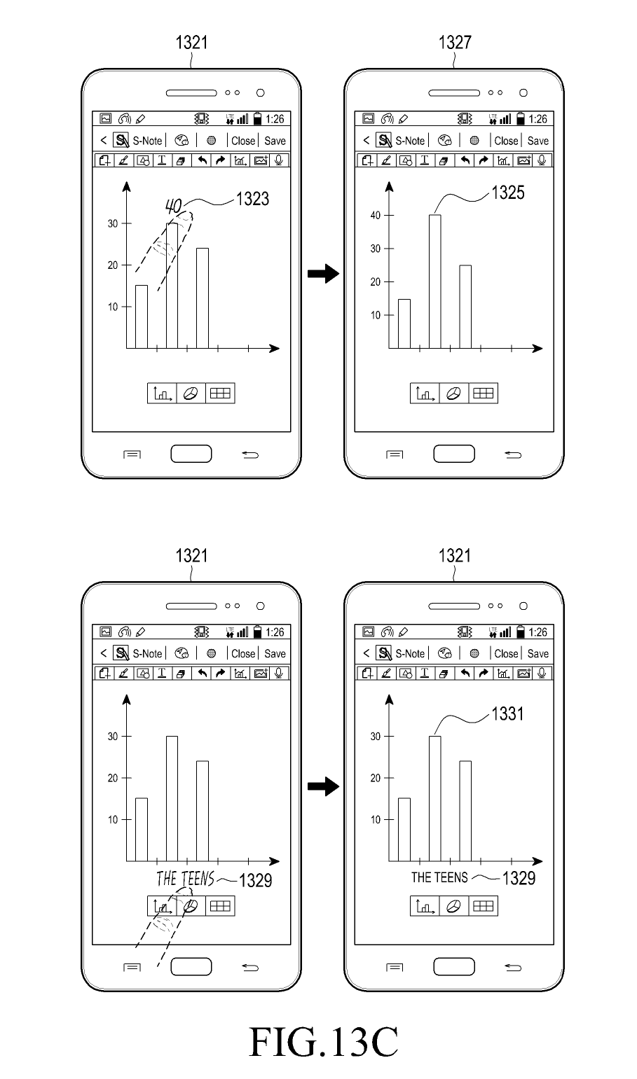

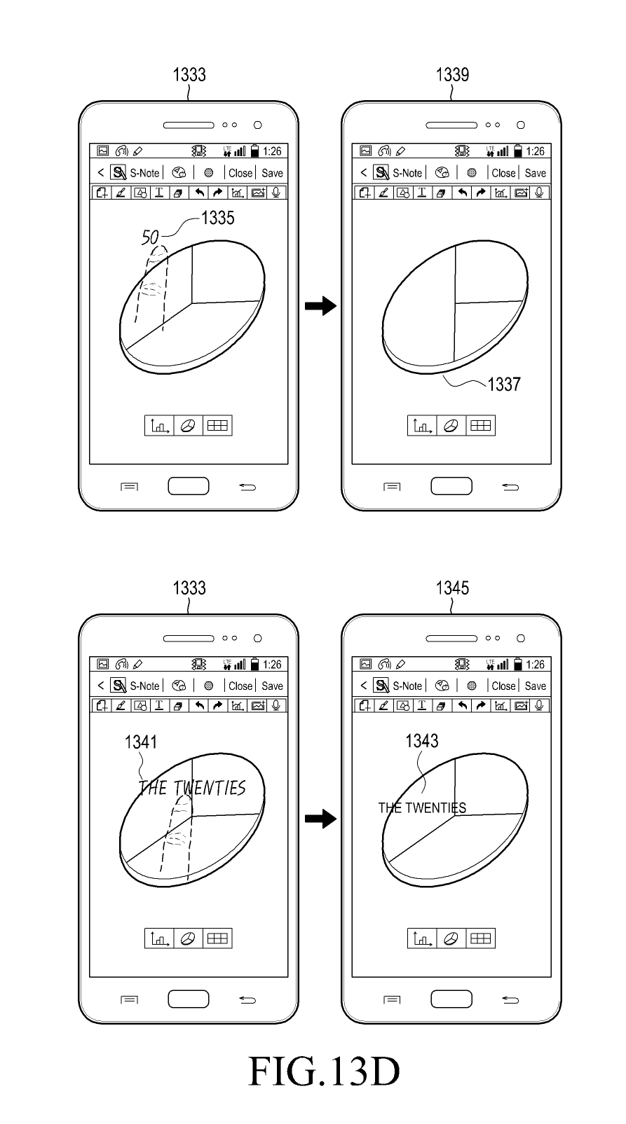

For example, if a number ‘60’ is entered by the user and an element closest to the input position of the number ‘60’ is a scale mark ‘30’, as shown in a screen 1301 of FIG. 13A, the controller 101 may compare the entered number ‘60’ with the scale mark ‘30’. As a result of comparison, if the entered number ‘60’ exceeds the scale mark ‘30’, the controller 101, determining that the scale increases, may determine an increasing gap between scale marks as 20 by dividing the entered number ‘60’ by the number ‘3’ of scale marks of the displayed coordinate system. The controller 101 may determine scale mark data 10, 20, and 30 of the displayed coordinate system, and update the scale mark data so that the scale mark data may include 20, 40, and 60, based on the determined increase in scale and the determined increasing gap ‘20’ between scale marks.

For example, if the chart value is changed to the entered number, the controller 101 may update the chart data of the displayed chart graph based on the entered number. For example, if a number ‘30’ is entered by the user and a chart value closest to the input position of the number ‘30’ is ‘20, as shown in the screen 1301 of FIG. 13A, the controller 101 may generate chart data shown in Table 6 by updating the chart data shown in Table 1 so that the chart value ‘20’ may be changed to the entered number ‘30’.

The controller 101 may change the displayed coordinate system or scale mark data based on the changed scale mark data or chart data. For example, as shown in a screen 1307 of FIG. 13A, the controller 101 may change scale marks 10, 20, and 30 of the displayed coordinate system to the scale marks 20, 40, and 60 (1305) based on the changed scale mark data, thereby reducing the size of the chart graph depending on the changed y-axis scale marks. As another example, the controller 101 may display a chart graph whose second chart data value is 30, based on the changed chart data, as shown in a screen 1313 of FIG. 13A.

The controller 101 may determine whether the entered letter is a character. If the entered letter is a character, the controller 101 may determine a chart value closest to the character's input position in the displayed chart graph, and display the entered character to be adjacent to the determined chart value.

For example, if characters ‘the twenties’ 1315 are entered by the user in a screen 1301 of FIG. 13B, the controller 101 may determine a scale mark closest to the input position of the characters 1315 among the scale marks of the x-axis. If the scale mark closest to the characters 1315 is ‘20’, the controller 101 may display characters ‘the twenties’ 1317 under the scale mark ‘20’ as shown in a screen 1319 of FIG. 13B.

An operation of storing a chart graph according to various embodiments of the present disclosure will be described. The controller 101 may determine whether chart storage is requested by the user. For example, the controller 101 may display a Save Chart icon, and if the Save Chart icon, a Save Chart menu, or a Done menu is selected by the user, the controller 101 may determine that chart storage is requested. The Save Chart icon may refer to an icon for requesting to save the displayed chart graph, and the Save Chart menu may refer to a menu for requesting to save the displayed chart graph. The Done menu may refer to a menu for indicating that the creation of a chart graph is done. For example, the Done menu may be a Done menu in the screen 1545 of FIG. 15B.

If chart storage is requested, the controller 101 may determine whether storing a chart in an image file format is requested by the user. For example, if an extension of a specific file format requested by the user corresponds to an extension (for example, *.bmp, *.dib, *.jpg, *.jpeg, *.jpe, *.jfif, *.gif, *.tif, *.tiff, *.png, *.pdf, and the like) of an image file format, the controller 101 may determine that storing a chart in an image file format is requested.

If storing a chart in a specific file format other than the image file format is requested, the controller 101 may store the chart data of the displayed chart graph in the specific file format requested by the user. For example, if the requested specific file format is a file format of Microsoft Word™, the controller 101 may store the chart data of the displayed chart graph in the file format of Microsoft Word™.

If storing a chart in an image file format is requested, the controller 101 may generate image data including a chart graph by capturing the displayed chart graph. The controller 101 may store an image file including the generated image data and the chart data of the displayed chart graph.

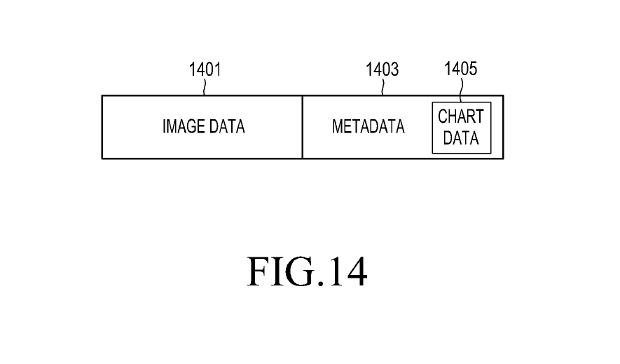

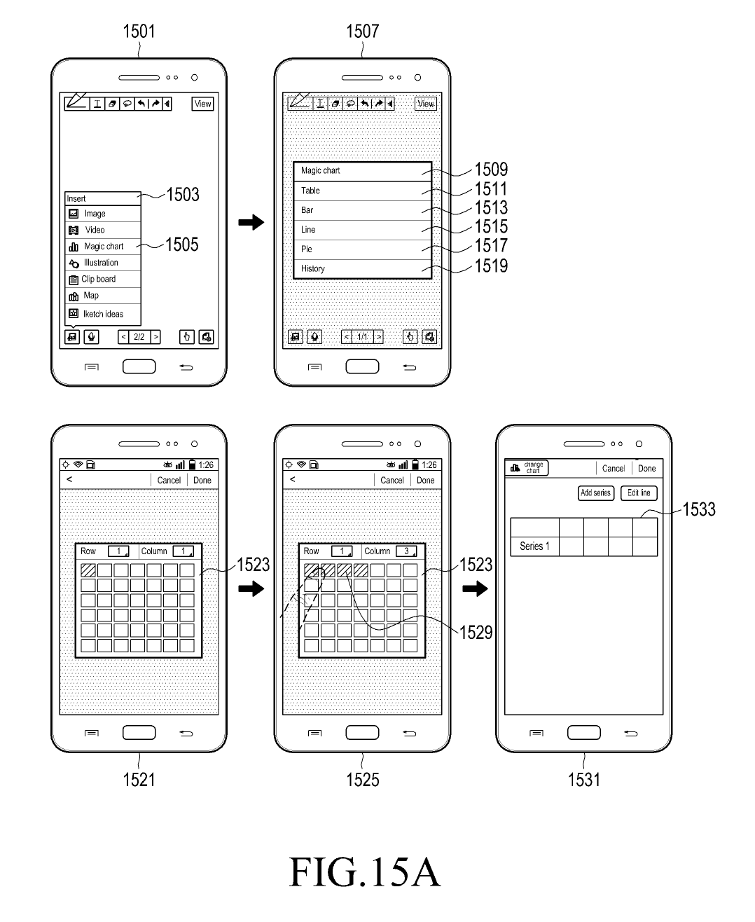

More specifically, by including or inserting chart data 1405 of a displayed chart graph in metadata 1403 corresponding to generated image data 1401 as illustrated in FIG. 14, the controller 101 may generate an image file including image data of the displayed chart graph and chart data of the displayed chart graph, and store the generated image file in the image file format requested by the user.

FIG. 2 is a flowchart of creating a chart in a mobile electronic device according to an embodiment of the present disclosure.

Referring to FIG. 2, at operation 201, the controller 101 may recognize an object entered by the user, generate chart data based on the recognized object, and display the chart based on the generated chart data.

The term ‘chart data’ as used herein may refer to data for a chart, and the chart data may include a chart name, a series list and a series name list. The series list may include a series value list and series colors. The series value list may include chart values and colors. An object may be entered using various methods, such as, for example, a user's finger, a stylus pen, a user's eyes, and the like. For example, if an object is entered by a user's finger or a stylus pen, the controller 101 may recognize an object formed by a gesture by detecting a gesture (for example, a touch-and-drag and touch-off gesture) made by the user's finger or the stylus pen. As another example, if an object is entered by the user's eyes, the controller 101 may recognize an object formed by movements of the user's eyes by detecting the movements (for example, a moving direction and a moving distance) of the user's eyes.

At operation 203, if a change request for a displayed chart is entered by the user, the controller 101 may change the displayed chart in response to the entered change request. The chart change may include object addition, graph (or chart) type switching, chart modification, and the like. The object addition may refer to an operation in which, if an object is entered by the user after a chart is displayed, the displayed chart is changed based on the entered object. The chart type switching may refer to an operation in which, if a chart type is selected by the user, the type of the displayed chart is switched to the selected type. The graph type (or chart type) may refer to a type of a graph representing a chart, and may include, for example, a line graph, a bar graph, a pie (or circle) graph, and the like.

The chart modification may be construed to include change in chart color, change in chart value, change in scale mark of the coordinate system, chart deletion, and the like. The ‘change in chart color’ may refer to an operation of changing the color of some areas or the entire area of a graph representing the chart to a color selected by the user. The ‘change in chart value’ may refer to an operation of changing chart values included in a graph representing the chart at the user's request. The ‘change in scale mark of the coordinate system’ may refer to an operation of changing scale marks of the coordinate system for a graph representing the chart at the user's request. The ‘chart deletion’ may refer to an operation of deleting some areas or the entire area of a graph representing the chart at the user's request.

At operation 205, if storage is requested by the user, the controller 101 may store chart data in a data format requested by the user. For example, if storing a chart as an image is requested by the user, the controller 101 may generate a chart image including a chart by capturing the displayed chart. The controller 101 may generate and store image data including the generated chart image and the chart data of the displayed chart.

Although it is assumed in FIG. 2 that operation 205 is performed after operations 201 and 203 are performed, operation 205 may be performed before operation 203.

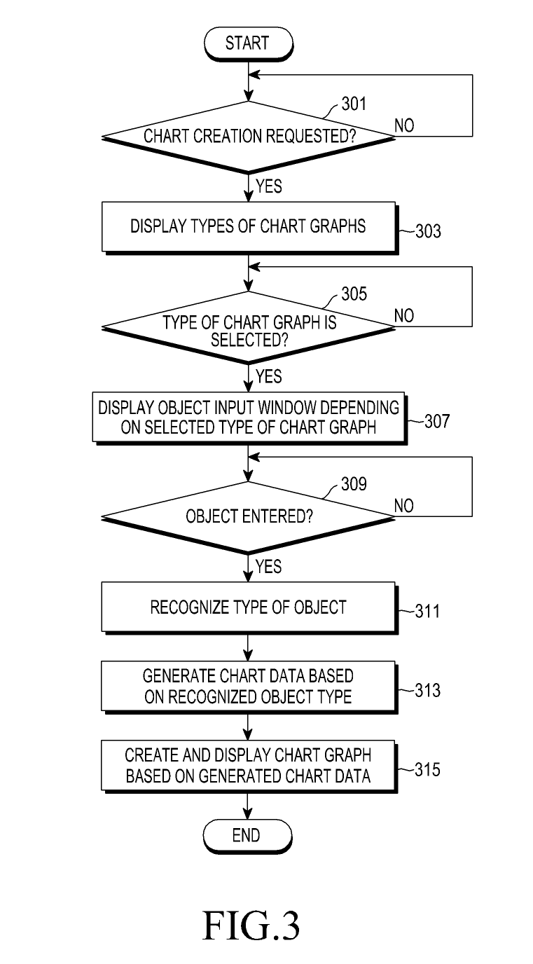

FIG. 3 is a flowchart of displaying a chart in a mobile electronic device according to a first embodiment of the present disclosure.

Referring to FIG. 3, at operation 301, the controller 101 may determine whether chart creation is requested by the user. For example, the controller 101 may display a Create Chart icon, and if the Create Chart icon is selected by the user, the controller 101 may determine that chart creation is requested. The Create Chart icon may refer to an icon used for receiving a request for chart creation from the user. For example, the controller 101 may display a Create Chart icon 803 as shown in a screen 801 of FIG. 8A, and if the Create Chart icon 803 is touched by the user, the controller 101 may determine that chart creation is requested. As another example, if an Insert Image icon 1503 is selected as shown in a screen 1501 of FIG. 15A, the controller 101 may display insertion menus including at least one insertable image type, and if a Magic Chart menu for requesting insertion of a chart is selected by the user from among the displayed insertion menus, the controller 101 may determine that chart creation is requested.

If chart creation is requested, the controller 101 may proceed to operation 303. Otherwise, the controller 101 may repeatedly perform operation 301.

At operation 303, the controller 101 may display types of graphs for showing a chart. The chart types (or graph types) may refer to chart types supportable by the mobile electronic device, and may include a line graph, a bar graph, a circle or oval graph, and the like. For example, if the Create Chart icon 803 is touched by the user, the controller 101 may display chart types 807 including a Line Graph icon 809, a Bar Graph icon 811 and a Pie Graph icon 813, as shown in a screen 805 of FIG. 8A. As another example, if a Magic Chart menu 1505 is selected by the user, the controller 101 may display a Chart Type menu 1509 including a Chart Table menu 1511, a Bar Graph menu 1513, a Line Graph menu 1515, a Pie Graph menu 1517, and a History menu 1519 showing the previously generated at least one chart, as shown in a screen 1507 of FIG. 15A.

At operation 305, the controller 101 may determine whether any one of the displayed chart types is selected. If it is determined at operation 305 that any one of the chart types is selected, the controller 101 may proceed to operation 307. Otherwise, the controller 101 may repeatedly perform operation 305. For example, if any one icon is touched among the Line Graph icon 809, the Bar Graph icon 811 and the Pie Graph icon 813 included in the chart types 807 displayed as shown in the screen 805 of FIG. 8A, the controller 101 may determine that any one of the displayed chart types is selected. As another example, if any one menu is touched in the Chart Type menu 1509 displayed as shown in the screen 1507 of FIG. 15A, the controller 101 may determine that any one of the displayed chart types is selected by the user.

At operation 307, the controller 101 may display an object input window depending on the selected chart type. The object input window may refer to a window used for receiving an object from the user, and may or may not include the coordinate system depending on the selected chart type.

For example, if the selected chart type corresponds to a line or bar graph, the controller 101 may display an object input window including the coordinate system, as shown in a screen 815 of FIG. 8B, a screen 833 of FIG. 8C, a screen 1553 of FIG. 15C, or a screen 1565 of FIG. 15D. As another example, if the selected chart type corresponds to a pie graph, the controller 101 may display an object input window including a circle, as shown in a screen 843 of FIG. 8D or a screen 1581 of FIG. 15E. As further another example, if the selected chart type corresponds to a chart table menu, the controller 101 may display a table setting window 1523 used for setting the size of the chart table, as shown in a screen 1521 of FIG. 15A. As further another example, if the selected chart type corresponds to a history menu, the controller 101 may display a history window 1595 including the previously generated at least one chart, as shown in a screen 1593 of FIG. 15F.

At operation 309, the controller 101 may determine whether an object is entered in an object input widow. The object may be entered by a user's finger, a stylus pen, a user's eyes, or the like. For example, if an object is entered by a user's finger or a stylus pen, the controller 101 may determine whether an object is entered, by detecting a gesture (for example, a touch-and-drag and touch-off gesture) made by the user's finger or the stylus pen. As another example, if an object is entered by the user's eyes, the controller 101 may determine whether an object is entered, by detecting the movements (for example, a moving direction and a moving distance) of the user's eyes.

If it is determined at operation 309 that an object is entered, the controller 101 may proceed to operation 311. Otherwise, the controller 101 may repeatedly perform operation 309.

At operation 311, the controller 101 may recognize a type of the entered object. At operation 313, the controller 101 may generate chart data based on the recognized object type.

For example, if an object or a curve 817 is entered in an object input window including the coordinate system as shown in a screen 819 of FIG. 8B, the controller 101 may recognize start and end points and at least one inflection point of the curve 817, estimate y-axis values corresponding to the recognized start and end points and at least one inflection point, and generate chart data based on the estimated y-axis values. More specifically, if the y-axis values corresponding to the start point, two inflection points and the end point of the curve 817 are 17, 21, 27, and 34, the controller 101 may generate chart data shown in Table 1.

As another example, if objects or a plurality of points 825 are entered in an object input window including the coordinate system as shown in a screen 827 of FIG. 8B, the controller 101 may recognize the plurality of points 825, estimate y-axis values corresponding to the plurality of recognized points, and generate chart data based on the estimated y-axis values. More specifically, if the y-axis values corresponding to the plurality of points are 17, 21, 27, and 34, the controller 101 may generate chart data shown in Table 1.

As further another example, if objects or a plurality of bars 835 are entered in an object input window including the coordinate system as shown in a screen 837 of FIG. 8C, the controller 101 may recognize the plurality of bars 835, estimate the maximum values of the y-axes corresponding to the plurality of recognized bars, and generate chart data based on the estimated maximum values of the y-axes. More specifically, if the maximum values of the y-axes corresponding to the plurality of bars are 17, 30, and 22, the controller 101 may generate chart data shown in Table 2.

As further another example, if objects or a plurality of oblique lines 845 are entered in an object input window including a circle as shown in a screen 847 of FIG. 8D, the controller 101 may recognize the plurality of oblique lines 845, estimate sizes corresponding to a plurality of areas formed by the circle and the plurality of oblique lines 845, and generate chart data based on the estimated sizes. More specifically, if the sizes corresponding to the plurality of areas are 35, 28, and 37, the controller 101 may generate chart data shown in Table 3.

As further another example, if objects or numbers are entered in an object input window including a coordinate table 1537 as shown in a screen 1535 of FIG. 15B, the controller 101 may generate chart data based on the entered numbers. More specifically, if the entered numbers are 17, 21, 27, and 34, the controller 101 may generate chart data shown in Table 1.

As further another example, if objects or a plurality of bars 1559 are entered in an object input window including the coordinate system as shown in a screen 1557 of FIG. 15C, the controller 101 may recognize the plurality of bars 1559, estimate the maximum values of the y-axes corresponding to the plurality of recognized bars, and generate chart data based on the estimated maximum values of the y-axes. More specifically, if the maximum values of the y-axes corresponding to the plurality of bars are 17, 30, and 22, the controller 101 may generate chart data shown in Table 2.

As further another example, if an object or a curve 1571 is entered in an object input window including the coordinate system as shown in a screen 1569 of FIG. 15D, the controller 101 may recognize start and end points and at least one inflection point of the curve 1571, estimate y-axes values corresponding to the recognized start and end points and inflection points, and generate chart data based on the estimated y-axis values. More specifically, if the y-axes values corresponding to the start point, two inflection points and the end point of the curve 1571 are 17, 21, 27, and 34, the controller 101 may generate chart data shown in Table 1.

As further another example, if objects or a plurality of points 1575 are entered in an object input window including the coordinate system as shown in a screen 1573 of FIG. 15D, the controller 101 may recognize the plurality of points 1575, estimate y-axes values corresponding to the plurality of recognized points, and generate chart data based on the estimated y-axes values. More specifically, if the y-axes values corresponding to the plurality of points are 17, 21, 27, and 34, the controller 101 may generate chart data shown in Table 1.

As further another example, if objects or a plurality of oblique lines 1587 are entered in an object input window including a circle as shown in a screen 1585 of FIG. 15E, the controller 101 may recognize the plurality of oblique lines 1587, estimate sizes corresponding to a plurality of areas formed by the circle and the plurality of oblique lines 1587, and generate chart data based on the estimated sizes. More specifically, if the sizes corresponding to the plurality of areas are 35, 28, and 37, the controller 101 may generate chart data shown in Table 3.

At operation 315, the controller 101 may create a chart graph depending on the selected chart type based on the generated chart data, and display the created chart graph.

For example, if the chart type selected by the user corresponds to a line graph, the controller 101 may create a line graph based on the chart data shown in Table 1, and display the line graph including a broken line 821 as shown in a screen 823 of FIG. 8B. As another example, if the chart type selected by the user corresponds to a bar graph, the controller 101 may create a bar graph based on the chart data shown in Table 2, and display the bar graph including three bars 839 as shown in a screen 841 of FIG. 8C. As further another example, if the chart type selected by the user corresponds to a pie graph, the controller 101 may create a pie graph based on the chart data shown in Table 3, and display the pie graph including three areas 849 as shown in a screen 851 of FIG. 8D.

As further another example, if the chart type selected by the user corresponds to a chart table, the controller 101 may display a chart table 1547 as shown in a screen 1545 of FIG. 15B. As further another example, if the chart type selected by the user corresponds to a line graph, the controller 101 may create a line graph based on the chart data shown in Table 1, and display the line graph including a broken line 1579 as shown in a screen 1577 of FIG. 15D. As further another example, if the chart type selected by the user corresponds to a bar graph, the controller 101 may create a bar graph based on the chart data shown in Table 2, and display the bar graph including three bars 1563 as shown in a screen 1561 of FIG. 15C. As further another example, if the chart type selected by the user corresponds to a pie graph, the controller 101 may create a pie graph based on the chart data shown in Table 3, and display the pie graph 1591 illustrating three areas as shown in a screen 1589 of FIG. 15E.

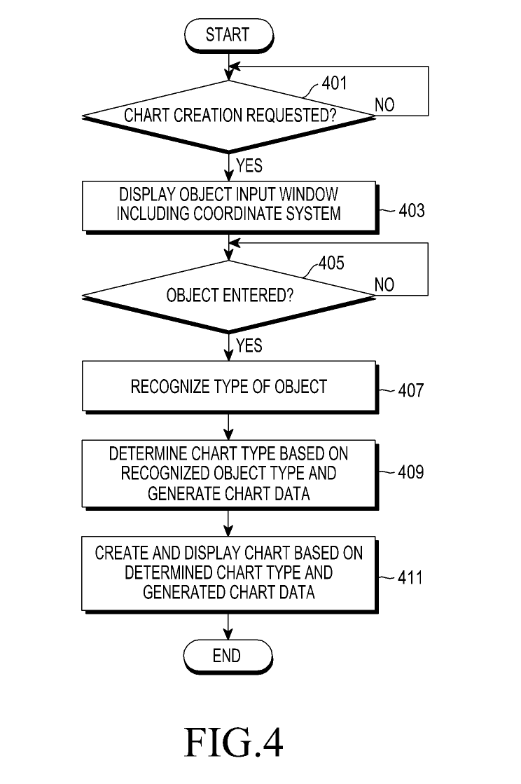

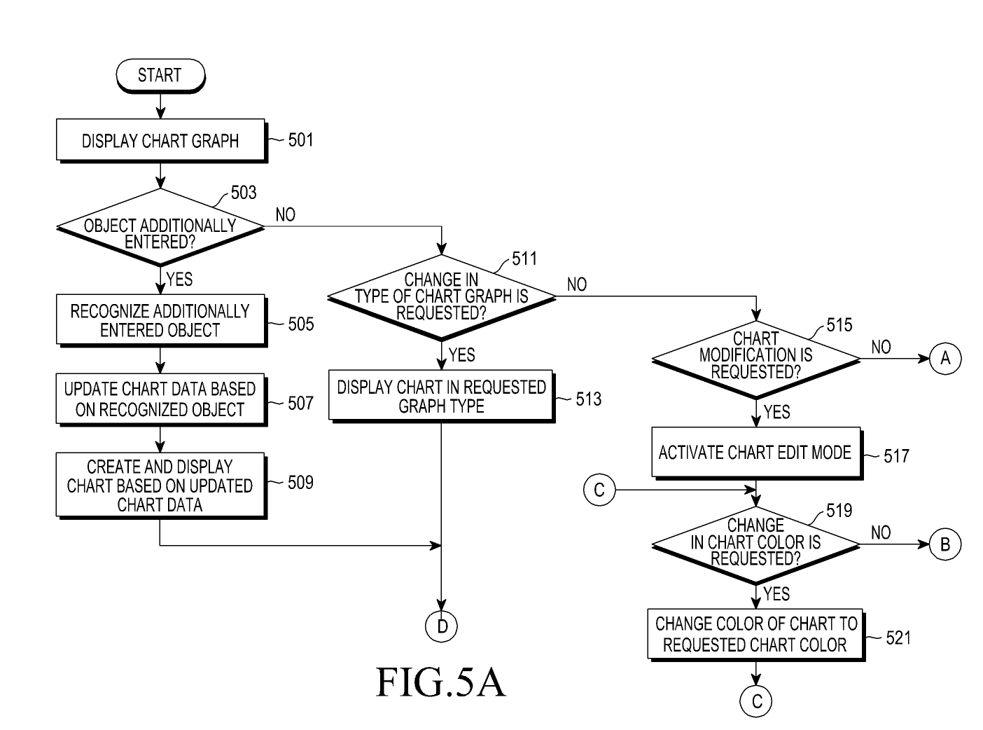

FIG. 4 is a flowchart of displaying a chart in a mobile electronic device according to a second embodiment of the present disclosure.

Referring to FIG. 4, at operation 401, the controller 101 may determine whether chart creation is requested by the user. For example, the controller 101 may display a Create Chart icon, and if the Create Chart icon is selected or touched by the user, the controller 101 may determine that chart creation is requested. The Create Chart icon may refer to an icon used for receiving a request for chart creation from the user. For example, the controller 101 may display a Create Chart icon 901 as shown in a screen 903 of FIG. 9A, and if the Create Chart icon 901 is touched by the user, the controller 101 may determine that chart creation is requested.

If it is determined at operation 401 that chart creation is requested, the controller 101 may proceed to operation 403. Otherwise, the controller 101 may repeatedly perform operation 401.

At operation 403, the controller 101 may display an object input window including the coordinate system. The object input window may refer to a window used for receiving an object from the user, and may include the coordinate system for a line graph or a bar graph. For example, the controller 101 may display an object input window including a coordinate system 905 as shown in a screen 907 of FIG. 9A.

At operation 405, the controller 101 may determine whether an object is entered in an object input window. The object may be entered by a user's finger, a stylus pen, a user's eyes, or the like. For example, if an object is entered by a user's finger or a stylus pen, the controller 101 may determine whether an object is entered, by detecting a gesture (for example, a touch-and-drag and touch-off gesture) made by the user's finger or the stylus pen. As another example, if an object is entered by the user's eyes, the controller 101 may determine whether an object is entered, by detecting the movements (for example, a moving direction and a moving distance) of the user's eyes.

If it is determined at operation 405 that an object is entered, the controller 101 may proceed to operation 407. Otherwise, the controller 101 may repeatedly perform operation 405.

At operation 407, the controller 101 may recognize a shape of the entered object. At operation 409, the controller 101 may determine a chart type based on the recognized shape of the object, and generate chart data based on the determined chart type and the recognized shape of the object. The chart type may refer to chart types supportable by the mobile electronic device, and may include a line graph, a bar graph, a circle or oval graph, and the like.

The shape of the entered object may be recognized in a variety of ways. For example, the controller 101 may determine whether a shape of an object corresponds to a curve, a point, a bar, a circle, or the like. The bar may be a rectangle with one side opened. If the recognized shape of the object corresponds to a curve or a point, the controller 101 may determine that the chart type corresponds to a line graph, and if the recognized shape of the object corresponds to a bar, the controller 101 may determine that the chart type corresponds to a bar graph. If the recognized shape of the object corresponds to a circle, the controller 101 may determine that the chart type corresponds to a pie graph.

For example, if an object or a curve 909 is entered in an object input window as shown in a screen 911 of FIG. 9B, the controller 101 may determine that the chart type corresponds to a line graph since the shape of the object corresponds to the curve 909, recognize start and end points and at least one inflection point of the curve 909, estimate y-axis values corresponding to the recognized start and end points and inflection points, and generate chart data based on the estimated y-axis values. More specifically, if the y-axis values corresponding to the start point, two inflection points and the endpoint of the curve 909 are 17, 21, 27, and 34, the controller 101 may generate chart data shown in Table 1.

As another example, if objects or a plurality of points 925 are entered in an object input window as shown in a screen 927 of FIG. 9B, the controller 101 may determine that the chart type corresponds to a line graph since the shape of the object corresponds to the plurality of points 925, recognize the plurality of points 925, estimate y-axis values corresponding to the plurality of recognized points, and generate chart data based on the estimated y-axis values. More specifically, if the y-axis values corresponding to the plurality of points are 17, 21, 27, and 34, the controller 101 may generate chart data shown in Table 1.

As further another example, if objects or a plurality of bars 923 are entered in an object input window as shown in a screen 933 of FIG. 9C, the controller 101 may determine that the chart type corresponds to a bar graph since the shape of the object corresponds to the plurality of bars 923, recognize the plurality of bars 923, estimate the maximum values of the y-axes corresponding to the plurality of recognized bars, and generate chart data based on the estimated maximum values of the y-axes. More specifically, if the maximum values of the y-axes corresponding to the plurality of bars are 17, 30, and 22, the controller 101 may generate chart data shown in Table 2.

As further another example, if an object or a circle 939 including a plurality of areas is entered in an object input window as shown in a screen 941 of FIG. 9D, the controller 101 may determine that the chart type corresponds to a pie graph since the shape of the object corresponds to the circle 939, estimate sizes corresponding to the plurality of areas, and generate chart data based on the estimated sizes. More specifically, if the sizes corresponding to the plurality of areas are 35, 28, and 37, the controller 101 may generate chart data shown in Table 3.

At operation 411, the controller 101 may create a chart graph depending on the determined graph type based on the generated chart data, and display the created chart graph.

For example, if the determined chart type corresponds to a line graph, the controller 101 may create a line graph based on the chart data shown in Table 1, and display the line graph including a broken line 913 as shown in a screen 920 of FIG. 9B. As another example, if the determined chart type corresponds to a bar graph, the controller 101 may create a bar graph based on the chart data shown in Table 2, and display the bar graph including three bars 935 as shown in a screen 937 of FIG. 9C. As further another example, if the determined chart type corresponds to a pie graph, the controller 101 may create a pie graph based on the chart data shown in Table 3, and display the pie graph 943 including three areas as shown in the screen 953 of FIG. 9D.

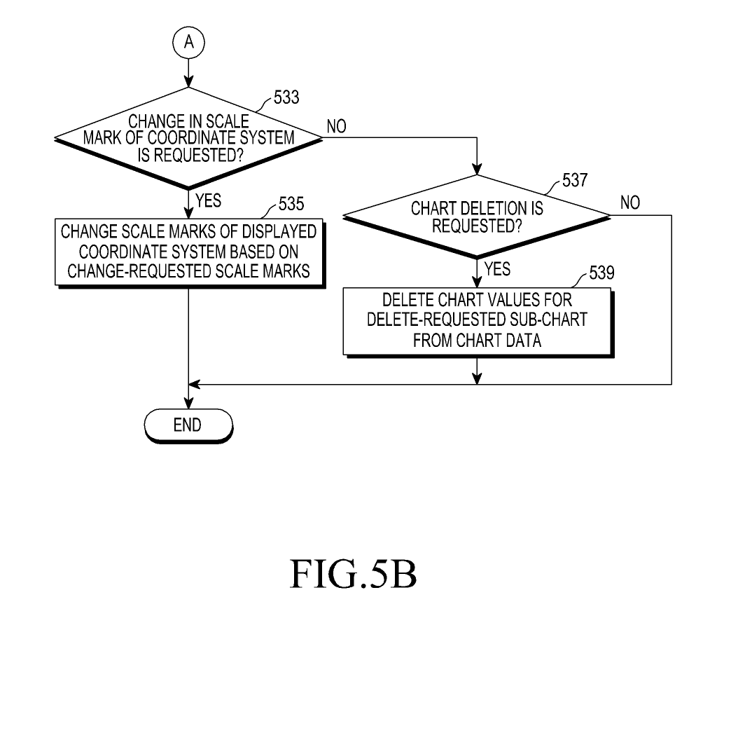

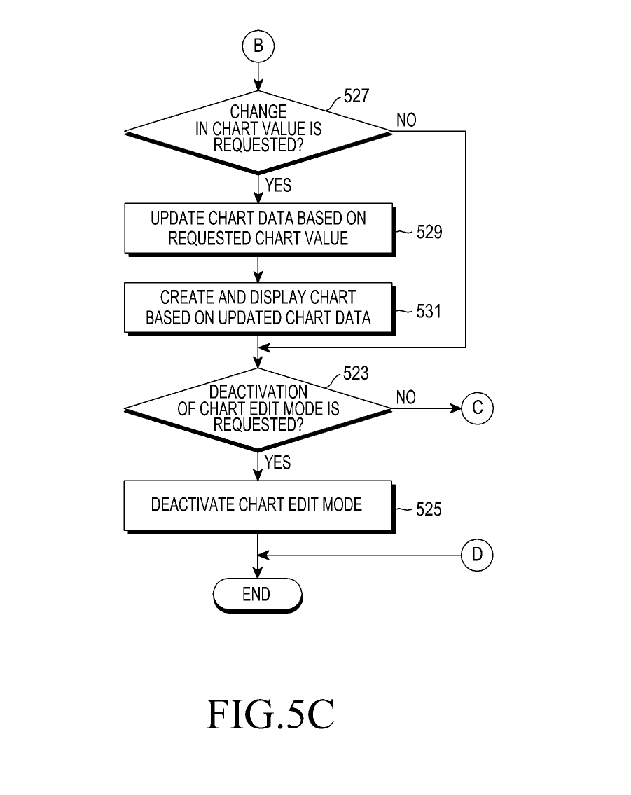

FIGS. 5A, 5B, and 5C are flowcharts of changing a chart in a mobile electronic device according to the first embodiment of the present disclosure.

Referring to FIGS. 5A, 5B, and 5C, at operation 501, the controller 101 may display a chart graph. For example, the controller 101 may display a chart in any one of the chart types supportable by the mobile electronic device. For example, the controller 101 may display a line graph as shown in a screen 1003 of FIG. 10A. As another example, the controller 101 may display a bar graph as shown in a screen 1103 of FIG. 11A. As further another example, the controller 101 may display a pie graph as shown in a screen 1203 of FIG. 12A.

As further another example, the controller 101 may display a chart table as shown in a screen 1601 of FIG. 16A. As further another example, the controller 101 may display a bar graph as shown in a screen 1701 of FIG. 17A. As further another example, the controller 101 may display a pie graph as shown in a screen 1801 of FIG. 18A.

At operation 503, the controller 101 may determine whether an object is additionally entered in the displayed chart graph. If it is determined at operation 503 that an object is additionally entered, the controller 101 may proceed to operation 505. Otherwise, the controller 101 may proceed to operation 511.

At operation 505, the controller 101 may recognize the additionally entered object. At operation 507, the controller 101 may update the chart data based on the recognized object.

For example, if an object or a curve 1005 is entered on a line graph as shown in a screen 1007 of FIG. 10A, the controller 101 may recognize start and end points and at least one inflection point of the curve 1005, estimate y-axis values corresponding to the recognized start and end points and inflection point, and update the chart data of the line graph based on the estimated y-axis values. More specifically, if the y-axis values corresponding to the start point, one inflection point and the end point of the curve 1005 are 15, 10, and 20, the controller 101 may generate chart data shown in Table 4 by updating the chart data shown in Table 1 based on the y-axis values of 15, 10, and 20.

As another example, if objects or a plurality of points are entered on a line graph, the controller 101 may recognize the plurality of points, estimate y-axis values corresponding to the plurality of recognized points, and update the chart data of the line graph based on the estimated y-axis values. More specifically, if the y-axis values corresponding to the plurality of points are 15, 10, and 20, the controller 101 may generate chart data shown in Table 4 by updating the chart data shown in Table 1 based on the y-axis values of 15, 10, and 20.

As further another example, if an object or a bar 1105 is entered on a bar graph as shown in a screen 1103 of FIG. 11A, the controller 101 may estimate the maximum value of the y-axis of the bar 1105, and update the chart data of the bar graph based on the estimated y-axis value. More specifically, if the object or the bar 1105 is entered between the first and second bars included in the bar graph and the maximum value of the y-axis of the bar 1105 is 25, the controller 101 may generate chart data shown in Table 5 by updating the chart data shown in Table 2 based on the input position (or entry position) and the maximum value ‘25’ of the y-axis of the bar 1105.

As further another example, if an Add Series menu is selected by the user as shown in a screen 1629 of FIG. 16B, the controller 101 may add a series in the chart table as shown in a screen 1635, and if objects or numbers are entered in the added series by the user, the controller 101 may update the chart table based on the entered at least one number. More specifically, if the entered numbers are 15, 10, and 20, the controller 101 may create a chart table shown in Table 4 by updating the chart table shown in Table 1 based on the entered numbers of 15, 10, and 20.

As further another example, if an Add Series menu is selected by the user as shown in a screen 1729 of FIG. 17B, the controller 101 may display series information 1739 indicating information about the added series as shown in a screen 1735, and if the added series is selected by the user and an object or a bar 1741 is entered on the bar graph as shown in a screen 1735 of FIG. 17B, the controller 101 may estimate the maximum value of the y-axis of the bar 1741, and update the chart data of the bar graph based on the estimated maximum value of the y-axis. More specifically, if the maximum value of the y-axis of the bar 1741 is 25, the controller 101 may generate chart data shown in Table 5 by updating the chart data shown in Table 2 based on the x-axis value and the maximum value ‘25’ of the y-axis of the bar 1741.

At operation 509, the controller 101 may create a chart graph based on the updated chart data, and display the created chart graph. For example, if the chart type corresponds to a line graph, the controller 101 may create a line graph based on the updated chart data shown in Table 4, and display a line graph 1009 including a broken line corresponding to the entered additional object and a broken line corresponding to the existing object, as shown in a screen 1011 of FIG. 10A. As another example, if the chart type corresponds to a chart table, the controller 101 may display a chart table shown in Table 4. As further another example, if the chart type corresponds to a bar graph, the controller 101 may create a bar graph based on the updated chart table shown in Table 5, and display a bar graph 1745 including a bar corresponding to the added series and a plurality of bars corresponding to the previous series, as shown in a screen 1743 of FIG. 17B.

At operation 511, the controller 101 may determine whether change in chart type is requested by the user. For example, the controller 101 may display a Change Chart Graph icon including a plurality of icons corresponding to available chart types, and if any one of the plurality of icons is selected by the user, the controller 101 may determine that change in chart type is requested.

For example, if the displayed chart graph is a line graph, the controller 101 may display a Change Chart Graph icon 1001 including a Bar Graph icon, a Pie Graph icon, and a Chart Data icon used for requesting display of chart data for the displayed chart graph, as shown in the screen 1003 of FIG. 10A. If the Bar Graph icon 1013 is touched by the user among the plurality of icons displayed in the Change Chart Graph icon 1001, the controller 101 may determine that a request to change a line graph to a bar graph is entered.

As another example, if a Pie Graph icon 1021 is touched by the user among the plurality of icons displayed in the Change Chart Graph icon 1001 as shown in a screen 1003 of FIG. 10B, the controller 101 may determine that a request to change a line graph to a pie graph is entered. As further another example, if a Chart Data icon 1029 is touched by the user among the plurality of icons displayed in the Change Chart Graph icon 1001 as shown in the screen 1003 of FIG. 10B, the controller 101 may determine that a request to display chart data of the line graph is entered.

As further another example, the controller 101 may display a Change Chart Graph menu 1605 as shown in the screen 1601 of FIG. 16A. In a case where the chart graph corresponds to a chart table, if the Change Chart Graph menu 1605 is touched by the user, the controller 101 may display a Chart Type menu 1609 including types (i.e., a bar graph, a line graph, a pie graph, and the like) of available chart graphs as shown in a screen 1607 of FIG. 16A, and if a Bar Graph menu 1611 is touched by the user among the displayed chart type menus, the controller 101 may determine that a request to change a chart table to a bar graph is entered.

As further another example, if a Line Graph menu 1613 is touched by the user among the displayed chart type menus as shown in the screen 1607 of FIG. 16A, the controller 101 may determine that a request to change a chart table to a line graph is entered. As further another example, if a Pie Graph menu 1615 is touched by the user among the displayed chart type menus as shown in the screen 1607 of FIG. 16A, the controller 101 may determine that a request to change a chart table to a pie graph is entered.

If it is determined at operation 511 that a chart type change request is entered, the controller 101 may proceed to operation 513. Otherwise, the controller 101 may proceed to operation 515.

At operation 513, the controller 101 may display the displayed chart graph as a change-requested chart graph using the chart data of the displayed chart graph. For example, if a request to change a line graph to a bar graph is entered, the controller 101 may change a line graph to a bar graph 1015 based on the chart data of the line graph as shown in a screen 1019 of FIG. 10A. As another example, if a request to change a line graph to a pie graph is entered, the controller 101 may change a line graph to a pie graph 1023 based on the chart data of the line graph as shown in a screen 1027 of FIG. 10B. As further another example, if a request to display chart data of a line graph is entered, the controller 101 may display chart data 1031 of the line graph as shown in a screen 1035 of FIG. 10B.

As further another example, if a request to change a chart table to a line graph is entered, the controller 101 may change the chart table to a line graph 1619 based on the chart data corresponding to the chart data as shown in a screen 1617 of FIG. 16A. As further another example, if a request to change a chart table to a bar graph is entered, the controller 101 may change the chart table to a bar graph 1623 based on the chart data corresponding to the chart table as shown in a screen 1621 of FIG. 16A.

As further another example, if a request to change a chart table to a pie graph is entered, the controller 101 may change the chart table to a pie graph 1627 based on the chart data corresponding to the chart table as shown in a screen 1625 of FIG. 16A.

At operation 515, the controller 101 may determine whether chart modification is requested by the user. For example, if an element (for example, a specific area of a broken line, or a specific area of a bar or a circle) included in the chart graph is selected, or an Edit Line menu is selected, the controller 101 may determine that chart modification is requested. As another example, if a specific area 1037 of a broken line included in a line graph is touched or is touched for a period of time as shown in a screen 1003 of FIG. 10C, the controller 101 may determine that modification of the touched specific area 1037 is requested. As further another example, if an Edit Line menu 1643 is touched by the user as shown in a screen 1639 of FIG. 16B, the controller 101 may determine that modification of the displayed chart graph is requested.

If it is determined at operation 515 that chart modification is requested, the controller 101 may proceed to operation 517. Otherwise, the controller 101 may proceed to operation 533.

At operation 517, the controller 101 may activate or enable a chart edit mode. The chart edit mode may refer to a mode for editing a color, a value, or the like, for a selected specific area of the displayed chart graph. If the chart edit mode is activated, the controller 101 may display an identification icon or a Change Color icon. A first identification icon may refer to an icon used for indicating that a specific area selected by the user is being edited, and the Change Color icon may refer to an icon used for receiving a color change request for a selected specific area from the user.

For example, if chart modification is requested by the user, the controller 101 may display a first identification icon 1039 and a Change Color icon 1041 as shown in a screen 1043 of FIG. 10C.

At operation 519, the controller 101 may determine whether change in chart color is requested by the user. For example, if the displayed Change Color icon or Change Color menu is selected by the user, the controller 101 may determine that change in chart color is requested. As another example, if the Change Color icon 1041 is touched by the user as shown in the screen 1043 of FIG. 10C, the controller 101 may determine that change in chart color is requested. As further another example, if one series included in a chart table is touched by the user and then a key is touched by the user, the controller 101 may display an Edit Chart menu 1659 including a Change Color menu for requesting change in chart color and a Delete menu for deleting some areas of the chart graph, as shown in a screen 1657 of FIG. 16C, and if the Change Color menu included in the Edit Chart menu 1659 is touched by the user, the controller 101 may determine that change in chart color is requested.

If it is determined at operation 519 that a change in chart color is requested, the controller 101 may proceed to operation 521. Otherwise, the controller 101 may proceed to operation 527.

At operation 521, the controller 101 may display a palette including a plurality of colors, and if any one of the plurality of colors included in the displayed palette is selected by the user, the controller 101 may change the color of the selected specific area to the selected color.

For example, if the Change Color icon 1041 is touched, the controller 101 may display a palette 1047 including a plurality of colors as shown in a screen 1051 of FIG. 10C, and determine whether a specific color among the plurality of colors included in the palette 1047 is selected by the user. If a specific color 1049 is selected from among the plurality of colors included in the palette 1047, the controller 101 may change the color of a broken line including a selected specific area to the specific color 1049, as shown in a screen 1055 of FIG. 10C.

As another example, if the Change Color menu is touched, the controller 101 may display a palette including a plurality of colors, and if a specific color among the plurality of colors included in the palette is selected by the user, the controller 101 may change the color of the touched series to the specific color as shown in a screen 1663 of FIG. 16C.

At operation 527, the controller 101 may determine whether change in chart value is requested by the user. For example, if the displayed first identification icon is shifted from the current position to another position by the user, if a number is entered in an object input window, or if a number is entered in a chart table, the controller 101 may determine that change in chart value is requested.

For example, if the first identification icon 1039 is touched by the user in the screen 1043 of FIG. 10C, the controller 101 may determine that change in value of a specific area is requested. As another example, if a specific number 1059 is entered by the user in a screen 1043 of FIG. 10D, the controller 101 may determine that change in chart value of the specific area is requested. As further another example, after chart modification is requested by the user, if a specific area of a chart table 1669 is selected by the user as shown in a screen 1667 of FIG. 16C, the controller 101 may determine that change in chart value of a specific area is requested.

If it is determined at operation 527 that change in chart value is requested, the controller 101 may proceed to operation 529. Otherwise, the controller 101 may proceed to operation 523.

At operation 529, the controller 101 may estimate the change-requested chart value based on the user's input, and update the chart data of the displayed chart graph based on the estimated chart value. For example, if the first identification icon 1039 undergoes a touch-and-drag and touch-off gesture 1057 by the user in the screen 1043 of FIG. 10D, the controller 101 may estimate a y-axis value corresponding to the touch-off point in the coordinate system. If the estimated y-axis value is 30, the controller 101 may generate chart data shown in Table 6 by updating the chart data shown in Table 1 based on the estimated y-axis value.

As another example, if a specific number 1059 is entered by the user in the screen 1043 of FIG. 10D, the controller 101 may recognize the specific number. If the recognized specific number is 30, the controller 101 may generate chart data shown in Table 6 by updating the chart data shown in Table 1 based on the recognized specific number.

As further another example, if a specific number is entered in a specific area of the chart table 1669 by the user in the screen 1667 of FIG. 16C, the controller 101 may recognize the entered specific number. If the recognized specific number is 47, the controller 101 may update the chart data shown in Table 1 based on the specific number ‘47’.

At operation 531, the controller 101 may create a chart graph based on the updated chart data, and display the created chart graph.

For example, if the displayed chart type corresponds to a line graph, the controller 101 may create a line graph based on the updated chart data shown in Table 6, and display the line graph including an identification icon 1061 whose y-axis value is 30 in the coordinate system, as shown in a screen 1063 of FIG. 10D. As another example, if the chart type corresponds to a chart table, the controller 101 may create a chart table based on the updated chart data, and display a chart table 1685 including a specific number ‘47’ 1687 as shown in a screen 1683 of FIG. 16D.

At operation 523, the controller 101 may determine whether deactivation of chart edit mode is requested by the user. For example, if an icon unrelated to chart editing (for example, a Change Chart Type icon, and the like) is selected, if no identification icon or no Change Color icon is selected for a period of time, or if no specific number is entered for a period of time, the controller 101 may determine that deactivation of chart edit mode is requested.

If it is determined at operation 523 that deactivation of chart edit mode is requested, the controller 101 may proceed to operation 525. Otherwise, the controller 101 may proceed to operation 519.

At operation 525, the controller 101 may deactivate the chart edit mode, and display no identification icon and no Change Color icon.

At operation 533, the controller 101 may determine whether change in scale mark of the coordinate system included in an object input window is requested the user. For example, if the coordinate system is selected, the controller 101 may determine that change in scale mark of the coordinate system is requested. For example, if a coordinate system 1065 is touched or is touched for a period of time in a screen 1003 of FIG. 10E, the controller 101 may determine that change in scale mark of the coordinate system is requested. As another example, if a gesture 1761 is entered in parallel to the x-axis of the coordinate system as shown in a screen 1757 of FIG. 17B, the controller 101 may determine that change in scale mark of the coordinate system is requested.

If it is determined at operation 533 that change in scale mark of the coordinate system is requested, the controller 101 may proceed to operation 535. Otherwise, the controller 101 may proceed to operation 537.

At operation 535, the controller 101 may estimate the change-requested scale marks based on the user's input, change scale mark data of the coordinate system based on the estimated scale marks, change scale marks of the displayed coordinate system based on the changed scale mark data, and change the size of the chart graph depending on the changed scale marks of the coordinate system. The scale mark data may refer to data for scale marks of the displayed coordinate system, and, for example, if the scale marks are 10, 20, and 30, the scale mark data may include 10, 20, and 30.

For example, if change in scale mark of the coordinate system is requested, the controller 101 may display a second identification icon on the coordinate system. If a second identification icon 1067 undergoes a touch-and-drag and touch-off gesture 1069 by the user in a screen 1071 of FIG. 10E, the controller 101 may determine an increase or decrease in scale (for example, whether the scale of the coordinate system increases or decreases) based on the drag direction, and determine an increasing gap or a decreasing gap between scale marks (for example, whether the gap between scale marks increases or decreases) based on the time from the touch until the touch-off. If it is determined that the scale increases and the increasing gap (or increment) is 20, the controller 101 may change a coordinate system 1075 such that an increasing gap between scale marks on the y-axis becomes 20, as shown in a screen 1077 of FIG. 10E, thereby reducing the size of the chart graph.

As another example, if a gesture 1761 that horizontally crosses a bar graph is entered as shown in the screen 1757 of FIG. 17B, the controller 101 may divide the maximum (or full) scale of the y-axis by a value obtained by adding one (1) to the number of displayed scale mark lines, and determine the calculated value as a gap between scale marks. For example, if the maximum scale of the y-axis is 100 and the number of displayed scale mark lines is 5, the controller 101 may divide 100 by 6, and determine the calculated value ‘17’ as a gap between scale marks. If the gap between scale marks is determined as 17, the controller 101 may change a coordinate system included in the bar graph 1765 such that a gap between scale marks on the y-axis becomes 17, as shown in a screen 1763 of FIG. 17B, thereby increasing the size of the chart graph.

At operation 537, the controller 101 may determine whether chart deletion is requested by the user. For example, if a specific gesture is entered or a Delete menu is selected by the user, the controller 101 may determine that chart deletion is requested. For example, if a specific gesture (for example, a touch-off after touch-and-zigzag gesture) 1079 is entered by the user in a screen 1003 of FIG. 10F, the controller 101 may determine that chart deletion is requested. As another example, if a Delete menu 1681 is selected by the user in a screen 1677 of FIG. 16D, the controller 101 may determine that chart deletion is requested.

If it is determined at operation 537 that chart deletion is requested, the controller 101 may proceed to operation 539. Otherwise, the controller 101 may end the chart change operation.

At operation 539, the controller 101 may recognize a specific area of the chart graph, deletion of which is requested by the user, update the chart data by deleting a value corresponding to the recognized specific area from the chart data of the displayed chart graph, and create and display a chart graph based on the updated chart data.

For example, if a specific gesture 1079 is entered in a specific area of a chart graph in the screen 1003 of FIG. 10F, the controller 101 may recognize the specific area in the chart graph. If the specific area corresponds to a straight line located between a scale mark 30 and a sale mark 40 on the x-axis, the controller 101 may generate chart data shown in Table 7 by deleting a value corresponding to the recognized specific area from the chart data shown in Table 1 based on the recognized specific area. As another example, if a specific area 1675 in the chart table shown in the screen 1671 is touched by the user and then a Delete menu 1681 is touched by the user, the controller 101 may delete a chart value included in the specific area 1675, and display a chart table 1679 in a screen 1677 of FIG. 16D.

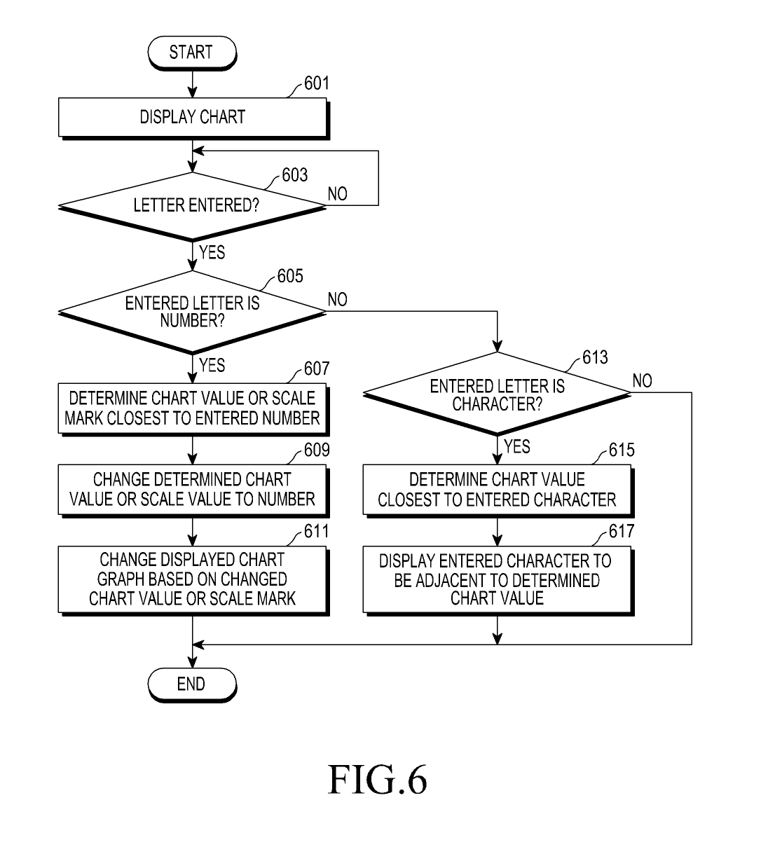

FIG. 6 is a flowchart of changing a chart in a mobile electronic device according to the second embodiment of the present disclosure.

Referring to FIG. 6, at operation 601, the controller 101 may display a chart graph. For example, the controller 101 may display a chart in any one of the chart types supportable by the mobile electronic device. For example, the controller 101 may display a line graph as shown in a screen 1301 of FIG. 13A. As another example, the controller 101 may display a bar graph as shown in a screen 1321 of FIG. 13C. As further another example, the controller 101 may display a pie graph as shown in a screen 1333 of FIG. 13D.

At operation 603, the controller 101 may determine whether a letter is entered by the user. The letter may include a number and a character. The number may include Arabic numerals, and the character may include Alphabet, Hangul (Korean Alphabet), Hiragana (Japanese Alphabet), Chinese characters, and the like.

If it is determined at operation 603 that a letter is entered, the controller 101 may proceed to operation 605. Otherwise, the controller 101 may repeatedly perform operation 603.

At operation 605, the controller 101 may determine whether the entered letter is a number. If it is determined at operation 605 that the entered letter is a number, the controller 101 may proceed to operation 607. Otherwise, the controller 101 may proceed to operation 613.

At operation 607, the controller 101 may determine a chart value or a scale mark closest to the number's input position in the displayed chart graph. At operation 609, the controller 101 may change the chart data or scale mark data of the displayed chart graph based on the entered number. The scale mark data may refer to data regarding scale marks of the coordinate system, and, for example, if the y-axis scale marks of the coordinate system are 10, 20, and 30, the scale mark data may include 10, 20, and 30.

For example, if a scale mark is changed to an entered number, the controller 101 may determine an increase or decrease in scale, and an increasing gap or a decreasing gap between scale marks, based on the entered number. The controller 101 may change scale mark data of the chart graph based on the determined increase or decrease in scale and the determined increasing gap or decreasing gap between scale marks.

For example, if a number ‘60’ 1303 is entered by the user and an element closest to the input position of the number ‘60’ 1303 is a scale mark ‘30’, as shown in the screen 1301 of FIG. 13A, the controller 101 may compare the entered number ‘60’ 1303 with the scale mark ‘30’. As a result of comparison, if the entered number ‘60’ 1303 exceeds the scale mark ‘30’, the controller 101, determining that the scale increases, may determine an increasing gap between scale marks as 20 by dividing the entered number ‘60’ 1303 by the number ‘3’ of scale marks of the displayed coordinate system. The controller 101 may determine scale mark data 10, 20, and 30 of the displayed coordinate system, and update the scale mark data so that the scale mark data may include 20, 40, and 60, based on the determined increase in scale and the determined increasing gap ‘20’ between scale marks.

For example, if the chart value is changed to the entered number, the controller 101 may update the chart data of the displayed chart graph based on the entered number. For example, if a number ‘30’ 1309 is entered by the user and a chart value closest to the input position of the number ‘30’ 1309 is ‘20, as shown in the screen 1301 of FIG. 13A, the controller 101 may generate chart data shown in Table 6 by updating the chart data shown in Table 1 so that the chart value ‘20’ may be changed to the entered number ‘30’ 1309.

At operation 611, the controller 101 may change the displayed coordinate system or scale mark data based on the changed scale mark data or chart data. For example, as shown in a screen 1307 of FIG. 13A, the controller 101 may change scale marks 10, 20, and 30 of the displayed coordinate system to the scale marks 20, 40, and 60 (1305) based on the changed scale mark data, thereby reducing the size of the chart graph depending on the changed y-axis scale marks. As another example, the controller 101 may display a chart graph whose second chart data value is 30, based on the changed chart data, as shown in a screen 1313 of FIG. 13A.

At operation 613, the controller 101 may determine whether the entered letter is a character. If it is determined at operation 613 that the entered letter is a character, the controller 101 may proceed to operation 615. Otherwise, the controller 101 may end the chart change operation.

At operation 615, the controller 101 may determine a chart value closest to the character's input position in the displayed chart graph. At operation 617, the controller 101 may display the entered character to be adjacent to the determined chart value. For example, if characters ‘the twenties’ 1315 are entered by the user in a screen 1031 of FIG. 13B, the controller 101 may determine a scale mark closest to the input position of the characters 1315 among the scale marks of the x-axis. If the scale mark closest to the characters 1315 is ‘20’, the controller 101 may display characters ‘the twenties’ 1317 under the scale mark ‘20’ as shown in a screen 1319 of FIG. 13B.

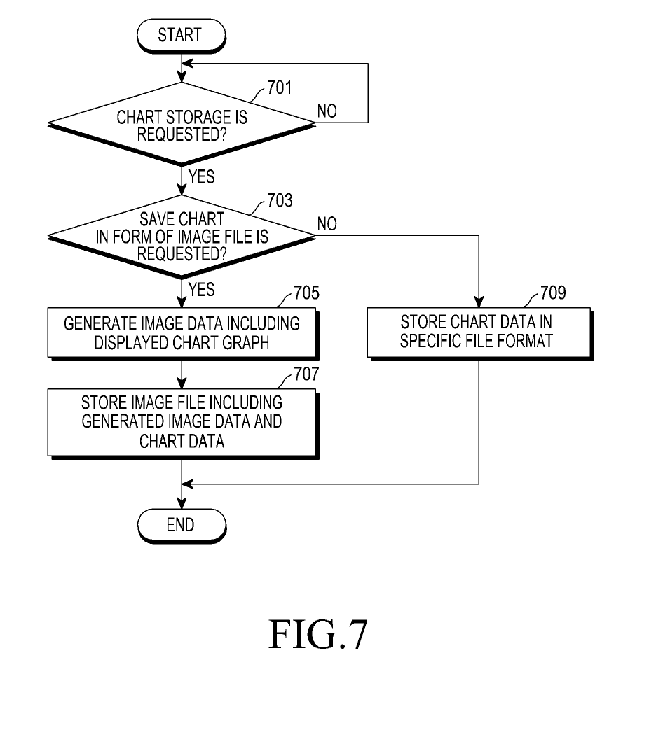

FIG. 7 is a flowchart of storing a chart in a mobile electronic device according to an embodiment of the present disclosure.

Referring to FIG. 7, at operation 701, the controller 101 may determine whether chart storage is requested by the user. For example, the controller 101 may display a Save Chart icon, and if the Save Chart icon, a Save Chart menu, or a Done menu is selected by the user, the controller 101 may determine that chart storage is requested. The Save Chart icon may refer to an icon for requesting to save the displayed chart graph, and the Save Chart menu may refer to a menu for requesting to save the displayed chart graph. The Done menu may refer to a menu for indicating that the creation of a chart graph is done. For example, the Done menu may be a Done menu in the screen 1545 of FIG. 15B.

If it is determined at operation 701 that chart storage is requested, the controller 101 may proceed to operation 703. Otherwise, the controller 101 may repeatedly perform operation 701.

At operation 703, the controller 101 may determine whether storing a chart in an image file format is requested by the user. For example, if an extension of a specific file format requested by the user corresponds to an extension (for example, *.bmp, *.dib, *.jpg, *.jpeg, *.jpe, *.jfif, *.gif, *.tif, *.tiff, *.png, *.pdf, and the like) of an image file format, the controller 101 may determine that storing a chart in an image file format is requested.

If it is determined at operation 703 that storing a chart in an image file format is requested, the controller 101 may proceed to operation 705. Otherwise, the controller 101 may proceed to operation 709.

At operation 709, the controller 101 may store the chart data of the displayed chart graph in the requested specific file format. For example, if the requested specific file format is a file format of Microsoft Word™, the controller 101 may store the chart data of the displayed chart graph in the file format of Microsoft Word™.

At operation 705, the controller 101 may generate image data including a chart graph by capturing the displayed chart graph. At operation 707, the controller 101 may store an image file including the generated image data and the chart data of the displayed chart graph. More specifically, by including or inserting chart data 1405 of a displayed chart graph in metadata 1403 corresponding to generated image data 1401 as illustrated in FIG. 14, the controller 101 may generate an image file including image data of the displayed chart graph and chart data of the displayed chart graph, and store the generated image file in the image file format requested by the user.

FIGS. 8A, 8B, 8C, and 8D illustrate screens on which a chart is displayed according to the first embodiment of the present disclosure.

Referring to FIGS. 8A, 8B, 8C, and 8D, the mobile electronic device may display a Create Chart icon 803 as shown in a screen 801. The Create Chart icon may refer to an icon used for receiving a request for chart creation from the user. If the Create Chart icon 803 is touched by the user in the screen 801, the mobile electronic device may display chart types 807 including a Line Graph icon 809, a Bar Graph icon 811 and a Pie Graph icon 813, as shown in a screen 805.

If the Line Graph icon 809 is touched by the user in the screen 805, the mobile electronic device may display an object input window including the coordinate system and a Change Chart Graph icon in the object input window, as shown in a screen 815. If the Line Graph icon is selected in this way, the Change Chart Graph icon may include a Bar Graph icon, a Pie Graph icon and a Chart Data icon.

If a curve 817 is entered in an object input window is entered by the user as shown in a screen 819, the mobile electronic device may generate chart data by recognizing the entered curve 817, and may display a line graph including a broken line 821 in the object input window based on the generated chart data, as shown in a screen 823.

In some cases, if a plurality of points 825 are entered in an object input window by the user as shown in a screen 827, the mobile electronic device may generate chart data by recognizing the plurality of entered points 825, and display a line graph including a broken line 829 in the object input window based on the generated chart data, as shown in a screen 831.

If the Bar Graph icon 811 is touched by the user in the screen 805, the mobile electronic device may display an object input window including the coordinate system and a Change Chart Graph icon in the object input window, as shown in a screen 833. If the Bar Graph icon is selected in this way, the Change Chart Graph icon may include a Line Graph icon, a Pie Graph icon and a Chart Data icon.

If a plurality of bars 835 are entered in an object input window by the user as shown in a screen 837, the mobile electronic device may generate chart data by recognizing the plurality of entered bars 835, and display a bar graph including a plurality of bars 839 in the object input window based on the generated chart data, as shown in a screen 841.

If the Pie Graph icon 813 is touched by the user in the screen 805, the mobile electronic device may display an object input window including a circle and a Change Chart Graph icon in the object input window, as shown in a screen 843. If the Pie Graph icon is selected in this way, the Change Chart Graph icon may include a Line Graph icon, a Bar Graph icon, and a Chart Data icon.

If a plurality of oblique lines 845 are entered in the circle by the user as shown in a screen 847, the mobile electronic device may generate chart data by recognizing the plurality of entered oblique lines 845, and display a pie graph including a circle 849 that is divided into a plurality of areas, in the object input window based on the generated chart data, as shown in a screen 851.

FIGS. 9A, 9B, 9C, and 9D illustrate screens on which a chart is displayed according to the second embodiment of the present disclosure.

Referring to FIGS. 9A, 9B, 9C, and 9D, the mobile electronic device may display a Create Chart icon 901 as shown in a screen 903. The Create Chart icon may refer to an icon used for receiving a request for chart creation from the user. If the Create Chart icon 901 is touched by the user in the screen 903, the mobile electronic device may display an object input window including a coordinate system 905 as shown in a screen 907.

If a curve 909 is entered in an object input window by the user as in a screen 911, the mobile electronic device may generate chart data by recognizing the entered curve 909, and display a line graph including a broken line 913 and a Change Chart Graph icon 915 in the object input window based on the generated chart data, as shown in a screen 920. If the curve 909 is entered in this way, the Change Chart Graph icon 915 may include a Bar Graph icon 917, Pie Graph icon 919 and a Chart Data icon 921.

In some various embodiments, if a plurality of points 925 are entered in an object input window by the user as shown in a screen 927, the mobile electronic device may generate chart data by recognizing the plurality of entered points 925, and display a line graph including a broken line 929 and a Change Chart Graph icon 915 in the object input window based on the generated chart data, as shown in a screen 931.

If a plurality of bars 923 are entered in an object input window by the user as shown in a screen 933, the mobile electronic device may generate chart data by recognizing the plurality of entered bars 923, and display a bar graph including a plurality of bars 935 and a Change Chart Graph icon 915 in the object input window based on the generated chart data, as shown in a screen 937. If the plurality of bars 923 are entered in this way, the Change Chart Graph icon 915 may include a Bar Graph icon 917, a Pie Graph icon 919, and a Chart Data icon 921.

If a circle 939 that is divided into a plurality of areas is entered in an object input window by the user as shown in a screen 941, the mobile electronic device may generate chart data by recognizing the entered circle 939, and display a pie graph 943 that is divided into a plurality of areas, and a Change Chart Graph icon 945 in the object input window without displaying the coordinate system based on the generated chart data, as shown in a screen 953. If the circle 939 is entered in this way, the Change Chart Graph icon 945 may include a Bar Graph icon 947, a Pie Graph icon 949, and a Chart Data icon 951.

FIGS. 10A, 10B, 10C, 10D, 10E, and 10F illustrate screens on which a line graph is changed according to the first embodiment of the present disclosure.

Referring to FIGS. 10A, 10B, 10C, 10D, 10E, and 10F, the mobile electron device may display a line graph and a Change Chart Graph icon 1001 in an object input window as shown in a screen 1003. The Change Chart Graph icon 1001 may include a Bar Graph icon, a Pie Graph icon and a Chart Data icon.

If a broken line 1005 is additionally entered in an object input window by the user as shown in a screen 1007, the mobile electronic device may recognize the additionally entered broken line 1005, and update the chart data for the pre-displayed line graph taking into account the recognized broken line 1005. The mobile electronic device may display a line graph including a first broken line and a second broken line 1009 in the object input window based on the updated chart data, as shown in a screen 1011.

If a Bar Graph icon 1013 is touched by the user in the screen 1003, the mobile electronic device may create and display a bar graph 1015 in the object input window based on the chart data for the line graph and may also display a Change Chart Graph icon 1017, as shown in a screen 1019. The Change Chart Graph icon 1017 may include a Line Graph icon, a Pie Graph icon and a Chart Data icon.

If a Pie Graph icon 1021 is touched by the user in the screen 1003, the mobile electronic device may create and display a pie graph 1023 in the object input window based on the chart data for the line graph and may also display a Change Chart Graph icon 1025, as shown in a screen 1027. The Change Chart Graph icon 1025 may include a Line Graph icon, a Bar Graph icon and a Chart Data icon.

If a Chart Data icon 1029 is touched by the user in the screen 1003, the mobile electronic device may detect and display chart data 1031 for the line graph in the object input window and may also display a Change Chart Graph icon 1033, as shown in a screen 1035. The Change Chart Graph icon 1033 may include a Line Graph icon, a Bar Graph icon and a Pie Graph icon.

If a specific area 1037 of a broken line included in a line graph is touched by the user for a period of time in the screen 1003, the mobile electronic device may display a first identification icon 1039 indicating the editability of a touched specific area in the touched specific area and may also display a Change Color icon 1041 in the vicinity of the Change Chart Graph icon 1033, as shown in a screen 1043.

If the Change Color icon 1041 is touched by the user (e.g., using the user's finger 1045) in the screen 1043, the mobile electronic device may display a palette 1047 including a plurality of changeable colors as shown in a screen 1051. If a specific color 1049 is touched among the plurality of colors included in the displayed palette 1047 in the screen 1051, the mobile electronic device may display a broken line 1053 in the specific color as shown in a screen 1055.

If the first identification icon undergoes a touch-and-drag and touch-off gesture 1057 by the user in the screen 1043, the mobile electronic device may estimate a y-axis value corresponding to the touch-off point in the coordinate system, and update the chart data for the displayed line graph using the estimated y-axis value. If the estimated y-axis value is 30, the mobile electronic device may create and display a line graph based on the updated chart data so that the y-axis value of a specific area 1061 may be 30, as shown in a screen 1063.

If a number ‘30’ 1059 is entered by the user in the screen 1043, the mobile electronic device may recognize the entered number ‘30’ 1059, and update the chart data for the displayed line graph using the recognized number ‘30’ 1059. As shown in the screen 1063, the mobile electronic device may create and display a line graph based on the updated chart data so that the y-axis value of the specific area 1061 may be 30.

If a specific area 1065 on the y-axis included in the coordinate system is touched by the user in the screen 1003 for a period of time, the mobile electronic device may display a second identification icon 1067 indicating the changeability of scale marks of the coordinate system on the touched specific area, as shown in a screen 1071.

If the second identification icon 1067 undergoes a touch-and-drag and touch-off gesture 1069 by the user in the screen 1071, the mobile electronic device may determine an increase or decrease in scale and a gap between scale marks, taking into account the drag direction and the time from the touch-on until the touch-off, and update the scale mark data of the displayed coordinate system based on the determined increase or decrease in scale and the determined gap between scale marks. The scale mark data may refer to data regarding scale marks of the displayed coordinate system.

As shown in a screen 1077, the mobile electronic device may change a plurality of scale marks on the y-axis of the coordinate system based on the updated scale mark data, thereby reducing the size of the line graph depending on the plurality of changed scale marks.

If a number ‘60’ 1073 is entered by the user in the screen 1071, the mobile electronic device may recognize the entered specific number ‘60’ 1073, determine an increase or decrease in scale and a gap between scale marks taking into account the recognized specific number ‘60’ 1073, and update the scale mark data of the displayed coordinate system based on the determined increase or decrease in scale and the determined gap between scale marks.

As shown in the screen 1077, the mobile electronic device may change a plurality of scale marks on the y-axis of the coordinate system based on the updated scale mark data, thereby reducing the size of the line graph depending on the plurality of changed scale marks.

If a specific gesture (for example, a touch-off after touch-and-zigzag gesture) 1079 is entered on some areas of a broken line included in the line graph by the user in the screen 1003, the mobile electronic device may update the chart data by deleting the chart value related to some areas from the chart data for the line graph. As shown in a screen 1083, the mobile electronic device may display the line graph 1081, some areas of which are deleted based on the updated chart data.

If a specific gesture (for example, a touch-off after touch-and-zigzag gesture) 1085 that obliquely crosses the line graph is entered on some areas of a broken line included in the line graph by the user in the screen 1003, the mobile electronic device may delete the chart data for the line graph. As shown in a screen 1089, the mobile electronic device may delete the line graph and display the coordinate system 1087.

FIGS. 11A, 11B, 11C, 11D, and 11E illustrate screens on which a bar graph is changed according to the first embodiment of the present disclosure.

Referring to FIGS. 11A, 11B, 11C, 11D, and 11E, the mobile electronic device may display a bar graph and a Change Chart Graph icon 1101 in an object input window as shown in a screen 1103. The Change Chart Graph icon 1101 may include a Line Graph icon, a Pie Graph icon and a Chart Data icon.

If a bar 1105 is additionally entered between first and second bars among a plurality of bars included in the bar graph by the user in the screen 1103, the mobile electronic device may recognize the additionally entered bar 1105, and update the chart data for the pre-displayed bar graph taking into account the recognized bar 1105. As shown in a screen 1107, the mobile electronic device may display a bar graph 1106 including the plurality of pre-displayed bars and the added bar in the object input window based on the updated chart data.

If a specific gesture (for example, two fingers are touched and move in the opposite directions, and then are touched-off) 1109 is entered between first and second bars among the plurality of bars included in the bar graph by the user in the screen 1103, the mobile electronic device may update the chart data such that a third chart value of ‘0’ may be included or inserted between a first chart value corresponding to the first bar and a second chart value corresponding to the second bar in the chart data for the bar graph. As shown in a screen 1115, the mobile electronic device may display a bar graph 1111 in which an empty space is located between the first and second bars based on the updated chart data.

If a bar 1113 is additionally entered in the empty space in the bar graph by the user in the screen 1115, the mobile electronic device may recognize the additionally entered bar 1113, and update the chart data for the pre-displayed bar graph taking into account the recognized bar 1113.

If a Line Graph icon 1117 is touched by the user in the screen 1103, the mobile electronic device may create and display a line graph 1119 in the object input window based on the chart data for the bar graph 1111 and may also display a Change Chart Graph icon 1121, as shown in a screen 1123. The Change Chart Graph icon 1121 may include a Bar Graph icon, a Pie Graph icon and a Chart Data icon.

If a second bar 1125 among the plurality of bars included in the bar graph is touched or is touched for a period of time in the screen 1103 by the user, the mobile electronic device may display, on the touched second bar 1125, a first identification icon 1127 indicating the editability of the touched second bar 1125 and may also display a Change Color icon 1129 in the vicinity of the Change Chart Graph icon, as shown in the screen 1131.

If the Change Color icon 1129 is touched by the user (e.g., using the user's finger 1133) in the screen 1131, the mobile electronic device may display a palette 1135 including a plurality of changeable colors as shown in a screen 1139. If a specific color 1137 among the plurality of colors included in the displayed palette 1135 is touched in the screen 1139, the mobile electronic device may display the second bar 1141 in the specific color as shown in a screen 1143.

If the first identification icon undergoes a touch-and-drag and touch-off gesture 1145 by the user in the screen 1131, the mobile electronic device may estimate a y-axis value corresponding to the touch-off point in the coordinate system, and update the chart data for the displayed bar graph using the estimated y-axis value. If the estimated y-axis value is 40, the mobile electronic device may create and display a bar graph based on the updated chart data so that the y-axis value of the second bar 1147 may be 40, as shown in a screen 1149.

If a number ‘40’ 1151 is entered by the user in the screen 1131, the mobile electronic device may recognize the entered number ‘40’ 1151, and update the chart data for the displayed bar graph using the recognized number ‘40’ 1151. As shown in the screen 1149, the mobile electronic device may create and display a bar graph based on the updated chart data so that the y-axis value of the second bar 1147 may be 40.

If a specific gesture (for example, a touch-off after touch-and-vertical zigzag gesture) 1153 is entered on the second bar included in the bar graph by the user in the screen 1103, the mobile electronic device may update the chart data by deleting the second chart value related to the second bar from the chart data for the bar graph. As shown in a screen 1155, the mobile electronic device may display a bar graph 1157, the second bar of which is deleted based on the updated chart data.

If a specific gesture (for example, a touch-off after touch-and-oblique zigzag gesture) 1159 that obliquely crosses the bar graph is entered by the user in the screen 1103, the mobile electronic device may delete the chart data for the bar graph. As shown in a screen 1161, the mobile electronic device may delete the bar graph and display the coordinate system 1163.

FIGS. 12A, 12B, 12C, and 12D illustrate screens on which a pie graph is changed according to the first embodiment of the present disclosure.

Referring to FIGS. 12A, 12B, 12C, and 12D, the mobile electronic device may display a pie graph and a Change Chart Graph icon 1201 in an object input window as shown in a screen 1203. The Change Chart Graph icon 1201 may include a Line Graph icon, a Bar Graph icon and a Chart Data icon.

If a Line Graph icon 1204 is touched by the user as shown in a screen 1205, the mobile electronic device may create and display a line graph 1207 in the object input window based on the chart data for the pie graph and may also display a Change Chart Graph icon, as shown in a screen 1209. The bar graph displayed in the screen 1205 may include an identification icon 1133 indicating the editability of a touched bar of the bar graph. The Change Chart Graph icon may include a Bar Graph icon, a Pie Graph icon and a Chart Data icon.

If a first area 1211 among a plurality of areas included in the pie graph is touched by the user for a period of time in the screen 1203, the mobile electronic device may display first identification icons 1213 indicating the editability of the first area 1211 on the touched first area 1211 and may also display a Change Color icon 1215 in the vicinity of the Change Chart Graph icon, as shown in a screen 1217.

If a Change Color icon 1215 is touched by the user (e.g., using the user's finger 1219) in the screen 1217, the mobile electronic device may display a palette 1221 including a plurality of changeable colors, as shown in a screen 1225. If a specific color 1223 among the plurality of colors included in the displayed palette 1221 is touched in the screen 1225, the mobile electronic device may display the first area 1227 in the specific color as shown in a screen 1229.

If any one of the first identification icons 1213 undergoes a touch-and-drag and touch-off gesture 1231 by the user in the screen 1217, the mobile electronic device may estimate sizes of a first area changed by the touch-off and a second area adjacent to the changed first area, and update the chart data for the displayed pie graph using the estimated sizes of the first and second areas. For example, if the estimated sizes of the first and second areas are 50 and 13, respectively, the mobile electronic device may generate chart data shown in Table 8 by updating the chart data shown in Table 3.

TABLE 8

| / | | | |
|---|---|---|---|
| | 50 | 13 | 37 |

As shown in a screen 1235, the mobile electronic device may create and display a pie graph 1233 in which the size of the first area is extended up to the touch-off point based on the updated chart data.

If a number ‘50’ 1237 is entered by the user in the screen 1217, the mobile electronic device may recognize the entered number ‘50’ 1237, and update the chart data for the pie graph using the recognized number ‘50’. As shown in the screen 1235, the mobile electronic device may create and display the pie graph 1233 in which the size of the first area is extended up to the touch-off point based on the updated chart data.

If a specific gesture (for example, a touch-off after touch-and-zigzag gesture) 1238 is entered on a first straight line that divides the first and second areas included in the pie graph, by the user in the screen 1203, the mobile electronic device may generate chart data shown in Table 9 by updating chart data shown in Table 3 by adding a first chart value corresponding to the first area and a second chart value corresponding to the second area in the chart data for the pie graph.

TABLE 9

| / | | |
|---|---|---|
| | 63 | 37 |

As shown in the screen 1241, the mobile electronic device may create and display a pie graph 1239 in which the first and second areas are combined based on the updated chart data.

If a specific gesture (for example, a touch-off after touch-and-zigzag gesture) 1243 that obliquely crosses the pie graph is entered by the user in the screen 1203, the mobile electronic device may delete the chart data for the pie graph and display the circle 1245, as shown in a screen 1247.

FIGS. 13A, 13B, 13C, and 13D illustrate screens on which a line graph, a bar graph, and a pie chart are changed according to the second embodiment of the present disclosure.

Referring to FIGS. 13A, 13B, 13C, and 13D, the mobile electronic device may display a line graph and a Change Chart Graph icon in an object input window as shown in a screen 1301. The Change Chart Graph icon may include a Bar Graph icon, a Pie Graph icon and a Chart Data icon.

If a specific number ‘60’ 1303 is entered by the user in the screen 1301, the mobile electronic device may recognize the entered specific number ‘60’ 1303, and determine an element (for example, a scale mark ‘30’ on the y-axis of the coordinate system) closest to the input position of the specific number ‘60’ 1303 among a plurality of elements included in the object input window. If the determined element is a scale mark, the mobile electronic device may determine an increase or decrease in scale and a gap between scale marks taking into account the recognized specific number ‘60’ 1303, and update the scale mark data of the displayed coordinate system based on the determined increase or decrease in scale and the determined gap between scale marks.

As shown in a screen 1307, the mobile electronic device may change a plurality of scale marks on the y-axis of the coordinate system 1305 based on the updated scale mark data, thereby reducing the size of the line graph depending on the plurality of changed scale marks.

If a specific number ‘30’ 1309 is entered by the user in the screen 1301, the mobile electronic device may recognize the entered specific number ‘30’ 1309, and determine an element (for example, a specific point of a broken line) closest to the input position of the specific number ‘30’ 1309 among a plurality of elements included in the object input window. The specific point may be a discontinuous point included in the broken line.

If the determined element corresponds to a second discontinuous point among the discontinuous points included in the broken line, the mobile electronic device may update the chart data for the displayed line graph using the recognized specific number ‘30’ 1309. For example, the mobile electronic device may generate chart data shown in Table 6 by updating the chart data shown in Table 1 using the specific number ‘30’ 1309.

As shown in a screen 1313, the mobile electronic device may create and display a line graph 1311 in which a y-axis value of the specific point is 30, based on the updated chart data.

If specific characters ‘the twenties’ 1315 are entered by the user in the screen 1301, the mobile electronic device may recognize the entered specific characters ‘the twenties’ 1315, and determine the scale mark closest to the input position of the specific characters ‘the twenties’ 1315 among the scale marks on the x-axis.

If the determined scale mark is 20, the mobile electronic device may display specific characters ‘the twenties’ 1317 under the scale mark ‘20’, as shown in a screen 1319.

As shown in a screen 1321, the mobile electronic device may display a bar graph and a Change Chart Graph icon in an object input window. The Change Chart Graph icon may include a Line Graph icon, a Pie Graph icon and a Chart Data icon.

If a specific number ‘40’ 1323 is entered by the user in the screen 1321, the mobile electronic device may recognize the entered specific number ‘40’ 1323, and determine the bar closest to the input position of the specific number ‘40’ 1323 among a plurality of bars included in the bar graph. If the determined bar corresponds to a second bar included in the bar graph, the mobile electronic device may update the chart data for the displayed bar graph using the recognized specific number ‘40’ 1323. For example, the mobile electronic device may generate chart data shown in Table 10 by updating the chart data shown in Table 2 using the specific number ‘40’ 1323.

TABLE 10

| / | | | |
|---|---|---|---|
| | 17 | 40 | 22 |

As shown in a screen 1327, the mobile electronic device may create and display a bar graph 1325 in which a y-axis value of the second bar is 40, based on the updated chart data.

If specific characters ‘the teens’ 1329 are entered by the user in the screen 1321, the mobile electronic device may recognize the entered specific characters ‘the teens’ 1329, and determine the scale mark closest to the input position of the specific characters ‘the teens’ 1329 among the x-axis scale marks. If the determined scale mark is 20, the mobile electronic device may display specific characters ‘the teens’ 1331 under the scale mark ‘20’.

As shown in a screen 1333, the mobile electronic device may display a pie graph and a Change Chart Graph icon in an object input window. The Change Chart Graph icon may include a Line Graph icon, a Bar Graph icon and a Chart Data icon.

If a specific number ‘50’ 1335 is entered by the user in the screen 1333, the mobile electronic device may recognize the entered specific number ‘50’ 1335, and determine the area closest to the input position of the specific number ‘50’ 1335 among a plurality of areas included in the pie graph. If the determined area is a first area among the plurality of areas included in the pie graph, the mobile electronic device may update the chart data for the displayed pie graph using the recognized specific number ‘50’ 1335. For example, the mobile electronic device may generate chart data shown in Table 9 by updating the chart data shown in Table 3 using the specific number ‘50’ 1335.

As shown in a screen 1339, the mobile electronic device may create and display a pie graph 1337 in which a size of the first area is 50, based on the updated chart data.

If specific characters ‘the twenties’ 1341 are entered by the user in the screen 1333, the mobile electronic device may recognize the entered specific characters ‘the twenties’ 1341, and determine the area closest to the input position of the specific characters ‘the twenties’ 1341 among the plurality of areas included in the pie graph. If the determined area is a first area among the plurality of areas included in the pie graph, the mobile electronic device may display specific characters ‘the twenties’ 1343 in the first area, as shown in a screen 1345.

FIG. 14 illustrates a format of an image file, in which a chart image is stored according to an embodiment of the present disclosure.

Referring to FIG. 14, if a request to save a chart in a format of an image file is entered by the user during display of a chart graph, the mobile electronic device may generate image data including a chart graph by capturing the displayed chart graph, and generate metadata including chart data regarding the displayed chart graph. As illustrated in FIG. 14, the mobile electronic device may generate and store an image file including generated image data 1401 and metadata 1403 having chart data 1405.

FIGS. 15A, 15B, 15C, 15D, 15E, and 15F illustrate screens on which a chart is displayed according to a third embodiment of the present disclosure.

Referring to FIGS. 15A, 15B, 15C, 15D, 15E, and 15F, if an Insert Image icon 1503 is selected by the user as shown in a screen 1501, the mobile electronic device may display insertion menus including at least one insertable image type. The insertion menus may include a Magic Chart menu 1505 used for requesting insertion of a chart. If the Magic Chart menu 1505 is touched by the user in the screen 1501, the mobile electronic device may display a Chart Type menu 1509 including at least one creatable chart type, as shown in a screen 1507. For example, the Chart Type menu 1509 may include a Chart Table menu 1511, a Bar Graph menu 1513, a Line Graph menu 1515, a Pie Graph menu 1517, and a History menu 1519 showing the previously generated at least one chart.

If the Chart Table menu 1511 is touched by the user in the screen 1507, the mobile electronic device may display a table setting window 1523 used for setting the size of the chart table, as shown in a screen 1521. If the size of the chart table is entered (1529) in the table setting window 1523 as shown in the screen 1525, the mobile electronic device may create and display a chart table 1533 having the entered size, as shown in a screen 1531.

If at least one specific number is entered in a chart table 1537 using the user's finger or the stylus pen as shown in a screen 1535, the mobile electronic device may create and display a chart table 1547 including the entered at least one specific number, as shown in a screen 1545. For example, if the entered specific numbers are ‘17’, ‘21’, ‘27’ and ‘34’, the mobile electronic device may create the chart table 1547 including the specific numbers ‘17’, ‘21’, ‘27’ and ‘34’.

If at least one specific number is entered in a chart table 1541 through a keypad 1543 in a screen 1539, the mobile electronic device may create and display the chart table 1547 including the entered at least one specific number, as shown in the screen 1545.

If a Done menu is touched by the user in the screen 1545, the mobile electronic device may generate and store image data including an image of the chart table 1547 and chart data of the chart table 1547 by capturing the displayed chart table 1547. As shown in a screen 1549, the mobile electronic device may detect and display an image 1551 of the stored chart table.

If the Bar Graph menu 1513 is touched by the user in the screen 1507, the mobile electronic device may display an object input window 1555 including the coordinate system, and display series information indicating information related to the series to be displayed in the object input window, as shown in a screen 1553. The series information may include a name of the series, and a sum and an average of chart values included in the series.

If at least one bar 1559 is entered in the object input window as shown in a screen 1557, the mobile electronic device may generate chart data by recognizing the entered at least one bar 1559, and display a bar graph 1563 including at least one bar in the object input window based on the generated chart data, as shown in a screen 1561. The mobile electronic device may calculate the sum and average of chart values based on the generated chart data, and update the series information based on the calculated sum and average of chart values.

If the Done menu is touched by the user in the screen 1557, the mobile electronic device may generate and store image data including an image of the bar graph 1563 and chart data of the bar graph 1563 by capturing the displayed bar graph 1563. The mobile electronic device may detect and display an image of the stored bar graph 1563.

If the Line Graph menu 1515 is touched by the user in the screen 1507, the mobile electronic device may display an object input window 1567 including the coordinate system and display series information indicating information related to the series to be displayed in the object input window, as shown in a screen 1565. The series information may include a name of the series, and a sum and an average of chart values included in the series.

If a curve 1571 is entered in the object input window as shown in a screen 1569, the mobile electronic device may generate chart data by recognizing start and end points and inflection points of the curve 1571 and display a line graph 1579 including at least one broken line in the object input window based on the generated chart data, as shown in a screen 1577. The mobile electronic device may calculate the sum and average of chart values based on the generated chart data, and update the series information based on the calculated sum and average of chart values.

If at least one point 1575 is entered in the object input window as shown in a screen 1573, the mobile electronic device may generate chart data by recognizing the entered at least one point 1575, and display the line graph 1579 including at least one broken line in the object input window based on the generated chart data, as shown in the screen 1577. The mobile electronic device may calculate the sum and average of chart values based on the generated chart data, and update the series information based on the calculated sum and average of chart values.

If the Done menu is touched by the user in the screen 1577, the mobile electronic device may generate and store image data including an image of the line graph 1579 and chart data of the line graph 1579 by capturing the displayed line graph 1579. The mobile electronic device may detect and display an image of the stored line graph 1579.

If the Pie Graph menu 1517 is touched by the user in the screen 1507, the mobile electronic device may display an object input window including a circle 1583 and display series information indicating information related to the series to be displayed in the object input window, as shown in a screen 1581. The series information may include a name of the series, and a sum and an average of chart values included in the series.

If at least one oblique line 1587 is entered in the circle as shown in a screen 1585, the mobile electronic device may generate chart data by recognizing the entered at least one oblique line 1587, and display a pie graph 1591 that is divided into a plurality of areas, in the object input window based on the generated chart data, as shown in a screen 1589. The mobile electronic device may calculate the sum and average of chart values based on the generated chart data, and update the series information based on the calculated sum and average of chart values.

If the Done menu is touched by the user in the screen 1589, the mobile electronic device may generate and store image data including an image of the pie graph 1591 and chart data of the pie graph 1591 by capturing the displayed pie graph 1591. The mobile electronic device may detect and display an image of the stored pie graph 1591.

If the History menu 1519 is touched by the user in the screen 1507, the mobile electronic device may detect an image from the image data related to at least one pre-stored chart and display the detected at least one image in a history window 1595, as shown in a screen 1593.

If a specific image among the displayed at least one image is selected by the user in the screen 1593, the mobile electronic device may display the selected specific image 1599, as shown in a screen 1597.

FIGS. 16A, 16B, 16C, and 16D illustrate screens on which chart data is changed according to the third embodiment of the present disclosure.

Referring to FIGS. 16A, 16B, 16C, and 16D, the mobile electronic device may display a chart table 1603 and a Change Chart Graph menu 1605, as shown in a screen 1601. If the Change Chart Graph menu 1605 is touched by the user, the mobile electronic device may display a Chart Type menu 1609 including graph types (for example, a bar graph, a line graph, and a pie graph), as shown in a screen 1607.

If a Bar Graph menu 1611 among the displayed chart type menus is touched by the user, the mobile electronic device may change the chart table 1603 to a bar graph 1623 based on the chart data corresponding to the chart table 1603, as shown in a screen 1621.

If a Line Graph menu 1613 among the displayed chart type menus is touched by the user, the mobile electronic device may change the chart table 1603 to a line graph 1619 based on the chart data corresponding to the chart table 1603, as shown in a screen 1617.

If a Pie Graph menu 1615 among the displayed chart type menus is touched by the user, the mobile electronic device may change the chart table 1603 to a pie graph 1627 based on the chart data corresponding to the chart table 1603, as shown in a screen 1625.

The mobile electronic device may display a chart table 1631 and an Add Series menu 1633 as shown in the screen 1629. If the Add Series menu 1633 is touched by the user, the mobile electronic device may create and display the chart table 1637 by adding a series in the chart table 1631, as shown in the screen 1635.

The mobile electronic device may display a chart table 1641 and an Edit Line menu 1643 as shown in a screen 1639. If the Edit Line menu 1643 is touched by the user and then a gesture 1645 that vertically crosses the chart table 1641 is entered, as shown in the screen 1639, the mobile electronic device may create and display a chart table 1649 by adding one column in the chart table 1641, as shown in a screen 1647.

The mobile electronic device may display a chart table 1653 and an Edit Line menu 1655 as shown in a screen 1651. If the Edit Line menu 1655 is touched by the user, any one series among at last one series included in the chart table 1653 is touched, and then a key is entered, as shown in a screen 1657, the mobile electronic device may display an Edit Chart menu 1659 including a Change Color menu for requesting change in chart color and a Delete menu for deleting some areas of the chart graph, as shown in the screen 1657.

If the Change Color menu is touched (1661), the mobile electronic device may display a palette including a plurality of colors, and if a specific color is selected from among the plurality of colors included in the palette by the user, the mobile electronic device may create and display a chart table 1665 by changing the color of the touched series to the specific color in the chart table 1653, as shown in a screen 1663.

If the Delete menu is touched, the mobile electronic device may create and display a chart table 1669 by deleting at least one chart value corresponding to the touched series in the chart table 1653, as shown in a screen 1667.

If a specific area 1675 among the plurality of areas included in the chart table 1673 is touched, and then a key is touched, as shown in a screen 1671, the mobile electronic device may display a Delete menu 1681 used for deleting a chart value included in a specific area, as shown in a screen 1677.

If the Delete menu 1681 is touched by the user, the mobile electronic device may create and display a chart table 1679 by deleting the chart value of the specific area included in the chart table 1673.

If the specific area 1675 among the plurality of areas included in the chart table 1673 is touched, and then a specific number is entered in the specific area 1675, as shown in the screen 1671, the mobile electronic device may create and display a chart table 1685 by changing the chart value of the specific area 1675 included in the chart table 1673 to a specific number ‘47’ 1687, as shown in a screen 1683.

FIGS. 17A, 17B, 17C, and 17D illustrate screens on which a bar graph is changed according to the third embodiment of the present disclosure.

Referring to FIGS. 17A, 17B, 17C, and 17D, the mobile electronic device may display a bar graph 1703, first series information about a first series included in the bar graph 1703, and a Change Chart Graph icon 1705, as shown in a screen 1701. If the Change Chart Graph icon 1705 is touched by the user, the mobile electronic device may display a Chart Type menu 1709 including graph types (for example, a chart table, a line graph, and a pie graph), as shown in a screen 1707.

If a Chart Table menu 1711 among the displayed chart type menus is touched by the user, the mobile electronic device may change the bar graph 1703 to a chart table 1719 based on the chart data corresponding to the bar graph 1703, as shown in a screen 1717.

If a Line Graph menu 1713 among the displayed chart type menus is touched by the user, the mobile electronic device may change the bar graph 1703 to a line graph 1723 based on the chart data corresponding to the bar graph 1703, as shown in a screen 1721.

If a Pie Graph menu 1715 among the displayed chart type menus is touched by the user, the mobile electronic device may change the bar graph 1703 to a pie graph 1727 based on the chart data corresponding to the bar graph 1703, as shown in a screen 1725.

The mobile electronic device may display a bar graph 1731 and an Add Series menu 1733 as shown in a screen 1729. If the Add Series menu 1733 is touched by the user, the mobile electronic device may generate and display second series information about a second series, as shown in a screen 1735.

If the displayed second series information is touched by the user in the screen 1735, the mobile electronic device may deactivate at least one bar corresponding to the first series included in the bar graph 1731. If at least one bar 1741 is entered in a bar graph 1737 as shown in the screen 1735, the mobile electronic device may recognize the entered bar 1741 as a bar corresponding to the second series, and update the chart data based on the recognized bar 1741. The mobile electronic device may update the second series information based on the updated chart data, and may also create and display a bar graph 1745 including the entered bar 1747 based on the updated chart data and display the updated second series information, as shown in a screen 1743.

The mobile electronic device may display a bar graph 1751 and an Edit Line menu 1753, in a screen 1749. If the Edit Line menu 1753 is touched by the user as shown in the screen 1749, the mobile electronic device may display first identification icons 1755 indicating the editability of bars on all the bars included in the bar graph 1751.

If a gesture 1761 that horizontally crosses the bar graph 1759 is entered, the mobile electronic device may divide the maximum scale of the y-axis by a value obtained by adding one (1) to the number of displayed scale mark lines, determine the calculated value as a gap between scale marks, and then change the y-axis scale marks of the coordinate system included in a bar graph 1765 based on the determined gap between scale marks, as shown in a screen 1763.

As shown in a screen 1769, the mobile electronic device may display a bar graph 1771, and first identification icons indicating the editability of bars on all the bars included in the bar graph 1771. If any one series is touched among at least one series included in the bar graph 1771, and then a key is entered (1773), the mobile electronic device may display an Edit Chart menu 1779 including a Change Color menu for requesting change in chart color and a Delete menu for deleting some areas of the chart graph, as shown in a screen 1775.

If the Change Color menu is touched, the mobile electronic device may a palette including a plurality of colors, and if a specific color is selected from among the plurality of colors included in the palette by the user, the mobile electronic device may create and display a bar graph 1783 by changing the color of the touched series to the specific color in the bar graph 1771, as shown in a screen 1781.

If the Delete menu is touched, the mobile electronic device may update the chart data by deleting the chart data corresponding to the touched series from the chart data corresponding to the bar graph 1771, and create and display a bar graph based on the updated chart data. As shown in a screen 1785, the mobile electronic device may delete the bar graph and display the coordinate system.

As shown in a screen 1789, the mobile electronic device may display a bar graph 1791 and first identification icons indicating the editability of bars on all the bars included in the bar graph 1791. If a first identification icon undergoes a touch-and-drag and touch-off gesture 1795 by the user as shown in a screen 1793, the mobile electronic device may estimate a y-axis value corresponding to the touch-off point in the coordinate system, and update the chart data for the displayed bar graph using the estimated y-axis value. If the estimated y-axis value is 40, the mobile electronic device may create and display a bar graph based on the updated chart data so that the y-axis value of a second bar 1799 may be 40, as shown in a screen 1797.

FIGS. 18A, 18B, and 18C illustrate screens on which a pie graph is changed according to the third embodiment of the present disclosure.

Referring to FIGS. 18A, 18B, and 18C, the mobile electronic device may display a pie graph 1803, first series information about a first series included in the pie graph 1803, and a Change Chart Graph menu 1805, as shown in a screen 1801. If the Change Chart Graph menu 1805 is touched by the user, the mobile electronic device may display a Chart Type menu 1809 including graph types (for example, a chart table, a bar graph, and a line graph), as shown in a screen 1807.

If a Chart Table menu 1811 among the displayed chart type menus is touched by the user, the mobile electronic device may change the pie graph 1803 to a chart table 1819 based on the chart data corresponding to the pie graph 1803, as shown in a screen 1817.

If a Bar Graph menu 1813 among the displayed chart type menus is touched by the user, the mobile electronic device may change the pie graph 1803 to a bar graph 1823 based on the chart data corresponding to the pie graph 1803, as shown in a screen 1821.

If a Line Graph menu 1815 among the displayed chart type menus is touched by the user, the mobile electronic device may change the pie graph 1803 to a line graph 1827 based on the chart data corresponding to the pie graph 1803, as shown in a screen 1825.

As shown in a screen 1829, the mobile electronic device may display a pie graph 1831 and an Add Series menu 1833. If the Add Series menu 1833 is touched by the user, the mobile electronic device may generate and display second series information 1839 about a second series, as shown in a screen 1835.

If the displayed second series information 1839 is touched by the user in the screen 1835, the mobile electronic device may create and display a pie graph 1837 corresponding to the second series based on the chart data corresponding to the second series in the chart data corresponding to the pie graph 1831. If at least one oblique line 1841 is entered in the pie graph 1837 as shown in the screen 1835, the mobile electronic device may recognize the entered at least one oblique line 1841 and update the chart data corresponding to the second series based on the recognized at least one oblique line 1841. The mobile electronic device may update the second series information based on the updated chart data, and may also create and display a pie graph 1845 for the second series based on the updated chart data and display the updated second series information, as shown in a screen 1843.

The mobile electronic device may display a pie graph 1849 and an Edit Line menu 1851, as shown in a screen 1847. If the Edit Line menu 1851 is touched by the user as shown in the screen 1847, the mobile electronic device may display first identification icons indicating the editability of at least one area included in the pie graph 1849.

If a key is entered by the user, the mobile electronic device may display an Edit Chart menu 1853 including a Delete menu for requesting deletion of the displayed pie graph 1849. If the Delete menu is touched by the user, the mobile electronic device may delete the chart data corresponding to the series of the displayed pie graph 1849 from the chart data, and may display a circle 1857 of the pie graph 1849 as shown in a screen 1855.

As shown in a screen 1859, the mobile electronic device may display a pie graph 1861 and may also display first identification icons 1863 indicating the editability of areas on the boundaries between the areas included in the pie graph 1861. If a specific first identification icon 1863 that is located on the boundary between first and second areas undergoes a touch-and-drag and touch-off gesture 1867 by the user as shown in a screen 1865, the mobile electronic device may estimate sizes of the first and second areas changed by the touch-off, and update the chart data for the displayed pie graph 1861 using the estimated sizes of the first and second areas. As shown in a screen 1869, the mobile electronic device may create and display a pie graph 1871 based on the updated chart data.

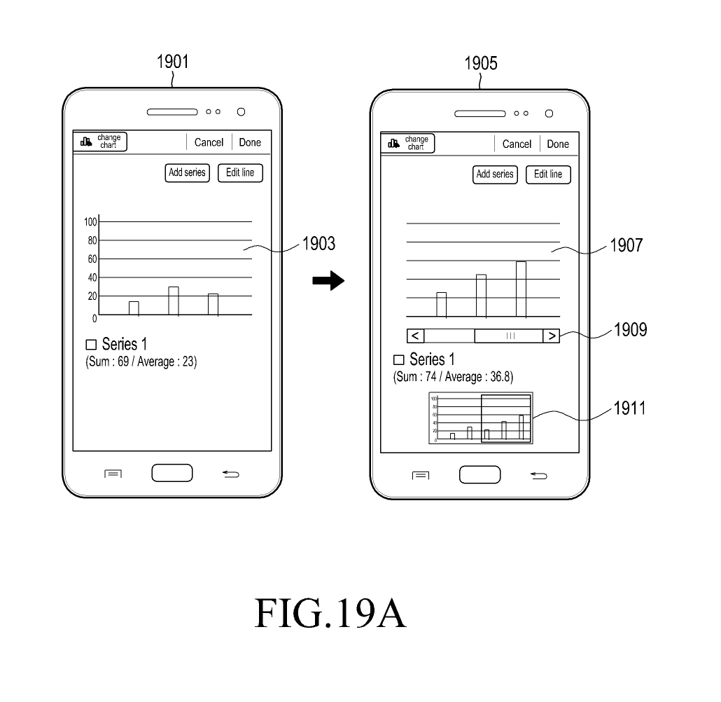

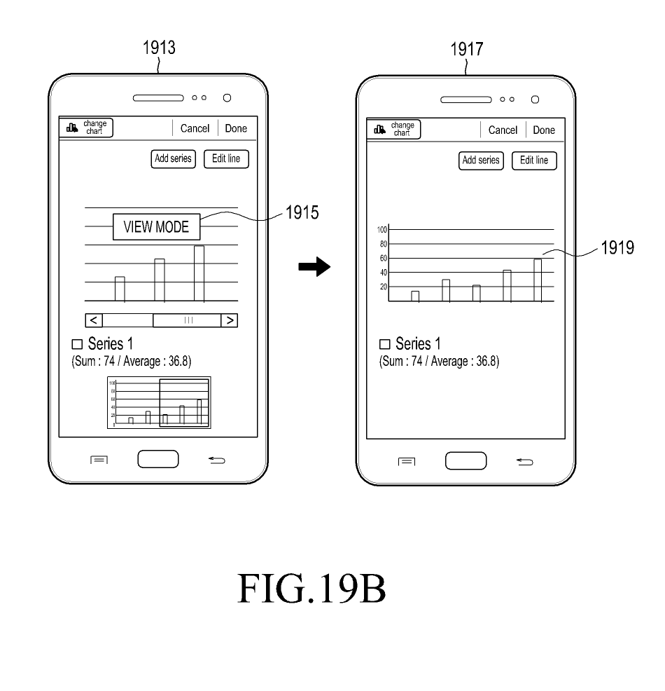

FIGS. 19A and 19B illustrate screens on which a chart larger in size than a chart display area is displayed according to an embodiment of the present disclosure.

Referring to FIGS. 19A and 19B, the mobile electronic device may display a bar graph 1903 as shown in a screen 1901. If the size of the bar graph becomes larger than a reference value as at least one bar is added in the bar graph 1903, the mobile electronic device may display some areas 1907 of the bar graph, display a scroll bar 1909 used to select a specific area of the bar graph, and display a window for displaying a thumbnail 1911 of the bar graph and an area that the mobile electronic device is displaying in the thumbnail 1911, as shown in a screen 1905. The reference value may be determined based on the size of the object input window.

The mobile electronic device may display some areas of the bar graph, a scroll bar and a thumbnail in a screen 1913. If a key is selected or touched by the user, the mobile electronic device may display a View Mode menu 1915 for displaying the entire area of the bar graph, as shown in the screen 1913. If the View Mode menu 1915 is selected, the mobile electronic device may display the entire area 1919 of the bar graph as shown in a screen 1917.

The method for displaying a chart in a mobile electronic device according to the present disclosure may be implemented as computer-readable code on a non-transitory computer-readable recording medium. A non-transitory computer-readable recording medium is any data storage device that can store data which can be thereafter read by a computer system. Examples of the non-transitory computer readable recording medium may include any kind of recording devices storing computer-readable data. Typical examples of the recording medium may include a Read Only Memory (ROM), a Random Access Memory (RAM), an optical disk, a magnetic disk, a floppy disk, a hard disk, a non-volatile memory, and the like, and may also include a medium that is implemented in the form of a carrier wave (for example, transmission over the Internet). The non-transitory computer-readable recording medium may be distributed over the computer systems connected by the network, and the computer-readable code may be stored and executed in a distributed manner.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

As is apparent from the foregoing description, various embodiments of the present disclosure may provide a method and an apparatus for displaying a chart graph using an object recognition technique, thereby allowing the user to intuitively recognize the chart graph.

In addition, various embodiments of the present disclosure may provide a method and an apparatus for modifying a chart graph using an object recognition technique, thereby allowing the user to intuitively modify the chart graph.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display unit configured to receive an input for entering an object associated with a chart; and
a controller configured to control display of at least one chart component based on characteristics of the object.

2. The electronic device of claim 1, wherein the controller is further configured to generate chart data based on the characteristics of the object and control display of the chart based on the generated chart data.

3. The electronic device of claim 2, wherein the chart data comprises coordinate values corresponding to a form of the entered object.

4. The electronic device of claim 1, wherein, upon receiving a request to create a chart, the controller is further configured to display chart types, and if a chart in any one of the displayed chart types is selected, the controller is further configured to display an object input window related to the selected chart.

5. The electronic device of claim 4, wherein the object input window comprises a coordinate system related to the selected chart.

6. The electronic device of claim 4, wherein the chart type comprises at least one of a chart table, a line chart, a bar chart, a pie chart, and at least one pre-stored chart history.

7. The electronic device of claim 4, wherein, if the chart is selected, the controller is further configured to display at least one series information about at least one series constituting the chart.

8. The electronic device of claim 7, wherein the series information comprises at least one of a name of the series, and a sum and an average of at least one chart value included in the series.

9. The electronic device of claim 7, wherein, upon receiving a request to add a series, the controller is further configured to add a series in the chart, display series information about the added series, and update the chart data.

10. The electronic device of claim 7, wherein, upon receiving a request to delete the series information, the controller is further configured to delete a series corresponding to the series information from the chart, and update the chart data.

11. The electronic device of claim 1, wherein, in a case where the chart is a line chart or a bar chart, the controller is further configured to change Y-axis scale marks of the coordinate system included in the chart, if a gesture that horizontally crosses the chart is entered.

12. The electronic device of claim 1, wherein, in a case where the chart is a chart table, the controller is further configured to add at least one column in the chart table, if a gesture that vertically crosses the chart table is entered.

13. The electronic device of claim 1, wherein, upon receiving a request to create a chart, the controller is further configured to display an object input window comprising a reference coordinate system.

14. The electronic device of claim 1, wherein, if an object is additionally entered, the controller is further configured to update and display the chart based on characteristics of the displayed chart or additionally entered object.

15. The electronic device of claim 1, wherein, upon receiving a request to change a type of the chart, the controller is further configured to change a type of the chart depending on the requested change in type.

16. The electronic device of claim 1, wherein, if a specific area of the chart is selected, the controller is further configured to determine that editing of the specific area is requested, display a first identifier, and update and display the chart based on a shift of the first identifier or on an entered number.

17. The electronic device of claim 1, wherein, if a specific area of a coordinate system included in the chart is selected, the controller is further configured to determine that editing of scale marks for the coordinate system is requested, display a second identifier, and update the coordinate system based on a shift of the second identifier or on an entered number.

18. The electronic device of claim 1, wherein, if a first delete gesture is entered in a specific area of the chart, the controller is further configured to delete the specific area from the chart.

19. The electronic device of claim 1, wherein, if a second delete gesture is entered in the chart, the controller is further configured to delete the chart.

20. The electronic device of claim 1, wherein, if a number is entered in the chart, the controller is further configured to determine a chart value or a scale mark closest to an input position of the number among a plurality of components included in the chart, and change the determined chart value or scale mark to the number.

21. The electronic device of claim 1, wherein, if a character is entered in the chart, the controller is further configured to determine a scale mark closest to an input position of the character among X-axis scale marks included in the chart, and display the character to be adjacent to the determined scale mark.

22. The electronic device of claim 1, wherein, upon receiving a request to save the chart in a form of an image file or receiving an input indicating completion of creating the chart, the controller is further configured to generate and store an image file comprising an image of the chart and chart data corresponding to the chart.

23. The electronic device of claim 1, wherein the characteristics comprise at least one of the type and input position.

24. A method for displaying a chart in an electronic device, the method comprising:
receiving an input for entering an object associated with a chart; and
generating and displaying at least one chart component based on characteristics of the object.

25. The method of claim 24, wherein the generating and displaying of the at least one chart component based on characteristics of the object comprises:
generating chart data based on the characteristics of the object; and
displaying the chart based on the generated chart data.

26. The method of claim 25, wherein the chart data comprises coordinate values corresponding to a form of the entered object.

27. The method of claim 24, further comprising:
upon receiving a request to create a chart, displaying chart types; and
if a chart in any one of the displayed chart types is selected, displaying an object input window related to the selected chart.

28. The method of claim 27, wherein the object input window comprises a coordinate system related to the selected chart.

29. The method of claim 27, wherein the chart type comprises at least one of a chart table, a line chart, a bar chart, a pie chart, and at least one pre-stored chart history.

30. The method of claim 27, further comprising:
if the chart is selected, displaying at least one series information about at least one series constituting the chart.

31. The method of claim 30, wherein the series information comprises at least one of a name of the series, and a sum and an average of at least one chart value included in the series.

32. The method of claim 30, further comprising:
upon receiving a request to add a series, adding a series in the chart;
displaying series information about the added series; and
updating the chart data.

33. The method of claim 30, further comprising:
upon receiving a request to delete the series information, deleting a series corresponding to the series information from the chart; and
updating the chart data.

34. The method of claim 24, further comprising:
if the chart is a line chart or a bar chart and a gesture that horizontally crosses the chart is entered, changing Y-axis scale marks of the coordinate system included in the chart.

35. The method of claim 24, further comprising:
if the chart is a chart table and a gesture that vertically crosses the chart table is entered, adding at least one column in the chart table.

36. The method of claim 24, further comprising:
upon receiving a request to create a chart, displaying an object input window comprising a reference coordinate system.

37. The method of claim 24, further comprising:
if an object is additionally entered, updating and displaying the chart based on characteristics of the displayed chart or additionally entered object.

38. The method of claim 24, further comprising:
upon receiving a request to change a type of the chart, changing a type of the chart depending on the requested change in type.

39. The method of claim 24, further comprising:
if a specific area of the chart is selected, determining that editing of the specific area is requested;
displaying a first identifier; and
updating and displaying the chart based on a shift of the first identifier or on an entered number.

40. The method of claim 24, further comprising:
if a specific area of a coordinate system included in the chart is selected, determining that editing of scale marks for the coordinate system is requested;
displaying a second identifier; and
updating the coordinate system based on a shift of the second identifier or on an entered number.

41. The method of claim 24, further comprising:
if a delete gesture is entered in a specific area of the chart, deleting the specific area from the chart.

42. The method of claim 24, further comprising:
if a delete gesture is entered in the chart, deleting the chart.

43. The method of claim 24, further comprising:
if a number is entered in the chart, determining a chart value or a scale mark closest to an input position of the number among a plurality of components included in the chart; and
changing the determined chart value or scale mark to the number.

44. The method of claim 24, further comprising:
if a character is entered in the chart, determining a scale mark closest to an input position of the character among X-axis scale marks included in the chart; and
displaying the character to be adjacent to the determined scale mark.

45. The method of claim 24, further comprising:
upon receiving a request to save the chart in a form of an image file or receiving an input indicating completion of creating the chart, generating and storing an image file comprising an image of the chart and chart data corresponding to the chart.

46. The method of claim 24, wherein the characteristics comprise at least one of the type and input position.

47. A non-transitory computer-readable storage medium storing instructions, which are executed by at least one processor and are set to cause the at least one processor to perform at least one operation, wherein the at least one operation comprises:
receiving an input for entering an object associated with a chart; and
generating and displaying at least one chart component based on characteristics of the object.
